(19) United States
(12) Patent Application Publication
(10) Pub. No.: US 2025/0167714 A1
(43) Pub. Date: May 22, 2025

(54) POWER CONVERSION DEVICE AND MOTOR MODULE

(71) Applicant: NIDEC CORPORATION, Kyoto (JP)

(72) Inventors: Koji SATO, Kyoto (JP); Kotaro KATAOKA, Kyoto (JP)

(21) Appl. No.: 18/835,349

(22) PCT Filed: Feb. 8, 2023
(86) PCT No.: PCT/JP2023/004125

§ 371 Date: Feb. 6, 2025

(30) Foreign Application Priority Data
Feb. 10, 2022 (JP) 2022-019721

(51) Int. Cl. H02P 27/08

(52) U.S. Cl. CPC H02P 27/08

(57) ABSTRACT

One aspect of a power conversion device of the present invention includes a power conversion circuit that performs mutual conversion between DC power and N-phase AC power (N is an integer of three or more), and a control unit having a first deformation mode for controlling the power conversion circuit by pulse width modulation based on an N-phase modulated waveform and a carrier waveform. In the first deformation mode, the control unit outputs the N-phase modulated waveform obtained by adding a first offset waveform W1(θ) expressed by Formula having, as variables, a sign Sgn (Sgn is 1 or −1), a first change rate K1, and a maximum value fmax(θ) and a minimum value fmin(θ) of an N-phase AC waveform at an electrical angle θ and the N-phase AC waveform, and the first change rate K1 of the first deformation mode is larger than 0 and smaller than 1.

### CROSS-REFERENCE TO RELATED APPLICATIONS

This is the U.S. national stage of application No. PCT/JP2023/004125, filed on Feb. 8, 2023, and priority under 35 U.S.C. § 119(a) and 35 U.S.C. § 365(b) is claimed from Japanese Patent Application No. 2022-019721, filed on Feb. 10, 2022.

### FIELD OF THE INVENTION

The present invention relates to a power conversion device and a motor module.

### BACKGROUND

Conventionally, there are known a two-phase modulation method in which a high-side switch or a low-side switch of one phase among six switches included in a power conversion circuit such as a three-phase inverter is set to be ON, and switches of the remaining phases are controlled by pulse width modulation, and a three-phase modulation method in which switches of all phases among six switches are controlled by pulse width modulation.

The two-phase modulation method has an advantage that a switching loss is low, but has a disadvantage that noise is large due to a large phase current ripple. The three-phase modulation method has an advantage that a phase current ripple is small (noise is small) and high-accuracy motor control with little torque unevenness can be realized, but has a disadvantage that a switching loss is large.

Conventionally, there is a technical idea of controlling a power conversion circuit while switching between a two-phase modulation method and a three-phase modulation method. However, when the two-phase modulation method and the three-phase modulation method are instantaneously switched, torque of a motor fluctuates due to a sudden change in a switching loss, and there is a possibility that the user feels uncomfortable due to a sudden change in noise.

Conventionally, there is a technique of reducing a sudden change in noise caused by switching from a three-phase modulation method to a two-phase modulation method by using the three-phase modulation method when a modulation rate is small and continuously changing the modulation method from the three-phase modulation method to a two-phase modulation method as the modulation rate increases.

In the conventional technique, since a modulation rate changes when a modulation method is switched, a rotational speed of the motor may change.

### SUMMARY

One aspect of an exemplary power conversion device of the present invention includes a power conversion circuit that performs mutual conversion between DC power and N-phase AC power (N is an integer of three or more), and a control unit having a first deformation mode for controlling the power conversion circuit by pulse width modulation based on an N-phase modulated waveform and a carrier waveform. In the first deformation mode, the control unit outputs the N-phase modulated waveform obtained by adding a first offset waveform W1(θ) expressed by Formula (1) having, as variables, a sign Sgn (Sgn is 1 or −1), a first change rate K1, and a maximum value fmax(θ) and a minimum value fmin(θ) of an N-phase AC waveform at an electrical angle θ and the N-phase AC waveform, and the first change rate K1 of the first deformation mode is larger than 0 and smaller than 1.

$$\begin{matrix}[ Mathematical formula 1 ] & \\ W 1 ( θ ) = \{ 1 - f max ( θ ) - f min ( θ ) \} / 2 + Sgn \times ( 1 - K 1 ) \times \{ 1 - f max ( θ ) + f min ( θ ) \} / 2 & ( 1 )\end{matrix}$$

One aspect of the exemplary power conversion device of the present invention includes a power conversion circuit that performs mutual conversion between DC power and N-phase AC power (N is an integer of three or more), and a control unit having a first deformation mode and a second deformation mode for controlling the power conversion circuit by pulse width modulation based on an N-phase modulated waveform and a carrier waveform. In the first deformation mode, the control unit outputs the N-phase modulated waveform obtained by adding a third offset waveform W3(θ) expressed by Formula (3) having, as variables, a second change rate K2 and a maximum value fmax(θ) and a minimum value fmin(θ) of an N-phase AC waveform at an electrical angle θ and the N-phase AC waveform. In the second deformation mode, the control unit outputs the N-phase modulated waveform obtained by adding a fourth offset waveform W4(θ) expressed by Formula (4) having, as variables, a third change rate K3 and a maximum value fmax(θ) and a minimum value fmin(0) of the N-phase AC waveform at the electrical angle θ and the N-phase AC waveform. The control unit switches between the first deformation mode and the second deformation mode every 1/N of an electrical angle of 180 degrees in a first period, switches between the first deformation mode in which the second change rate K2 is fixed to 0 and the second deformation mode in which the third change rate K3 is fixed to 0 in a second period before the first period every 1/N of the electrical angle of 180 degrees, and outputs the N-phase modulated waveform obtained by adding a fifth offset waveform W5(θ) represented by Formula (5) and the N-phase AC waveform in a third period after the first period. The second change rate K2 in the first deformation mode changes from a value larger than 0 to a value smaller than 1 in a period in which the control unit operates in the first deformation mode during a period included in the first period. The third change rate K3 in the second deformation mode changes from a value larger than 0 to a value smaller than 1 in a period in which the control unit operates in the second deformation mode during a period included in the first period.

$$\begin{matrix}[ Mathematical formula 2 ] & \\ W 3 ( θ ) = - f min ( θ ) \times ( 1 - K 2 ) + K 2 \times \{ 1 - f max ( θ ) - f min ( θ ) \} / 2 & ( 3 )\end{matrix}$$

$$W 4 ( θ ) = \{ 1 - f max ( θ ) \} \times ( 1 - K 3 ) + K 3 \times \{ 1 - f max ( θ ) - f min ( θ ) \} / 2 \qquad ( 4 )$$

$$W 5 ( θ ) = \{ 1 - f max ( θ ) - f min ( θ ) \} / 2 \qquad ( 5 )$$

One aspect of an exemplary motor module of the present invention includes a motor, and the power conversion device of the above aspect that supplies power to the motor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating an overall configuration of a motor module according to a first embodiment of the present invention;

FIG. 2 is a diagram illustrating a first example of a three-phase AC waveform, a first offset waveform W1(θ), and a modulated waveform;

FIG. 3 is a diagram illustrating a second example of the three-phase AC waveform, the first offset waveform W1(θ), and the modulated waveform;

FIG. 4 is a diagram illustrating a third example of the three-phase AC waveform, the first offset waveform W1(θ), and the modulated waveform;

FIG. 5 is a diagram illustrating a first example of a modulated waveform output from a control unit according to a second embodiment;

FIG. 6 is a flowchart illustrating first processing executed by the control unit according to the second embodiment;

FIG. 7 is a flowchart illustrating second processing executed by the control unit according to the second embodiment;

FIG. 8 is a flowchart illustrating third processing executed by the control unit according to the second embodiment;

FIG. 9 is a flowchart illustrating 2-1st processing executed by the control unit according to the second embodiment;

FIG. 10 is a diagram illustrating a second example of the modulated waveform output from the control unit according to the second embodiment;

FIG. 11 is a diagram illustrating a first example of a modulated waveform output from the control unit according to a third embodiment;

FIG. 12 is a flowchart illustrating fourth processing executed by the control unit according to the third embodiment;

FIG. 13 is a flowchart illustrating fifth processing executed by the control unit according to the third embodiment;

FIG. 14 is a flowchart illustrating sixth processing executed by the control unit according to the third embodiment;

FIG. 15 is a flowchart illustrating 4-1st processing executed by the control unit according to the third embodiment;

FIG. 16 is a diagram illustrating a second example of a modulated waveform output from the control unit according to the third embodiment;

FIG. 17 is a diagram illustrating an example of a modulated waveform output from the control unit according to a fourth embodiment;

FIG. 18 is a flowchart illustrating seventh processing executed by the control unit according to the fourth embodiment;

FIG. 19 is a flowchart illustrating eighth processing executed by the control unit according to the fourth embodiment;

FIG. 20 is a diagram illustrating an example of a modulated waveform output from the control unit according to a fifth embodiment;

FIG. 21 is a flowchart illustrating ninth processing executed by the control unit according to the fifth embodiment;

FIG. 22 is a flowchart illustrating tenth processing executed by the control unit according to the fifth embodiment;

FIG. 23 is a flowchart illustrating eleventh processing executed by the control unit according to the fifth embodiment;

FIG. 24 is a diagram illustrating an example of a modulated waveform output from the control unit according to a seventh embodiment;

FIG. 25 is a flowchart illustrating twelfth processing executed by the control unit according to the seventh embodiment;

FIG. 26 is a flowchart illustrating thirteenth processing executed by the control unit according to the seventh embodiment;

FIG. 27 is a flowchart illustrating fourteenth processing executed by the control unit according to the seventh embodiment;

FIG. 28 is a flowchart illustrating fifteenth processing executed by the control unit according to the seventh embodiment;

FIG. 29 is a flowchart illustrating sixteenth processing executed by the control unit according to the seventh embodiment; and

FIG. 30 is a flowchart illustrating 12-1st processing executed by the control unit according to the seventh embodiment.

### DETAILED DESCRIPTION

An embodiment of the present invention will be described in detail below with reference to the drawings.

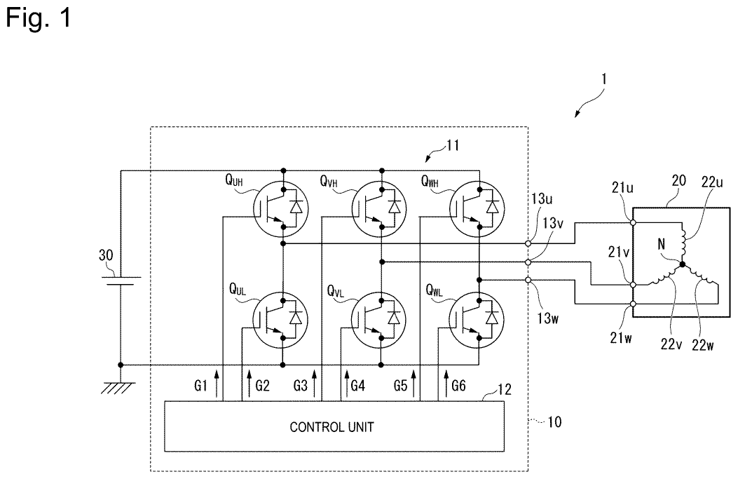

First, a first embodiment of the present invention will be described. FIG. 1 is a diagram schematically illustrating an overall configuration of a motor module 1 according to the present embodiment. As illustrated in FIG. 1, the motor module 1 includes a power conversion device 10 and a motor 20. The power conversion device 10 supplies power to the motor 20. As an example, the motor 20 is an inner rotor type three-phase brushless DC motor. Further, the motor 20 is, for example, a driving motor (traction motor) mounted on an electric vehicle.

The motor 20 includes a U-phase terminal 21u, a V-phase terminal 21v, a W-phase terminal 21w, a U-phase coil 22u, a V-phase coil 22v, and a W-phase coil 22w. Although not illustrated in FIG. 1, the motor 20 includes a motor case, and a rotor and a stator housed in the motor case. The rotor is a rotating body rotatably supported by a bearing component such as a rotor bearing inside the motor case. The rotor has an output shaft coaxially joined to the rotor in a state of penetrating the inner side in a radial direction of the rotor in an axial direction. The stator is set in a state of surrounding an outer peripheral surface of the rotor inside the motor case, and generates electromagnetic force necessary for rotating the rotor.

The U-phase terminal 21u, the V-phase terminal 21v, and the W-phase terminal 21w are metal terminals each exposed from a surface of the motor case. The U-phase terminal 21u is connected to a U-phase connection terminal 13u of the power conversion device 10. The V-phase terminal 21v is connected to a V-phase connection terminal 13v of the power conversion device 10. The W-phase terminal 21w is connected to a W-phase connection terminal 13w of the power conversion device 10. The U-phase coil 22u, the V-phase coil 22v, and the W-phase coil 22w are excitation coils provided in the stator. As an example, the U-phase coil 22u, the V-phase coil 22v, and the W-phase coil 22w are star-connected inside the motor 20.

The U-phase coil 22u is connected between the U-phase terminal 21u and a neutral point N. The V-phase coil 22v is connected between the V-phase terminal 21v and the neutral point N. The W-phase coil 22w is electrically connected between the W-phase terminal 21w and the neutral point N. When energization states of the U-phase coil 22u, the V-phase coil 22v, and the W-phase coil 22w are controlled by the power conversion device 10, electromagnetic force necessary for rotating the rotor is generated. When the rotor rotates, an output shaft also rotates in synchronization with the rotor.

The power conversion device 10 includes a power conversion circuit 11 and a control unit 12. The power conversion circuit 11 is connected to the motor 20 and a DC power supply 30, and performs mutual conversion between DC power and N-phase AC power (N is an integer of three or more). In the present embodiment, since the motor 20 is a three-phase motor, a value of N is three. Therefore, the power conversion circuit 11 performs mutual conversion between DC power and three-phase AC power. For example, when the power conversion circuit 11 functions as an inverter, the power conversion circuit 11 converts DC power supplied from the DC power supply 30 into three-phase AC power and outputs the three-phase AC power to the motor 20. As an example, the DC power supply 30 is one of a plurality of batteries mounted on an electric vehicle.

The power conversion circuit 11 includes 2N switches. As described above, in the present embodiment, since a value of N is three, the power conversion circuit 11 includes six switches. The power conversion circuit 11 includes a U-phase high-side switch Q_{UH}, a V-phase high-side switch Q_{VH}, a W-phase high-side switch Q_{WH}, a U-phase low-side switch Q_{UL}, a V-phase low-side switch Q_{VL}, and a W-phase low-side switch Q_{WL}. In the present embodiment, each switch is, for example, an insulated gate bipolar transistor (IGBT).

Each of a collector terminal of the U-phase high-side switch Q_{UH}, a collector terminal of the V-phase high-side switch Q_{VH}, and a collector terminal of the W-phase high-side switch Q_{WH} is connected to a positive electrode terminal of the DC power supply 30. Each of an emitter terminal of the U-phase low-side switch Q_{UL}, an emitter terminal of the V-phase low-side switch Q_{VL}, and an emitter terminal of the W-phase low-side switch Q_{WL} is connected to a negative electrode terminal of the DC power supply 30.

An emitter terminal of the U-phase high-side switch Q_{UH} is connected to each of the U-phase connection terminal 13u and a collector terminal of the U-phase low-side switch Q_{UL}. That is, an emitter terminal of the U-phase high-side switch Q_{UH} is connected to the U-phase terminal 21u of the motor 20 via the U-phase connection terminal 13u. An emitter terminal of the V-phase high-side switch Q_{VH} is connected to each of the V-phase connection terminal 13v and a collector terminal of the V-phase low-side switch Q_{VL}. That is, an emitter terminal of the V-phase high-side switch Q_{VH} is connected to the V-phase terminal 21v of the motor 20 via the V-phase connection terminal 13v. An emitter terminal of the W-phase high-side switch Q_{WH} is connected to each of the W-phase connection terminal 13w and a collector terminal of the W-phase low-side switch Q_{WL}. That is, an emitter terminal of the W-phase high-side switch Q_{WH} is connected to the W-phase terminal 21w of the motor 20 via the W-phase connection terminal 13w.

A gate terminal of the U-phase high-side switch Q_{UH}, a gate terminal of the V-phase high-side switch Q_{VH}, and a gate terminal of the W-phase high-side switch Q_{WH} are connected to the control unit 12. Further, a gate terminal of the U-phase low-side switch Q_{UL}, a gate terminal of the V-phase low-side switch Q_{VL}, and a gate terminal of the W-phase low-side switch Q_{WL} are also connected to the control unit 12.

As described above, the power conversion circuit 11 includes a three-phase full-bridge circuit including three high-side switches and three low-side switches. The power conversion circuit 11 configured as described above performs mutual conversion between DC power and three-phase AC power as the control unit 12 performs switching control of each switch. The U-phase connection terminal 13u, the V-phase connection terminal 13v, and the W-phase connection terminal 13w are connection terminals of the power conversion circuit 11.

The control unit 12 is a processor incorporating a memory (not illustrated). As an example, the control unit 12 is a microcontroller unit (MCU). The control unit 12 controls the power conversion circuit 11 according to a program stored in advance in the memory. Although details will be described later, the control unit 12 has a first deformation mode for controlling the power conversion circuit 11 by pulse width modulation based on an N-phase modulated waveform and a carrier waveform. As described above, in the present embodiment, since a value of N is three, the control unit 12 has the first deformation mode in which the power conversion circuit 11 is controlled by pulse width modulation based on a three-phase modulated waveform and a carrier waveform.

The control unit 12 compares a modulated waveform with a carrier waveform to generate a gate signal necessary for controlling the power conversion circuit 11 by pulse width modulation. As an example, the carrier waveform is a triangular wave. As described later, the modulated waveform is a function of an electrical angle θ of the motor 20. The modulated waveform includes a U-phase modulated waveform Vum(θ), a V-phase modulated waveform Vvm(θ), and a W-phase modulated waveform Vwm(θ).

The control unit 12 generates a U-phase high-side gate signal G1 necessary for controlling the U-phase high-side switch Q_{UH}, and outputs the generated U-phase high-side gate signal G1 to a gate terminal of the U-phase high-side switch Q_{UH}. The control unit 12 sets the U-phase high-side gate signal G1 to a high level when the U-phase modulated waveform Vum(θ) is larger than a carrier waveform.

The control unit 12 generates a U-phase low-side gate signal G2 necessary for controlling the U-phase low-side switch Q_{UL}, and outputs the generated U-phase low-side gate signal G2 to a gate terminal of the U-phase low-side switch Q_{UL}. The control unit 12 sets the U-phase low-side gate signal G2 to a low level when the U-phase modulated waveform Vum(θ) is larger than a carrier waveform. As described above, the U-phase low-side gate signal G2 is a complementary signal of the U-phase high-side gate signal G1.

The control unit 12 generates a V-phase high-side gate signal G3 necessary for controlling the V-phase high-side switch Q_{VH}, and outputs the generated V-phase high-side gate signal G3 to a gate terminal of the V-phase high-side switch Q_{VH}. The control unit 12 sets the V-phase high-side gate signal G3 to a high level when the V-phase modulated waveform Vvm(θ) is larger than a carrier waveform.

The control unit 12 generates a V-phase low-side gate signal G4 necessary for controlling the V-phase low-side switch Q_{VL}, and outputs the generated V-phase low-side gate signal G4 to a gate terminal of the V-phase low-side switch Q_{VL}. When the V-phase modulated waveform Vvm(θ) is larger than a carrier waveform, the control unit 12 sets the V-phase low-side gate signal G4 to a low level. As described above, the V-phase low-side gate signal G4 is a complementary signal of the V-phase high-side gate signal G3.

The control unit 12 generates a W-phase high-side gate signal G5 necessary for controlling the W-phase high-side switch Q_{WH}, and outputs the generated W-phase high-side gate signal G5 to a gate terminal of the W-phase high-side switch Q_{WH}. The control unit 12 sets the W-phase high-side gate signal G5 to a high level when the W-phase modulated waveform Vwm(θ) is larger than a carrier waveform.

The control unit 12 generates a W-phase low-side gate signal G6 necessary for controlling the W-phase low-side switch Q_{WL}, and outputs the generated W-phase low-side gate signal G6 to a gate terminal of the W-phase low-side switch Q_{WL}. The control unit 12 sets the W-phase low-side gate signal G6 to a low level when the W-phase modulated waveform Vwm(θ) is larger than a carrier waveform. As described above, the W-phase low-side gate signal G6 is a complementary signal of the W-phase high-side gate signal G5.

Note that dead time is inserted into each gate control signal in order to prevent a high-side switch and a low-side switch of the same phase from being simultaneously switched on.

The configuration of the motor module 1 is described above. Hereinafter, operation of the control unit 12 included in the power conversion device 10 will be described in detail.

In the first deformation mode, the control unit 12 outputs a modulated waveform obtained by adding a first offset waveform W1(θ) expressed by Formula (1) having a maximum value fmax(θ) and a minimum value fmin(θ) of a three-phase AC waveform at the electrical angle θ of the motor 20, a first change rate K1, and a sign Sgn (Sgn is 1 or −1) as variables and a three-phase AC waveform. The first change rate K1 of the first deformation mode is larger than 0 and smaller than 1.

$$\begin{matrix}[ Mathematical formula 3 ] & \\ W 1 ( θ ) = \{ 1 - f max ( θ ) - f min ( θ ) \} / 2 + Sgn \times ( 1 - K 1 ) \times \{ 1 - f max ( θ ) + f min ( θ ) \} / 2 & ( 1 )\end{matrix}$$

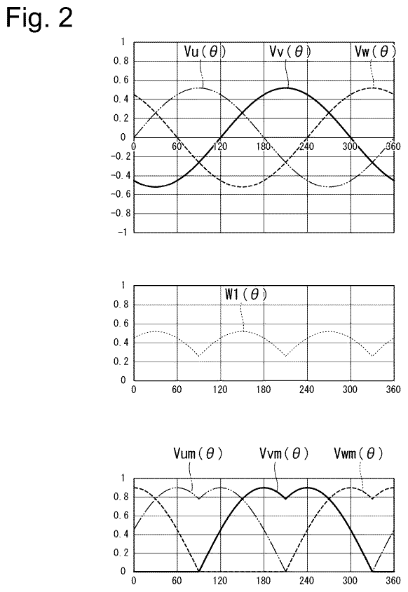

FIG. 2 is a diagram illustrating a first example of a three-phase AC waveform, the first offset waveform W1(θ), and a modulated waveform. The horizontal axis of each graph illustrated in FIG. 2 represents the electrical angle θ of the motor 20, and the vertical axis of each graph represents an instantaneous value of each waveform.

An upper graph of FIG. 2 shows an example of a three-phase AC waveform. The three-phase AC waveform is a function of the electrical angle θ. The three-phase AC waveform includes three sinusoidal waveforms having a phase difference of an electrical angle of 120 degrees from each other. Specifically, the three-phase AC waveform includes a U-phase AC waveform Vu(θ), a V-phase AC waveform Vv(θ), and a W-phase AC waveform Vw(θ). For example, the control unit 12 generates the three-phase AC waveform based on a torque command value or a speed command value from a host control device and a detection value of three-phase current and a rotation angle of the motor 20. Since generating a three-phase AC waveform in this manner is a publicly-known technique in the field of motor control, description of a method of generating a three-phase AC waveform is omitted.

The maximum value fmax(θ) of a three-phase AC waveform at the electrical angle θ is an instantaneous value of an AC waveform having a largest instantaneous value at the electrical angle θ in the three-phase AC waveform. For example, in a case where the electrical angle θ is 180 degrees, since an instantaneous value Vv(180) of the V-phase AC waveform Vv(θ) is largest in a three-phase AC waveform, a value of Vv(180) is substituted into fmax(180) of Formula (1). The minimum value fmin(θ) of a three-phase AC waveform at the electrical angle θ is an instantaneous value of an AC waveform having a smallest instantaneous value at the electrical angle θ in the three-phase AC waveform. For example, in a case where the electrical angle θ is 180 degrees, since an instantaneous value Vw(180) of the W-phase AC waveform Vw(θ) is smallest in a three-phase AC waveform, a value of Vv(180) is substituted into fmax(180) of Formula (1).

A middle graph of FIG. 2 illustrates the first offset waveform W1(θ) calculated by Formula (1) on a condition that the first change rate K1 is 0 and the sign Sgn is −1. A lower graph of FIG. 2 illustrates a modulated waveform obtained by adding the first offset waveform W1(θ) illustrated in the middle part of FIG. 2 and the three-phase AC waveform illustrated in the upper part of FIG. 2. The modulated waveform includes a U-phase modulated waveform Vum(θ), a V-phase modulated waveform Vvm(θ), and a W-phase modulated waveform Vwm(θ).

In the example illustrated in FIG. 2, the U-phase modulated waveform Vum(θ) is a waveform obtained by adding the first offset waveform W1(θ) illustrated in the middle part of FIG. 2 and the U-phase AC waveform Vu(θ) illustrated in the upper part of FIG. 2. The V-phase modulated waveform Vvm(θ) is a waveform obtained by adding the first offset waveform W1(θ) illustrated in the middle part of FIG. 2 and the V-phase AC waveform Vv(θ) illustrated in the upper part of FIG. 2. The W-phase modulated waveform Vwm(0) is a waveform obtained by adding the first offset waveform W1(θ) illustrated in the middle part of FIG. 2 and the W-phase AC waveform Vw(θ) illustrated in the upper part of FIG. 2.

As illustrated in FIG. 2, in a case where a modulated waveform obtained by adding the first offset waveform W1(θ) calculated on a condition that the first change rate K1 is 0 and the sign Sgn is −1 and a three-phase AC waveform is output, the power conversion circuit 11 is controlled by what is called low-side-on-fixed-type two-phase modulation. The low-side-on-fixed-type two-phase modulation is a two-phase modulation method in which, among six switches included in the power conversion circuit 11, a low-side switch of one phase is set to ON, and a switch of a remaining phase is controlled by pulse width modulation. In the low-side-on-fixed-type two-phase modulation, a phase switching cycle in which a low-side switch is set to ON corresponds to ⅓ of one electrical angle cycle (that is, an electrical angle of 120 degrees).

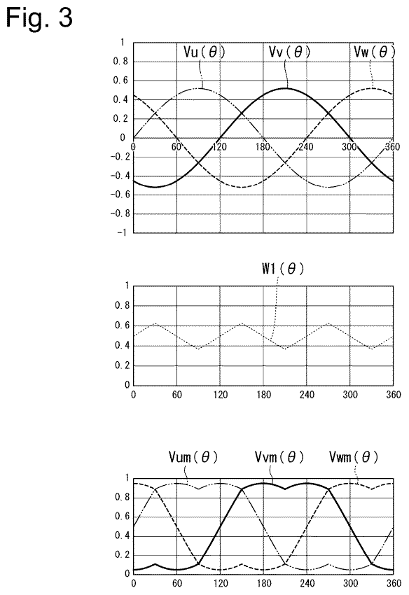

FIG. 3 is a diagram illustrating a second example of a three-phase AC waveform, the first offset waveform W1(θ), and a modulated waveform. The horizontal axis of each graph illustrated in FIG. 3 represents the electrical angle θ of the motor 20, and the vertical axis of each graph represents an instantaneous value of each waveform.

An upper graph of FIG. 3 shows an example of a three-phase AC waveform. The three-phase AC waveform illustrated in FIG. 3 is the same as the three-phase AC waveform illustrated in FIG. 2. A middle graph of FIG. 3 illustrates the first offset waveform W1(θ) calculated by Formula (1) on a condition that the first change rate K1 is 1 and the sign Sgn is 1 or −1. A lower graph of FIG. 3 illustrates a modulated waveform obtained by adding the first offset waveform W1(θ) illustrated in the middle part of FIG. 3 and the three-phase AC waveform illustrated in the upper part of FIG. 3.

In the example illustrated in FIG. 3, the U-phase modulated waveform Vum(θ) is a waveform obtained by adding the first offset waveform W1(θ) illustrated in the middle part of FIG. 3 and the U-phase AC waveform Vu(θ) illustrated in the upper part of FIG. 3. The V-phase modulated waveform Vvm(θ) is a waveform obtained by adding the first offset waveform W1(θ) illustrated in the middle part of FIG. 3 and the V-phase AC waveform Vv(θ) illustrated in the upper part of FIG. 3. The W-phase modulated waveform Vwm(θ) is a waveform obtained by adding the first offset waveform W1(θ) illustrated in the middle part of FIG. 3 and the W-phase AC waveform Vw(θ) illustrated in the upper part of FIG. 3.

As illustrated in FIG. 3, in a case where a modulated waveform obtained by adding the first offset waveform W1(θ) calculated on a condition that the first change rate K1 is 1 and the sign Sgn is 1 or −1 and a three-phase AC waveform is output, the power conversion circuit 11 is controlled by what is called spatial vector modulation. The spatial vector modulation is a three-phase modulation method in which switches of all phases among six switches included in the power conversion circuit 11 are controlled by pulse width modulation.

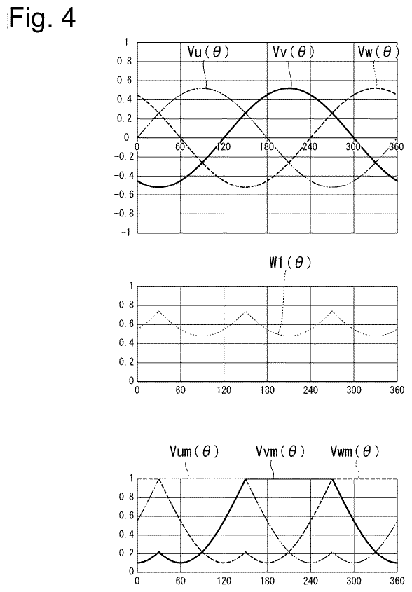

FIG. 4 is a diagram illustrating a third example of a three-phase AC waveform, the first offset waveform W1(θ), and a modulated waveform. The horizontal axis of each graph illustrated in FIG. 4 represents the electrical angle C of the motor 20, and the vertical axis of each graph represents an instantaneous value of each waveform.

An upper graph of FIG. 4 shows an example of a three-phase AC waveform. The three-phase AC waveform illustrated in FIG. 4 is the same as the three-phase AC waveform illustrated in FIG. 2. A middle graph of FIG. 4 illustrates the first offset waveform W1(θ) calculated by Formula (1) on a condition that the first change rate K1 is 0 and the sign Sgn is 1. A lower graph of FIG. 4 illustrates a modulated waveform obtained by adding the first offset waveform W1(θ) illustrated in the middle part of FIG. 4 and the three-phase AC waveform illustrated in the upper part of FIG. 4.

In the example illustrated in FIG. 4, the U-phase modulated waveform Vum(θ) is a waveform obtained by adding the first offset waveform W1(θ) illustrated in the middle part of FIG. 4 and the U-phase AC waveform Vu(θ) illustrated in the upper part of FIG. 4. The V-phase modulated waveform Vvm(θ) is a waveform obtained by adding the first offset waveform W1(θ) illustrated in the middle part of FIG. 4 and the V-phase AC waveform Vv(θ) illustrated in the upper part of FIG. 4. The W-phase modulated waveform Vwm(θ) is a waveform obtained by adding the first offset waveform W1(θ) illustrated in the middle part of FIG. 4 and the W-phase AC waveform Vw(θ) illustrated in the upper part of FIG. 4.

As illustrated in FIG. 4, in a case where a modulated waveform obtained by adding the first offset waveform W1(θ) calculated on a condition that the first change rate K1 is 0 and the sign Sgn is 1 and a three-phase AC waveform is output, the power conversion circuit 11 is controlled by what is called high-side-on-fixed-type two-phase modulation. The high-side-on-fixed-type two-phase modulation is a two-phase modulation method in which, among six switches included in the power conversion circuit 11, a high-side switch of one phase is set to ON, and a switch of a remaining phase is controlled by pulse width modulation. In the high-side-on-fixed-type two-phase modulation, a phase switching cycle in which a high-side switch is set to ON corresponds to ⅓ of one electrical angle cycle (that is, an electrical angle of 120 degrees).

Since the first change rate K1 of the first deformation mode is larger than 0 and smaller than 1, a modulation method during a period in which the control unit 12 operates in the first deformation mode does not completely match any of the low-side-on-fixed-type two-phase modulation, the high-side-on-fixed-type two-phase modulation, and the spatial vector modulation. However, when the first change rate K1 gradually changes from a value larger than 0 to a value smaller than 1 in a state where the sign Sgn is fixed to −1 in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation.

In description below, in a period during which the control unit 12 operates in the first deformation mode, a value larger than 0 that may be taken by the first change rate K1 is referred to as a first lower limit value, and a value smaller than 1 that may be taken by the first change rate K1 is referred to as a first upper limit value. For example, the first lower limit value is 0.01, and the first upper limit value is 0.99.

Further, when the first change rate K1 gradually changes from the first upper limit value to the first lower limit value in a state where the sign Sgn is fixed to −1 in a period in which the control unit 12 operates in the first deformation mode, a modulation method gradually shifts from a modulation method close to a characteristic of the spatial vector modulation to a modulation method close to a characteristic of the low-side-on-fixed-type two-phase modulation.

Further, when the first change rate K1 gradually changes from the first lower limit value to the first upper limit value in a state where the sign Sgn is fixed to 1 in a period in which the control unit 12 operates in the first deformation mode, a modulation method gradually shifts from a modulation method close to a characteristic of the high-side-on-fixed-type two-phase modulation to a modulation method close to a characteristic of the spatial vector modulation.

Furthermore, when the first change rate K1 gradually changes from the first upper limit value to the first lower limit value in a state where the sign Sgn is fixed to 1 in a period in which the control unit 12 operates in the first deformation mode, a modulation method gradually shifts from a modulation method close to a characteristic of the spatial vector modulation to a modulation method close to a characteristic of the high-side-on-fixed-type two-phase modulation.

As described above, in the first embodiment, in a period in which the control unit 12 operates in the first deformation mode, the first change rate K1 of the first deformation mode changes within a range of more than 0 and less than 1 in a state in which the sign Sgn is fixed to 1 or −1. By the above, for example, when the first change rate K1 changes within a range of more than 0 and less than 1 in a state where the sign Sgn is fixed to −1 in a period in which the control unit 12 operates in the first deformation mode, a shift from a modulation method close to a characteristic of the low-side-on-fixed-type two-phase modulation to a modulation method close to a characteristic of the spatial vector modulation, or a shift from a modulation method close to a characteristic of the spatial vector modulation to a modulation method close to a characteristic of the low-side-on-fixed-type two-phase modulation gradually proceeds. As a result, it is possible to reduce a sudden change in noise caused by switching between the modulation method close to a characteristic of the low-side-on-fixed-type two-phase modulation and the modulation method close to a characteristic of the spatial vector modulation, and thus, it is possible to prevent the user from feeling uncomfortable. Further, since it is possible to reduce a sudden change in a switching loss due to switching between both of the modulation methods, it is possible to reduce a torque fluctuation of the motor 20. Furthermore, since it is not necessary to change a modulation rate when a modulation method is switched, it is possible to reduce a change in a rotational speed of the motor 20 accompanying switching of a modulation method.

Further, for example, when the first change rate K1 changes within a range of more than 0 and less than 1 in a state where the sign Sgn is fixed to 1 in a period in which the control unit 12 operates in the first deformation mode, a shift from a modulation method close to a characteristic of the high-side-on-fixed-type two-phase modulation to a modulation method close to a characteristic of the spatial vector modulation, or a shift from a modulation method close to a characteristic of the spatial vector modulation to a modulation method close to a characteristic of the high-side-on-fixed-type two-phase modulation gradually proceeds. As a result, it is possible to reduce a change in a rotational speed of the motor 20, a sudden change in a switching loss, and a sudden change in noise caused by switching between the modulation method close to a characteristic of the high-side-on-fixed-type two-phase modulation and the modulation method close to a characteristic of the spatial vector modulation.

Next, a second embodiment of the present invention will be described. The control unit 12 in the second embodiment is different from that in the first embodiment in that the control unit 12 has not only the first deformation mode but also a first start mode and a first end mode. Therefore, operation of the control unit 12 in the second embodiment will be described in detail below.

In the second embodiment, the control unit 12 operates in the first start mode in which the first change rate K1 is a first predetermined value different from a value in the first deformation mode before operating in the first deformation mode. Further, after operating in the first deformation mode, the control unit 12 operates in the first end mode in which the first change rate K1 is a second predetermined value different from a value in the first deformation mode and the first start mode.

First, operation of the control unit 12 in a first case in which the first change rate K1 of the first start mode is 0, the first change rate K1 of the first end mode is 1, and the sign Sgn is −1 throughout all the modes will be described.

In the first case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 0 and the sign Sgn is −1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In a period during which the control unit 12 operates in the first deformation mode, the first change rate K1 gradually changes (increases) from the first lower limit value to the first upper limit value in a state where the sign Sgn is fixed to −1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 1 and the sign Sgn is −1.

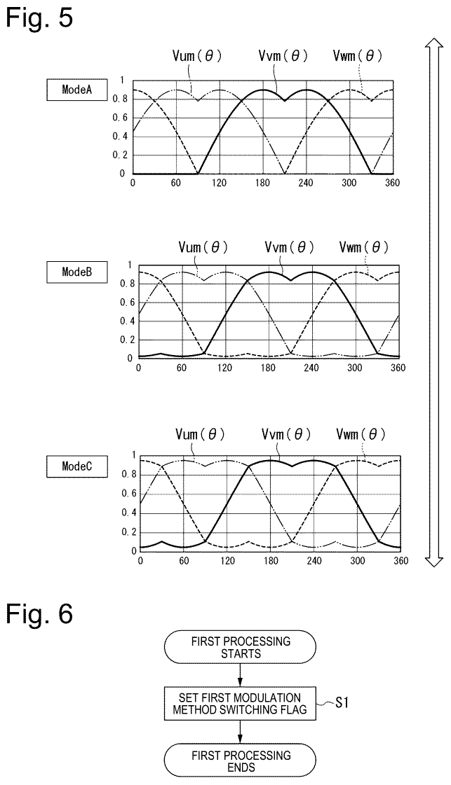

FIG. 5 is a diagram illustrating an example of a modulated waveform output during a period in which the control unit 12 operates in each of the first start mode, the first deformation mode, and the first end mode in the first case. In FIG. 5, “Mode A” indicates a modulated waveform output during a period in which the control unit 12 operates in the first start mode, “Mode B” indicates a modulated waveform output during a period in which the control unit 12 operates in the first deformation mode, and “Mode C” indicates a modulated waveform output during a period in which the control unit 12 operates in the first end mode. The horizontal axis of each graph illustrated in FIG. 5 represents the electrical angle θ of the motor 20, and the vertical axis of each graph represents an instantaneous value of each waveform.

As indicated by “Mode A” in FIG. 5, during a period in which the control unit 12 operates in the first start mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

In a period during which the control unit 12 operates in the first deformation mode, when the first change rate K1 gradually increases from the first lower limit value to the first upper limit value in a state in which the sign Sgn is fixed to −1, a modulated waveform output from the control unit 12 also gradually changes with increase in the first change rate K1. As an example, “Mode B” in FIG. 5 indicates a modulated waveform output when the first change rate K1 is 0.5. As described above, when the first change rate K1 gradually increases from the first lower limit value to the first upper limit value in a state where the sign Sgn is fixed to −1 in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation.

As indicated by “Mode C” in FIG. 5, during a period in which the control unit 12 operates in the first end mode, since a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation

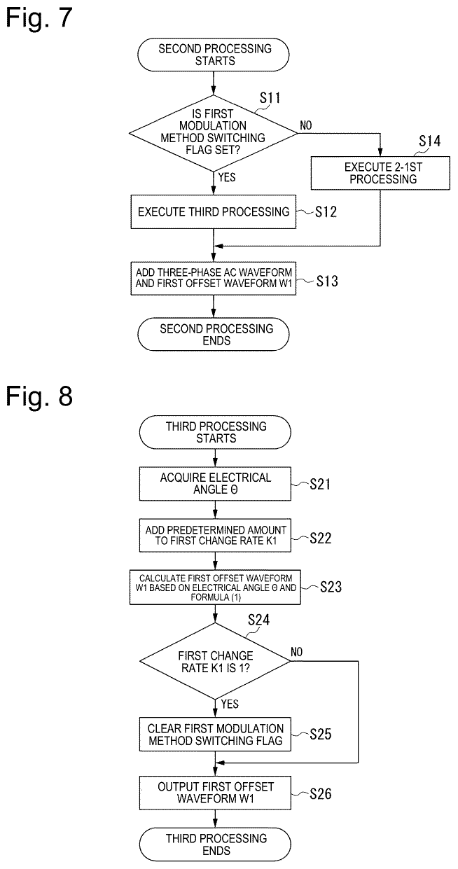

FIG. 6 is a flowchart illustrating first processing executed by the control unit 12 in the first case. FIG. 7 is a flowchart illustrating second processing executed by the control unit 12 in the first case. FIG. 8 is a flowchart illustrating third processing executed by the control unit 12 in the first case. The control unit 12 executes the first processing and the second processing at a predetermined cycle. As described later, the control unit 12 executes the third processing in a case of determining that a first modulation method switching flag is set at the time of executing the second processing.

First, the control unit 12 operates in the first start mode. That is, during a period in which the control unit 12 operates in the first start mode, as a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

As illustrated in FIG. 6, when starting the first processing, the control unit 12 sets the first modulation method switching flag with receiving of a switching command for a modulation method from a host control device during operation in the first start mode as a trigger (Step S1). After executing Step S1, the control unit 12 ends the first processing.

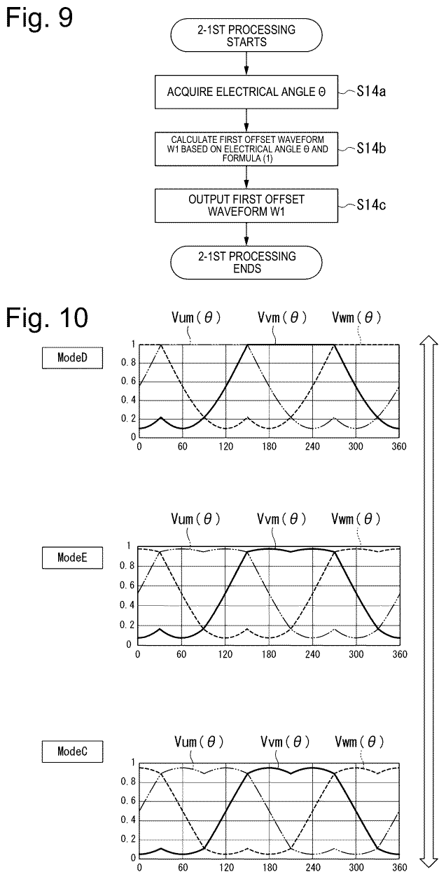

As illustrated in FIG. 7, when starting the second processing, the control unit 12 first determines whether or not the first modulation method switching flag is set (Step S11). In a case of determining that the first modulation method switching flag is not set (Step S11: No), that is, in a case where a switching command for a modulation method is not received from a host control device during operation in the first start mode, the control unit 12 executes 2-1st processing illustrated in FIG. 9 (Step S14).

Note that in execution of the first processing and the second processing at a predetermined cycle, for example, the first processing and the second processing can be executed by being performed at every predetermined time in interrupt processing performed in synchronization with a carrier. For example, in interrupt processing synchronized with a carrier, the first processing and the second processing are performed in interrupt processing performed once every ten times. At this time, in another piece of interrupt processing, the 2-1st processing and Step S13 of the second processing illustrated in FIG. 7 are performed.

As illustrated in FIG. 9, when starting the 2-1st processing, the control unit 12 acquires the electrical angle θ of the motor 20 (Step S14a). For example, in Step S14a, the control unit 12 calculates the electrical angle θ of the motor 20 by multiplying a detection value of a rotation angle of the motor 20 by the number of pole pairs of the motor 20. Then, the control unit 12 calculates the first offset waveform W1(θ) based on the acquired electrical angle θ and Formula (1) (Step S14b). In Step S14b, the control unit 12 calculates the first offset waveform W1(θ) on a condition that the first change rate K1 is 0 and the sign Sgn is −1. The control unit 12 outputs the first offset waveform W1(θ) calculated in Step S14b (Step S14c). After executing Step S14c, the control unit 12 ends the 2-1st processing and proceeds to Step S13 of the second processing illustrated in FIG. 7.

As illustrated in FIG. 7, when proceeding to Step S13 of the second processing after the 2-1st processing ends, the control unit 12 adds the first offset waveform W1(θ) output in Step S14c of the 2-1st processing and a three-phase AC waveform at the same electrical angle θ as the first offset waveform W1(θ) to calculate a modulated waveform at the same electrical angle θ (Step S13). After executing Step S13, the control unit 12 ends the second processing. As described above, in a case of determining that the first modulation method switching flag is not set, the control unit 12 continues to operate in the first start mode corresponding to the low-side-on-fixed-type two-phase modulation.

On the other hand, as illustrated in FIG. 7, in a case of determining that the first modulation method switching flag is set (Step S11: Yes), that is, in a case where a switching command for a modulation method is received from a host control device during operation in the first start mode, the control unit 12 executes the third processing illustrated in FIG. 8 (Step S12). When the control unit 12 starts the third processing, a mode of the control unit 12 is switched from the first start mode to the first deformation mode.

As illustrated in FIG. 8, when starting the third processing, the control unit 12 acquires the electrical angle θ of the motor 20 (Step S21). Then, the control unit 12 adds a predetermined amount to the first change rate K1 (Step S22). For example, the predetermined amount is 0.01. The control unit 12 calculates the first offset waveform W1(θ) based on the acquired electrical angle θ and Formula (1) (Step S23). In Step S23, the control unit 12 calculates the first offset waveform W1(θ) with the sign Sgn as −1.

Subsequently, the control unit 12 determines whether or not the first change rate K1 is 1 (Step S24). In a case of determining that the first change rate K1 is 1 (Step S24: Yes), the control unit 12 clears the first modulation method switching flag (Step S25). After clearing the first modulation method switching flag, the control unit 12 outputs the first offset waveform W1(θ) calculated in Step S23 (Step S26). On the other hand, in a case of determining that the first change rate K1 is not 1 (Step S24: No), the control unit 12 skips Step S25 and proceeds to Step 526. After executing Step S26, the control unit 12 ends the third processing and proceeds to Step S13 of the second processing illustrated in FIG. 7.

As illustrated in FIG. 7, when proceeding to Step S13 of the second processing after the third processing ends, the control unit 12 adds the first offset waveform W1(θ) output in Step S26 of the third processing and a three-phase AC waveform at the same electrical angle θ as the first offset waveform W1(θ) to calculate a modulated waveform at the same electrical angle θ (Step S13). After executing Step S13, the control unit 12 ends the second processing.

The control unit 12 continues to operate in the first deformation mode until the first change rate K1 is determined to be 1 in Step S24 of the third processing. That is, when the first change rate K1 increases by a predetermined amount from the first lower limit value to the first upper limit value in a state where the sign Sgn is set to −1 in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation.

Then, when the first change rate K1 becomes 1 and the first modulation method switching flag is cleared, the mode of the control unit 12 is switched from the first deformation mode to the first end mode. That is, during a period in which the control unit 12 operates in the first end mode, as a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation.

During a period in which the control unit 12 operates in the first start mode, since the power conversion circuit 11 is controlled by the low-side-on-fixed-type two-phase modulation, a switching loss is relatively small, but noise is relatively large. On the other hand, during a period in which the control unit 12 operates in the first end mode, since the power conversion circuit 11 is controlled by the spatial vector modulation, noise is relatively small, but a switching loss is relatively large. If the first start mode and the first end mode are instantaneously switched, a torque fluctuation may occur due to a sudden change in a switching loss, and the user may feel uncomfortable due to a sudden change in noise.

However, in the first case of the second embodiment, the control unit 12 operates in the first deformation mode in a period between a period in which to operate in the first start mode and a period in which to operate in the first end mode. Then, in a period during which the control unit 12 operates in the first deformation mode, the first change rate K1 gradually increases from the first lower limit value to the first upper limit value in a state where the sign Sgn is fixed to −1. By the above, in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation. As a result, since it is possible to reduce a sudden change in a switching loss and a sudden change in noise due to switching of a modulation method from the low-side-on-fixed-type two-phase modulation (modulation method of the first start mode) to the spatial vector modulation (modulation method of the first end mode), and thus, it is possible to reduce a torque fluctuation of the motor 20 and to prevent the user from feeling uncomfortable. Furthermore, similarly to the first embodiment, according to the first case of the second embodiment, since it is not necessary to change a modulation rate when a modulation method is switched, it is possible to reduce a change in a rotational speed of the motor 20 accompanying switching of a modulation method.

Next, operation of the control unit 12 in a second case in which the first change rate K1 of the first start mode is 1, the first change rate K1 of the first end mode is 0, and the sign Sgn is −1 throughout all the modes will be described.

In the second case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 1 and the sign Sgn is −1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In a period during which the control unit 12 operates in the first deformation mode, the first change rate K1 gradually changes (decreases) from the first upper limit value to the first lower limit value in a state where the sign Sgn is fixed to −1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is −1.

In the second case, “Mode C” in FIG. 5 indicates a modulated waveform output during a period in which the control unit 12 operates in the first start mode, “Mode B” in FIG. 5 indicates a modulated waveform output during a period in which the control unit 12 operates in the first deformation mode, and “Mode A” in FIG. 5 indicates a modulated waveform output during a period in which the control unit 12 operates in the first end mode.

That is, in the second case, as indicated by “Mode C” in FIG. 5, during a period in which the control unit 12 operates in the first start mode, since a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation

In the second case, as indicated by “Mode B” in FIG. 5, in a period during which the control unit 12 operates in the first deformation mode, when the first change rate K1 gradually decreases from the first upper limit value to the first lower limit value in a state in which the sign Sgn is fixed to −1, a modulated waveform output from the control unit 12 also gradually changes with decrease in the first change rate K1. As a result, in a period in which the control unit 12 operates in the first deformation mode, a modulation method gradually shifts from a modulation method close to a characteristic of the spatial vector modulation to a modulation method close to a characteristic of the low-side-on-fixed-type two-phase modulation.

In the second case, as indicated by “Mode A” in FIG. 5, during a period in which the control unit 12 operates in the first end mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

The first processing and the second processing executed by the control unit 12 in the second case are the same as the first processing and the second processing in the first case. The third processing executed by the control unit 12 in the second case is basically the same as the third processing in the first case, but in the steps included in the third processing in the second case, content of Steps S22 and S24 is different from that of the third processing in the first case. In the second case, content of Step S22 of the third processing changes to “the control unit 12 subtracts a predetermined amount from the first change rate K1”. In the second case, content of Step S24 of the third processing changes to “the control unit 12 determines whether or not the first change rate K1 is 0”.

As described above, in the second case of the second embodiment, in a period during which the control unit 12 operates in the first deformation mode, the first change rate K1 gradually decreases from the first upper limit value to the first lower limit value in a state where the sign Sgn is fixed to −1. By the above, in a period in which the control unit 12 operates in the first deformation mode, a modulation method gradually shifts from a modulation method close to a characteristic of the spatial vector modulation to a modulation method close to a characteristic of the low-side-on-fixed-type two-phase modulation. As a result, it is possible to reduce a change in a rotational speed of the motor 20, a sudden change in noise, and a sudden change in a switching loss due to switching of a modulation method from the spatial vector modulation (modulation method of the first start mode) to the low-side-on-fixed-type two-phase modulation (modulation method of the first end mode).

Next, operation of the control unit 12 in the third case where the first change rate K1 of the first start mode is 0, the first change rate K1 of the first end mode is 1, and the sign Sgn is 1 throughout all modes will be described.

In the third case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 0 and the sign Sgn is 1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In a period during which the control unit 12 operates in the first deformation mode, the first change rate K1 gradually changes (increases) from the first lower limit value to the first upper limit value in a state where the sign Sgn is fixed to 1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 1 and the sign Sgn is 1.

FIG. 10 is a diagram illustrating an example of a modulated waveform output during a period in which the control unit 12 operates in each of the first start mode, the first deformation mode, and the first end mode in the third case. In FIG. 10, “Mode D” indicates a modulated waveform output during a period in which the control unit 12 operates in the first start mode, “Mode E” indicates a modulated waveform output during a period in which the control unit 12 operates in the first deformation mode, and “Mode C” indicates a modulated waveform output during a period in which the control unit 12 operates in the first end mode. The horizontal axis of each graph illustrated in FIG. 10 represents the electrical angle θ of the motor 20, and the vertical axis of each graph represents an instantaneous value of each waveform.

As indicated by “Mode D” in FIG. 10, during a period in which the control unit 12 operates in the first start mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

In a period during which the control unit 12 operates in the first deformation mode, when the first change rate K1 gradually increases from the first lower limit value to the first upper limit value in a state in which the sign Sgn is fixed to 1, a modulated waveform output from the control unit 12 also gradually changes with increase in the first change rate K1. As an example, “Mode E” in FIG. 10 indicates a modulated waveform output when the first change rate K1 is 0.5. As described above, when the first change rate K1 gradually increases from a lower limit value to an upper limit value in a state where the sign Sgn is fixed to 1 in a period in which the control unit 12 operates in the first deformation mode, a modulation method gradually shifts from a modulation method close to a characteristic of the high-side-on-fixed-type two-phase modulation to a modulation method close to a characteristic of the spatial vector modulation.

As indicated by “Mode C” in FIG. 10, during a period in which the control unit 12 operates in the first end mode, since a modulated waveform obtained by adding the first offset waveform W1(θ) calculated on a condition that the first change rate K1 is 1 and the sign Sgn is 1 and a three-phase AC waveform is output, the power conversion circuit 11 is controlled by the spatial vector modulation.

The first processing, the second processing, and the third processing executed by the control unit 12 in the third case are basically the same as those in the first case, but are different from those in the first case in that each piece of processing is executed in a state where the sign Sgn is fixed to 1.

As described above, in the third case of the second embodiment, in a period in which the control unit 12 operates in the first deformation mode, the first change rate K1 gradually increases from the first lower limit value to the first upper limit value in a state where the sign Sgn is fixed to 1. By the above, in a period in which the control unit 12 operates in the first deformation mode, a modulation method gradually shifts from a modulation method close to a characteristic of the high-side-on-fixed-type two-phase modulation to a modulation method close to a characteristic of the spatial vector modulation. As a result, it is possible to reduce a change in a rotational speed of the motor 20, a sudden change in noise, and a sudden change in a switching loss due to switching of a modulation method from the high-side-on-fixed-type two-phase modulation (modulation method of the first start mode) to the spatial vector modulation (modulation method of the first end mode).

Next, operation of the control unit 12 in a fourth case in which the first change rate K1 of the first start mode is 1, the first change rate K1 of the first end mode is 0, and the sign Sgn is 1 throughout all the modes will be described.

In the fourth case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 1 and the sign Sgn is 1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In a period during which the control unit 12 operates in the first deformation mode, the first change rate K1 gradually changes (decreases) from the first upper limit value to the first lower limit value in a state where the sign Sgn is fixed to 1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is 1.

In the fourth case, “Mode C” in FIG. 10 indicates a modulated waveform output during a period in which the control unit 12 operates in the first start mode, “Mode E” in FIG. 10 indicates a modulated waveform output during a period in which the control unit 12 operates in the first deformation mode, and “Mode D” in FIG. 10 indicates a modulated waveform output during a period in which the control unit 12 operates in the first end mode.

That is, in the fourth case, as indicated by “Mode C” in FIG. 10, during a period in which the control unit 12 operates in the first start mode, since a modulated waveform obtained by adding the first offset waveform W1(θ) calculated on a condition that the first change rate K1 is 1 and the sign Sgn is 1 and a three-phase AC waveform is output, the power conversion circuit 11 is controlled by the spatial vector modulation.

In the fourth case, as indicated by “Mode E” in FIG. 10, in a period during which the control unit 12 operates in the first deformation mode, when the first change rate K1 gradually decreases from the first upper limit value to the first lower limit value in a state in which the sign Sgn is fixed to 1, a modulated waveform output from the control unit 12 also gradually changes with decrease in the first change rate K1. As a result, in a period in which the control unit 12 operates in the first deformation mode, a modulation method gradually shifts from a modulation method close to a characteristic of the spatial vector modulation to a modulation method close to a characteristic of the high-side-on-fixed-type two-phase modulation.

In the fourth case, as indicated by “Mode D” in FIG. 10, during a period in which the control unit 12 operates in the first end mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

The first processing, the second processing, and the third processing executed by the control unit 12 in the fourth case are basically the same as those in the second case, but are different from those in the second case in that each piece of processing is executed in a state where the sign Sgn is fixed to 1.

As described above, in the fourth case of the second embodiment, in a period during which the control unit 12 operates in the first deformation mode, the first change rate K1 gradually decreases from the first upper limit value to the first lower limit value in a state where the sign Sgn is fixed to 1. By the above, in a period in which the control unit 12 operates in the first deformation mode, a modulation method gradually shifts from a modulation method close to a characteristic of the spatial vector modulation to a modulation method close to a characteristic of the high-side-on-fixed-type two-phase modulation. As a result, it is possible to reduce a change in a rotational speed of the motor 20, a sudden change in noise, and a sudden change in a switching loss due to switching of a modulation method from the spatial vector modulation (modulation method of the first start mode) to the high-side-on-fixed-type two-phase modulation (modulation method of the first end mode).

Note that, in the second embodiment, the case where the first change rate K1 of the first start mode is 0 and the first change rate K1 of the first end mode is 1 and the case where the first change rate K1 of the first start mode is 1 and the first change rate K1 of the first end mode is 0 are described, but the present invention is not limited to this.

For example, the first change rate K1 of one of the first start mode and the first end mode may be 0, and the first change rate K1 of the other may be a value larger than 0 and equal to or less than 1. In other words, a modulation method of one of the first start mode and the first end mode may be the low-side-on-fixed-type two-phase modulation or the high-side-on-fixed-type two-phase modulation, and a modulation method of the other may be a modulation method close to a characteristic of the spatial vector modulation.

Further, for example, the first change rate K1 of one of the first start mode and the first end mode may be 1, and the first change rate K1 of the other may be 0 or more and smaller than 1. In other words, a modulation method of one of the first start mode and the first end mode may be the spatial vector modulation, and a modulation method of the other may be a modulation method close to a characteristic of the low-side-on-fixed-type two-phase modulation or a modulation method close to a characteristic of the high-side-on-fixed-type two-phase modulation.

Next, a third embodiment of the present invention will be described. A part of the first deformation mode of the control unit 12 of the third embodiment is different from the first deformation mode of the first embodiment. Further, the control unit 12 of the third embodiment is different from that of the first embodiment in that the control unit 12 has not only the first deformation mode but also a first movement mode, the first start mode, and the first end mode. Therefore, operation of the control unit 12 in the third embodiment will be described in detail below.

In the first deformation mode, the control unit 12 of the third embodiment is the same as that in the first embodiment in that the control unit 12 outputs a modulated waveform obtained by adding the first offset waveform W1(θ) expressed by Formula (1) and a three-phase AC waveform. Furthermore, in the first deformation mode, the control unit 12 according to the third embodiment outputs, as a final modulated waveform, a modulated waveform obtained by adding a second offset waveform W2 expressed by Formula (2) having the first change rate K1, a modulation rate m, and the sign Sgn as variables and the above-described modulated waveform. In a period in which the control unit 12 operates in the first deformation mode, the first change rate K1 changes within a range of more than 0 and less than 1 in a state in which the sign Sgn is fixed to 1 or −1.

$$\begin{matrix}[ Mathematical formula 4 ] & \\ W 2 = Sgn \times K 1 \times ( 1 - m ) / 2 & ( 2 )\end{matrix}$$

In the third embodiment, the control unit 12 operates in the first start mode in which the first change rate K1 is a first predetermined value different from a value in the first deformation mode before operating in the first deformation mode. Further, after operating in the first deformation mode, the control unit 12 operates in the first end mode in which the first change rate K1 is a second predetermined value different from a value in the first deformation mode and the first start mode. As described below, there are a case where the control unit 12 operates in the first movement mode in a period between a period in which to operate in the first deformation mode and a period in which to operate in the first end mode, and a case where the control unit 12 operates in the first movement mode in a period between a period in which to operate in the first start mode and a period in which to operate in the first deformation mode.

First, operation of the control unit 12 in a first case in which the first change rate K1 of the first start mode is 0, the first change rate K1 of the first movement mode and the first end mode is 1, and the sign Sgn is −1 throughout all the modes will be described.

In the first case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 0 and the sign Sgn is −1, and the second offset waveform W2 is 0, for example.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first deformation mode, the first change rate K1 gradually changes (increases) from the first lower limit value to the first upper limit value in a state where the sign Sgn is fixed to −1.

After operating in the first deformation mode, the control unit 12 operates in the first movement mode. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is −1. Further, during a period in which the control unit 12 operates in the first movement mode, an absolute value of the second offset waveform W2 gradually changes (decreases) from Sgn×(1−m)/2 to 0.

After operating in the first movement mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 1 and the sign Sgn is −1.

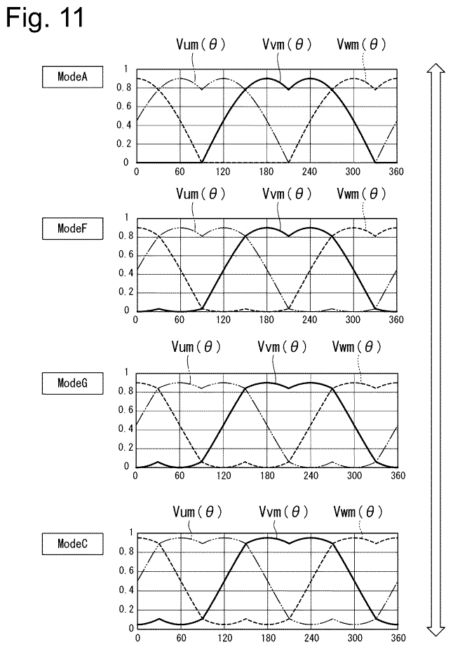

FIG. 11 is a diagram illustrating an example of a modulated waveform output during a period in which the control unit 12 operates in each of the first start mode, the first deformation mode, the first movement mode, and the first end mode in the first case. In FIG. 11, “Mode A” indicates a modulated waveform output during a period in which the control unit 12 operates in the first start mode, “Mode F” indicates a modulated waveform output during a period in which the control unit 12 operates in the first deformation mode, “Mode G” indicates a modulated waveform output during a period in which the control unit 12 operates in the first movement mode, and “Mode C” indicates a modulated waveform output during a period in which the control unit 12 operates in the first end mode. The horizontal axis of each graph illustrated in FIG. 11 represents the electrical angle θ of the motor 20, and the vertical axis of each graph represents an instantaneous value of each waveform.

As indicated by “Mode A” in FIG. 11, during a period in which the control unit 12 operates in the first start mode, since a modulated waveform obtained by adding the first offset waveform W1(θ) calculated on a condition that the first change rate K1 is 0 and the sign Sgn is −1 and a three-phase AC waveform is output, and a modulated waveform obtained by adding the modulated waveform and the second offset waveform W2 that is 0 is output as a final modulated waveform, the power conversion circuit 11 is controlled by the low-side-on-fixed-type two-phase modulation.

In a period during which the control unit 12 operates in the first deformation mode, when the first change rate K1 gradually increases from the first lower limit value to the first upper limit value in a state in which the sign Sgn is fixed to −1, a modulated waveform output from the control unit 12 also gradually changes with increase in the first change rate K1. As an example, “Mode F” in FIG. 11 indicates a modulated waveform output when the first change rate K1 is 0.5. As described above, when the first change rate K1 gradually increases from a lower limit value to an upper limit value in a state where the sign Sgn is fixed to −1 in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation. Furthermore, the second offset waveform W2 calculated by Formula (2) is added to a modulated waveform output during a period in which the control unit 12 operates in the first deformation mode. By the above, as indicated by “Mode F” in FIG. 11, a lower end of a modulated waveform output during a period in which control unit 12 operates in the first deformation mode sticks to 0 (reference voltage value).

In a case where, in a period in which the control unit 12 operates in the first movement mode, a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually decreases from Sgn×(1−m)/2 to 0, a modulated waveform stuck to 0 gradually moves to the high voltage side. In a period during which the control unit 12 operates in the first movement mode, the power conversion circuit 11 is controlled by a modulation method close to a characteristic of the spatial vector modulation. As an example, “Mode G” in FIG. 11 indicates a modulated waveform output when an absolute value of the second offset waveform W2 is Sgn×(1−m)/2.

As indicated by “Mode C” in FIG. 11, during a period in which the control unit 12 operates in the first end mode, since a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation

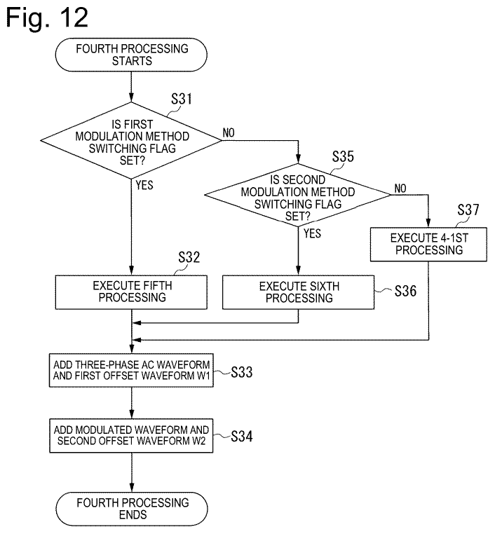

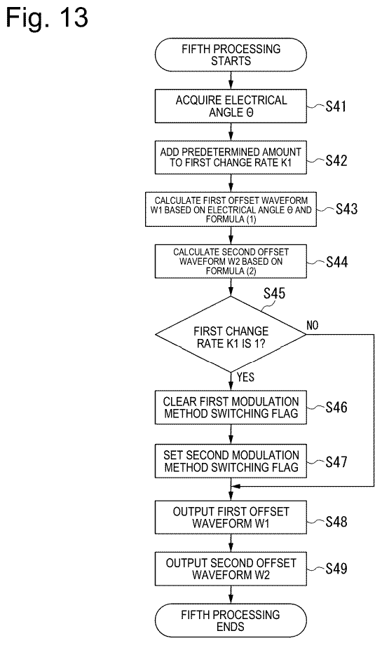

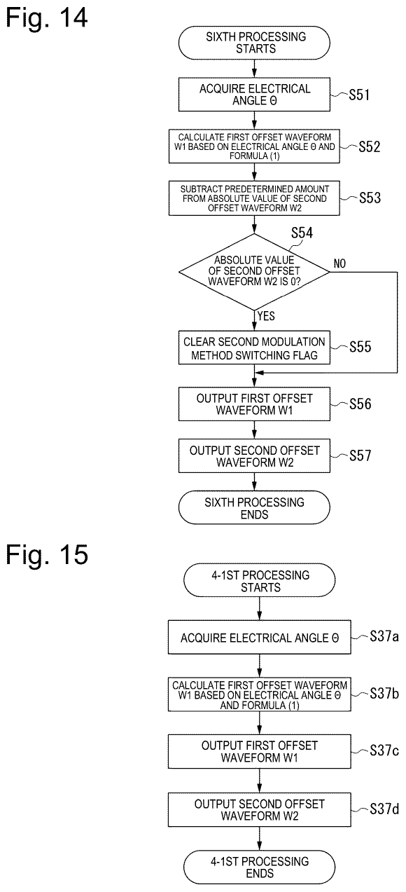

In the first case, the control unit 12 executes fourth processing, fifth processing, and sixth processing in addition to the first processing that is the same as that in the first embodiment. FIG. 12 is a flowchart illustrating the fourth processing executed by the control unit 12. FIG. 13 is a flowchart illustrating the fifth processing executed by the control unit 12. FIG. 14 is a flowchart illustrating the sixth processing executed by the control unit 12. The control unit 12 executes the first processing and the fourth processing at a predetermined cycle. As described later, the control unit 12 executes the fifth processing in a case of determining that the first modulation method switching flag is set at the time of executing the fourth processing. Further, in a case of determining that a second modulation method switching flag is set at the time of executing the fourth processing, the control unit 12 executes the sixth processing.

First, the control unit 12 operates in the first start mode. That is, during a period in which the control unit 12 operates in the first start mode, as a modulated waveform obtained by adding the first offset waveform W1(θ) calculated on a condition that the first change rate K1 is 0 and the sign Sgn is −1 and a three-phase AC waveform is output, and a modulated waveform obtained by adding the modulated waveform and the second offset waveform W2 that is 0 is output as a final modulated waveform, the power conversion circuit 11 is controlled by the low-side-on-fixed-type two-phase modulation.

As illustrated in FIG. 6, when starting the first processing, the control unit 12 sets the first modulation method switching flag with receiving of a switching command for a modulation method from a host control device during operation in the first start mode as a trigger (Step S1). After executing Step S1, the control unit 12 ends the first processing.

As illustrated in FIG. 12, when starting the fourth processing, the control unit 12 first determines whether or not the first modulation method switching flag is set (Step S31). In a case of determining that the first modulation method switching flag is not set (Step S31: No), the control unit 12 determines whether or not the second modulation method switching flag is set (Step S35). In a case of determining that the second modulation method switching flag is not set (Step S35: No), the control unit 12 executes 4-1st processing illustrated in FIG. 15 (Step S37).

Note that in execution of the first processing and the fourth processing at a predetermined cycle, for example, the first processing and the fourth processing can be executed by being performed at every predetermined time in interrupt processing performed in synchronization with a carrier. For example, in interrupt processing synchronized with a carrier, the first processing and the fourth processing are performed in interrupt processing performed once every ten times. At this time, in another piece of interrupt processing, the 4-1st processing, Step S33 of the fourth processing illustrated in FIG. 12, and Step S34 of the fourth processing illustrated in FIG. 12 are performed.

As illustrated in FIG. 15, when starting the 4-1st processing, the control unit 12 acquires the electrical angle θ of the motor 20 (Step S37a). Then, the control unit 12 calculates the first offset waveform W1(θ) based on the acquired electrical angle θ and Formula (1) (Step S37b). In Step S37b, the control unit 12 calculates the first offset waveform W1(θ) on a condition that the first change rate K1 is 0 and the sign Sgn is −1. The control unit 12 outputs the first offset waveform W1(θ) calculated in Step S37b (Step S37c). The control unit 12 outputs the second offset waveform W2 of 0 (Step S37d). After executing Step S37d, the control unit 12 ends the 4-1st processing and proceeds to Step S33 of the fourth processing illustrated in FIG. 12.

As illustrated in FIG. 12, when proceeding to Step S33 of the fourth processing after the 4-1st processing ends, the control unit 12 adds the first offset waveform W1(θ) output in Step S37c of the 4-1st processing and a three-phase AC waveform at the same electrical angle θ as the first offset waveform W1(θ) to calculate a modulated waveform at the same electrical angle θ (Step S33). Then, the control unit 12 adds the second offset waveform W2 output in Step S37d of the 4-1st processing and the modulated waveform calculated in Step S33 to calculate a modulated waveform to be finally output (Step S34). After executing Step S34, the control unit 12 ends the fourth processing. As described above, in a case of determining that both the first modulation method switching flag and the second modulation method switching flag are not set, the control unit 12 continues to operate in the first start mode corresponding to the low-side-on-fixed-type two-phase modulation.

On the other hand, as illustrated in FIG. 12, in a case of determining that the first modulation method switching flag is set (Step S31: Yes), that is, in a case where a switching command for a modulation method is received from a host control device during operation in the first start mode, the control unit 12 executes the fifth processing illustrated in FIG. 13 (Step S32). When the control unit 12 starts the fifth processing, a mode of the control unit 12 is switched from the first start mode to the first deformation mode.

As illustrated in FIG. 13, when starting the fifth processing, the control unit 12 acquires the electrical angle θ of the motor 20 (Step S41). Then, the control unit 12 adds a predetermined amount to the first change rate K1 (Step S42). The control unit 12 calculates the first offset waveform W1(θ) based on the acquired electrical angle θ and Formula (1) (Step S43). In Step S43, the control unit 12 calculates the first offset waveform W1(θ) with the sign Sgn as −1.

Then, the control unit 12 calculates the second offset waveform W2 based on Formula (2) (Step S44). In Step S44, the control unit 12 calculates the second offset waveform W2 with the sign Sgn as −1.

Subsequently, the control unit 12 determines whether or not the first change rate K1 is 1 (Step S45). In a case of determining that the first change rate K1 is 1 (Step S45: Yes), the control unit 12 clears the first modulation method switching flag (Step S46). Then, the control unit 12 sets a second modulation method switching flag (Step S47). Then, after setting the second modulation method switching flag, the control unit 12 outputs the first offset waveform W1(θ) calculated in Step S43 (Step S48). Furthermore, the control unit 12 outputs the second offset waveform W2 calculated in Step S44 (Step S49).

On the other hand, in a case of determining that the first change rate K1 is not 1 (Step S45: No), the control unit 12 skips Steps S46 and S47 and proceeds to Step S48. After executing Step S49, the control unit 12 ends the fifth processing and proceeds to Step S33 of the fourth processing illustrated in FIG. 12.

As illustrated in FIG. 12, when proceeding to Step S33 of the fourth processing after the fifth processing ends, the control unit 12 adds the first offset waveform W1(θ) output in Step S48 of the fifth processing and a three-phase AC waveform at the same electrical angle θ as the first offset waveform W1(θ) to calculate a modulated waveform at the same electrical angle θ (Step S33).

Then, the control unit 12 adds the second offset waveform W2 output in Step S49 of the fifth processing and the modulated waveform calculated in Step S33 to calculate a modulated waveform to be finally output (Step S34). After executing Step S34, the control unit 12 ends the fourth processing.

The control unit 12 continues to operate in the first deformation mode until the first change rate K1 is determined to be 1 in Step S45 of the fifth processing. That is, when the first change rate K1 increases by a predetermined amount from the first lower limit value to the first upper limit value in a state where the sign Sgn is fixed to −1 in a period in which the control unit 12 operates in the first deformation mode, a modulation method gradually shifts from a modulation method close to a characteristic of the low-side-on-fixed-type two-phase modulation to a modulation method close to a characteristic of the spatial vector modulation. Furthermore, since the second offset waveform W2 calculated by Formula (2) is added to a modulated waveform output during a period in which the control unit 12 operates in the first deformation mode, a lower end of the modulated waveform sticks to 0.

As illustrated in FIG. 12, in a case of determining that the second modulation method switching flag is set after determining that the first modulation method switching flag is not set (Step S35: Yes), that is, in a case where the first change rate K1 reaches 1 in the fifth processing, the control unit 12 executes the sixth processing illustrated in FIG. 14 (Step S36). When the control unit 12 starts the sixth processing, a mode of the control unit 12 is switched from the first deformation mode to the first movement mode.

As illustrated in FIG. 14, when starting the sixth processing, the control unit 12 acquires the electrical angle θ of the motor 20 (Step S51). The control unit 12 calculates the first offset waveform W1(θ) based on the acquired electrical angle θ and Formula (1) (Step S52). In Step S52, the control unit 12 calculates the first offset waveform W1(θ) with the sign Sgn as −1.

Then, the control unit 12 subtracts a predetermined amount from an absolute value of the second offset waveform W2 (Step S53). Note that, since an absolute value of the second offset waveform W2 is Sgn×(1−m)/2 when the first sixth processing is executed, when Step S53 of the first sixth processing is executed, a predetermined amount is subtracted from Sgn×(1−m)/2.

Subsequently, the control unit 12 determines whether or not an absolute value of the second offset waveform W2 is 0 (Step S54). In a case of determining that an absolute value of the second offset waveform W2 is 0 (Step S54: Yes), the control unit 12 clears the second modulation method switching flag (Step S55). Then, after clearing the second modulation method switching flag, the control unit 12 outputs the first offset waveform W1(θ) calculated in Step S52 (Step S56). Furthermore, the control unit 12 outputs the second offset waveform W2 calculated in Step S53 (Step S57).

On the other hand, in a case of determining that an absolute value of the second offset waveform W2 is not 0 (Step S54: No), the control unit 12 skips Step S55 and proceeds to Step 556. After executing Step S57, the control unit 12 ends the sixth processing and proceeds to Step S33 of the fourth processing illustrated in FIG. 12.

As illustrated in FIG. 12, when proceeding to Step S33 of the fourth processing after the sixth processing ends, the control unit 12 adds the first offset waveform W1(θ) output in Step S56 of the sixth processing and a three-phase AC waveform at the same electrical angle θ as the first offset waveform W1(θ) to calculate a modulated waveform at the same electrical angle θ (Step S33).

Then, the control unit 12 adds the second offset waveform W2 output in Step S57 of the sixth processing and the modulated waveform calculated in Step S33 to calculate a modulated waveform to be finally output (Step S34). After executing Step S34, the control unit 12 ends the fourth processing.

The control unit 12 continues to operate in the first movement mode until an absolute value of the second offset waveform W2 is determined to be 0 in Step S54 of the sixth processing. That is, in a period in which the control unit 12 operates in the first movement mode, since a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform decreases by a predetermined amount at a time from Sgn×(1−m)/2 to 0, a modulated waveform stuck to 0 gradually moves to the high voltage side.

Then, when an absolute value of the second offset waveform W2 becomes 0 and the second modulation method switching flag is cleared, a mode of the control unit 12 is switched from the first movement mode to the first end mode. That is, during a period in which the control unit 12 operates in the first end mode, as a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation.

As described above, in the first case of the third embodiment, the control unit 12 operates in the first start mode corresponding to the low-side-on-fixed-type two-phase modulation, the first deformation mode, the first movement mode, and the first end mode corresponding to the spatial vector modulation in this order. Then, during a period in which the control unit 12 operates in the first deformation mode, in a state in which a lower end of a modulated waveform sticks to 0, a modulation method gradually shifts from a modulation method close to a characteristic of the low-side-on-fixed-type two-phase modulation to a modulation method close to a characteristic of the spatial vector modulation. Further, during a period in which the control unit 12 operates in the first movement mode, a modulated waveform stuck to 0 gradually moves to the high voltage side while the power conversion circuit 11 is controlled by a modulation method close to a characteristic of the spatial vector modulation, and the power conversion circuit 11 is finally controlled by the spatial vector modulation.

In FIG. 11, a modulated waveform is expressed in sufficiently small resolution. However, in a case where the above-described mode switching function is implemented in a microcomputer or the like actually used as the control unit 12, a modulated waveform calculated by the microcomputer has a certain magnitude. For example, in a case where resolution is 0.001, a value less than 0.001 in a numerical value on the vertical axis of each graph illustrated in FIG. 11 is regarded as 0 on a microcomputer. Further, in a case where a numerical value on the vertical axis is small and ON time of pulse width modulation is close to turn-on or turn-off transition time of a switching element, a normal ON waveform is not output, and thus output is also regarded as 0.

Therefore, as in the first case of the third embodiment, in a case where a lower end of a modulated waveform is stuck to 0 during a period in which the control unit 12 operates in the first deformation mode, switching of a low-side switch is stopped, so that a switching loss can be reduced. Further, according to the first case of the third embodiment, similarly to the first case of the second embodiment, since it is possible to reduce a sudden change in a switching loss and a sudden change in noise due to switching of a modulation method from the low-side-on-fixed-type two-phase modulation (modulation method of the first start mode) to the spatial vector modulation (modulation method of the first end mode), and thus, it is possible to reduce a torque fluctuation of the motor 20 and to prevent the user from feeling uncomfortable. Furthermore, similarly to the first case of the second embodiment, according to the first case of the third embodiment, since it is not necessary to change a modulation rate when a modulation method is switched, it is possible to reduce a change in a rotational speed of the motor 20 accompanying switching of a modulation method.

Next, operation of the control unit 12 in a second case in which the first change rate K1 of the first start mode and the first movement mode is 1, the first change rate K1 of the first end mode is 0, and the sign Sgn is −1 throughout all the modes will be described.

In the second case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 1 and the sign Sgn is −1, and the second offset waveform W2 is 0, for example.

In the second case, the control unit 12 operates in the first movement mode after operating in the first start mode. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is −1. Further, during a period in which the control unit 12 operates in the first movement mode, an absolute value of the second offset waveform W2 gradually changes (increases) from 0 to Sgn×(1−m)/2.

In the second case, the control unit 12 operates in the first deformation mode after operating in the first movement mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first deformation mode, the first change rate K1 gradually changes (decreases) from the first upper limit value to the first lower limit value in a state where the sign Sgn is fixed to −1.

In the second case, the control unit 12 operates in the first end mode after operating in the first deformation mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is −1.

In the second case, “Mode C” in FIG. 11 indicates a modulated waveform output during a period in which the control unit 12 operates in the first start mode, “Mode G” in FIG. 11 indicates a modulated waveform output during a period in which the control unit 12 operates in the first movement mode, “Mode F” in FIG. 11 indicates a modulated waveform output during a period in which the control unit 12 operates in the first deformation mode, and “Mode A” in FIG. 11 indicates a modulated waveform output during a period in which the control unit 12 operates in the first end mode.

That is, in the second case, as indicated by “Mode C” in FIG. 11, during a period in which the control unit 12 operates in the first start mode, since a modulated waveform obtained by adding the first offset waveform W1(θ) calculated on a condition that the first change rate K1 is 1 and the sign Sgn is −1 and a three-phase AC waveform is output, and a modulated waveform obtained by adding the second offset waveform W2 which is 0 to the modulated waveform is finally output, the power conversion circuit 11 is controlled by the spatial vector modulation

In the second case, as indicated by “Mode G” in FIG. 11, in a period in which the control unit 12 operates in the first movement mode, since a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually increases from 0 to Sgn×(1−m)/2, a modulated waveform gradually moves to the low voltage side. Then, at a time point at which an absolute value of the second offset waveform W2 reaches Sgn×(1−m)/2, a lower end of a modulated waveform sticks to 0.

In the second case, as indicated by “Mode F” in FIG. 11, in a period during which the control unit 12 operates in the first deformation mode, when the first change rate K1 gradually decreases from the first upper limit value to the first lower limit value in a state in which the sign Sgn is fixed to −1, a modulated waveform output from the control unit 12 also gradually changes with decrease in the first change rate K1. As a result, in a period in which the control unit 12 operates in the first deformation mode, a modulation method gradually shifts from a modulation method close to a characteristic of the spatial vector modulation to a modulation method close to a characteristic of the low-side-on-fixed-type two-phase modulation. Furthermore, the second offset waveform W2 calculated by Formula (2) is added to a modulated waveform output during a period in which the control unit 12 operates in the first deformation mode. By the above, a lower end of a modulated waveform output in an initial stage of a period in which the control unit 12 operates in the first deformation mode sticks to 0, but as the first change rate K1 decreases, a value of the second offset waveform W2 also gradually decreases.

In the second case, as indicated by “Mode A” in FIG. 11, during a period in which the control unit 12 operates in the first end mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

The first processing executed by the control unit 12 in the second case are the same as the first processing in the first case. The fourth processing executed by the control unit 12 in the second case is basically the same as the fourth processing in the first case, but in the steps included in the fourth processing in the second case, content of Steps S32 and S36 is different from that of the fourth processing in the first case. In the second case, content of Step S32 of the fourth processing changes to “the control unit 12 executes the sixth processing”. In the second case, content of Step S36 of the fourth processing changes to “the control unit 12 executes the fifth processing”.

The sixth processing executed by the control unit 12 in the second case is basically the same as the sixth processing in the first case, but in the steps included in the sixth processing in the second case, content of Steps S53, S54, and S55 is different from that of the sixth processing in the first case. In the second case, content of Step S53 of the sixth processing changes to “the control unit 12 adds a predetermined amount to an absolute value of the second offset waveform W2”. In the second case, when the first sixth processing is executed, an absolute value of the second offset waveform W2 is 0 regardless of a value of the first change rate K1, and when Step S53 of the first sixth processing is executed, a value obtained by adding a predetermined amount to 0 is obtained as a value of the second offset waveform W2. In the second case, content of Step S54 of the sixth processing changes to “the control unit 12 determines whether or not an absolute value of the second offset waveform W2 is Sgn×(1−m)/2”. In the second case, content of Step S55 of the sixth processing changes to “the control unit 12 clears the first modulation method switching flag and sets the second modulation method switching flag”.

The fifth processing executed by the control unit 12 in the second case is basically the same as the fifth processing in the first case, but in the steps included in the fifth processing in the second case, content of Steps S42, S45, S46, and S47 is different from that of the fifth processing in the first case. In the second case, content of Step S42 of the fifth processing changes to “the control unit 12 subtracts a predetermined amount from the first change rate K1”. In the second case, content of Step S45 of the fifth processing changes to “the control unit 12 determines whether or not the first change rate K1 is 0”. In the second case, content of Step S46 of the fifth processing changes to “the control unit 12 clears the second modulation method switching flag”. In the second case, Step S47 of the fifth processing is omitted.

As described above, in the second case of the third embodiment, the control unit 12 operates in the first start mode corresponding to the spatial vector modulation, the first movement mode, the first deformation mode, and the first end mode corresponding to the low-side-on-fixed-type two-phase modulation in this order. During a period in which the control unit 12 operates in the first movement mode, a modulated waveform gradually moves to the low voltage side while the power conversion circuit 11 is controlled by a modulation method close to a characteristic of the spatial vector modulation, and a lower end of the modulated waveform finally sticks to 0. Then, during a period in which the control unit 12 operates in the first deformation mode, in a state in which a lower end of a modulated waveform sticks to 0, a modulation method gradually shifts from a modulation method close to a characteristic of the spatial vector modulation to a modulation method close to a characteristic of the low-side-on-fixed-type two-phase modulation.

As described above, in the second case of the third embodiment, similarly to the first case of the third embodiment, a switching loss can be reduced as switching of a low-side switch is stopped during a period in which the control unit 12 operates in the first deformation mode. Further, according to the second case of the third embodiment, similarly to the second case of the second embodiment, it is possible to reduce a change in a rotational speed of the motor 20, a sudden change in noise, and a sudden change in a switching loss due to switching of a modulation method from the spatial vector modulation (modulation method of the first start mode) to the low-side-on-fixed-type two-phase modulation (modulation method of the first end mode).

Next, operation of the control unit 12 in a third case in which the first change rate K1 of the first start mode is 0, the first change rate K1 of the first movement mode and the first end mode is 1, and the sign Sgn is 1 throughout all the modes will be described.

In the third case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 0 and the sign Sgn is 1, and the second offset waveform W2 is 0, for example.

In the third case, the control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first deformation mode, the first change rate K1 gradually changes (increases) from the first lower limit value to the first upper limit value in a state where the sign Sgn is fixed to 1.

In the third case, the control unit 12 operates in the first movement mode after operating in the first deformation mode. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is 1. Further, during a period in which the control unit 12 operates in the first movement mode, an absolute value of the second offset waveform W2 gradually changes (decreases) from Sgn×(1−m)/2 to 0.

In the third case, the control unit 12 operates in the first end mode after operating in the first movement mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 1 and the sign Sgn is 1.

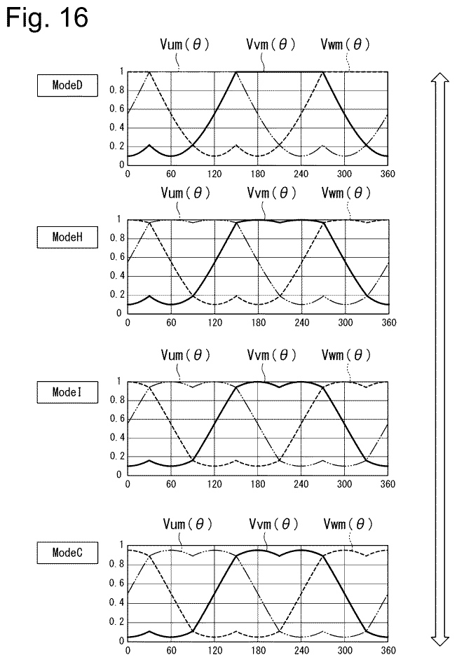

FIG. 16 is a diagram illustrating an example of a modulated waveform output during a period in which the control unit 12 operates in each of the first start mode, the first deformation mode, the first movement mode, and the first end mode in the third case. In FIG. 16, “Mode D” indicates a modulated waveform output during a period in which the control unit 12 operates in the first start mode, “Mode H” indicates a modulated waveform output during a period in which the control unit 12 operates in the first deformation mode, “Mode I” indicates a modulated waveform output during a period in which the control unit 12 operates in the first movement mode, and “Mode C” indicates a modulated waveform output during a period in which the control unit 12 operates in the first end mode. The horizontal axis of each graph illustrated in FIG. 16 represents the electrical angle θ of the motor 20, and the vertical axis of each graph represents an instantaneous value of each waveform.

As indicated by “Mode D” in FIG. 16, during a period in which the control unit 12 operates in the first start mode, since a modulated waveform obtained by adding the first offset waveform W1(θ) calculated on a condition that the first change rate K1 is 0 and the sign Sgn is 1 and a three-phase AC waveform is output, and a modulated waveform obtained by adding the modulated waveform and the second offset waveform W2 that is 0 is output as a final modulated waveform, the power conversion circuit 11 is controlled by the high-side-on-fixed-type two-phase modulation.

In a period during which the control unit 12 operates in the first deformation mode, when the first change rate K1 gradually increases from the first lower limit value to the first upper limit value in a state in which the sign Sgn is fixed to 1, a modulated waveform output from the control unit 12 also gradually changes with increase in the first change rate K1. As an example, “Mode H” in FIG. 16 indicates a modulated waveform output when the first change rate K1 is 0.5. As described above, when the first change rate K1 gradually increases from the first lower limit value to the first upper limit value in a state where the sign Sgn is fixed to −1 in a period in which the control unit 12 operates in the first deformation mode, a modulation method gradually shifts from a modulation method close to a characteristic of the high-side-on-fixed-type two-phase modulation to a modulation method close to a characteristic of the spatial vector modulation. Furthermore, the second offset waveform W2 calculated by Formula (2) is added to a modulated waveform output during a period in which the control unit 12 operates in the first deformation mode. By the above, as indicated by “Mode H” in FIG. 16, an upper end of a modulated waveform output during a period in which control unit 12 operates in the first deformation mode sticks to 1 (maximum voltage value).

In a period in which the control unit 12 operates in the first movement mode, since a modulated waveform obtained by adding the first offset waveform W1(θ) calculated on a condition that the first change rate K1 is 1 and the sign Sgn is 1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually decreases from Sgn×(1−m)/2 to 0, a modulated waveform stuck to 1 gradually moves to the low voltage side. As an example, “Mode I” in FIG. 16 indicates a modulated waveform output when an absolute value of the second offset waveform W2 is Sgn×(1−m)/2.

As indicated by “Mode C” in FIG. 16, during a period in which the control unit 12 operates in the first end mode, since a modulated waveform obtained by adding the first offset waveform W1(θ) calculated on a condition that the first change rate K1 is 1 and the sign Sgn is 1 and a three-phase AC waveform is output, the power conversion circuit 11 is controlled by the spatial vector modulation.

The first processing, the fourth processing, the fifth processing, and the sixth processing executed by the control unit 12 in the third case are basically the same as those in the first case, but are different from those in the first case in that each piece of processing is executed in a state where the sign Sgn is fixed to 1.

As described above, in the third case of the third embodiment, the control unit 12 operates in the first start mode corresponding to the high-side-on-fixed-type two-phase modulation, the first deformation mode, the first movement mode, and the first end mode corresponding to the spatial vector modulation in this order. Then, during a period in which the control unit 12 operates in the first deformation mode, in a state in which an upper end of a modulated waveform sticks to 1, a modulation method gradually shifts from a modulation method close to a characteristic of the high-side-on-fixed-type two-phase modulation to a modulation method close to a characteristic of the spatial vector modulation. Further, during a period in which the control unit 12 operates in the first movement mode, a modulated waveform gradually moves to the low voltage side while the power conversion circuit 11 is controlled by a modulation method close to a characteristic of the spatial vector modulation.

As described above, in the third case of the third embodiment, in a case where an upper end of a modulated waveform is stuck to 1 during a period in which the control unit 12 operates in the first deformation mode, switching of a high-side switch is stopped, so that a switching loss can be reduced. Further, according to the third case of the third embodiment, similarly to the third case of the second embodiment, it is possible to reduce a change in a rotational speed of the motor 20, a sudden change in noise, and a sudden change in a switching loss due to switching of a modulation method from the high-side-on-fixed-type two-phase modulation (modulation method of the first start mode) to the spatial vector modulation (modulation method of the first end mode).

Next, operation of the control unit 12 in a fourth case in which the first change rate K1 of the first start mode and the first movement mode is 1, the first change rate K1 of the first end mode is 0, and the sign Sgn is 1 throughout all the modes will be described.

In the fourth case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 1 and the sign Sgn is 1, and the second offset waveform W2 is 0, for example.

In the fourth case, the control unit 12 operates in the first movement mode after operating in the first start mode. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is 1. Further, during a period in which the control unit 12 operates in the first movement mode, an absolute value of the second offset waveform W2 gradually changes (increases) from 0 to Sgn×(1−m)/2.

In the fourth case, the control unit 12 operates in the first deformation mode after operating in the first movement mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first deformation mode, the first change rate K1 gradually changes (decreases) from the first upper limit value to the first lower limit value in a state where the sign Sgn is fixed to 1.

In the fourth case, the control unit 12 operates in the first end mode after operating in the first deformation mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is 1.

In the fourth case, “Mode C” in FIG. 16 indicates a modulated waveform output during a period in which the control unit 12 operates in the first start mode, “Mode I” in FIG. 16 indicates a modulated waveform output during a period in which the control unit 12 operates in the first movement mode, “Mode H” in FIG. 16 indicates a modulated waveform output during a period in which the control unit 12 operates in the first deformation mode, and “Mode D” in FIG. 16 indicates a modulated waveform output during a period in which the control unit 12 operates in the first end mode.

That is, in the fourth case, as indicated by “Mode C” in FIG. 16, during a period in which the control unit 12 operates in the first start mode, since a modulated waveform obtained by adding the first offset waveform W1(θ) calculated on a condition that the first change rate K1 is 1 and the sign Sgn is 1 and a three-phase AC waveform is output, and a modulated waveform obtained by adding the modulated waveform and the second offset waveform W2 that is 0 is output as a final modulated waveform, the power conversion circuit 11 is controlled by the spatial vector modulation.

In the fourth case, as indicated by “Mode I” in FIG. 16, in a period in which the control unit 12 operates in the first movement mode, since a modulated waveform obtained by adding the first offset waveform W1(θ) calculated on a condition that the first change rate K1 is 1 and the sign Sgn is 1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually increases from 0 to Sgn×(1−m)/2, a modulated waveform gradually moves to the high voltage side. Then, at a time point at which an absolute value of the second offset waveform W2 reaches Sgn×(1−m)/2, an upper end of a modulated waveform sticks to 1.

In the fourth case, as indicated by “Mode H” in FIG. 16, in a period during which the control unit 12 operates in the first deformation mode, when the first change rate K1 gradually decreases from the first upper limit value to the first lower limit value in a state in which the sign Sgn is fixed to 1, a modulated waveform output from the control unit 12 also gradually changes with decrease in the first change rate K1. As a result, in a period in which the control unit 12 operates in the first deformation mode, a modulation method gradually shifts from a modulation method close to a characteristic of the spatial vector modulation to a modulation method close to a characteristic of the high-side-on-fixed-type two-phase modulation. Furthermore, the second offset waveform W2 calculated by Formula (2) is added to a modulated waveform output during a period in which the control unit 12 operates in the first deformation mode. By the above, as indicated by “Mode H” in FIG. 16, an upper end of a modulated waveform output during a period in which control unit 12 operates in the first deformation mode sticks to 1, but a value of the second offset waveform W2 also gradually decreases as the first change rate K1 decreases.

In the fourth case, as indicated by “Mode D” in FIG. 16, during a period in which the control unit 12 operates in the first end mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

The first processing, the fourth processing, the fifth processing, and the sixth processing executed by the control unit 12 in the fourth case are basically the same as those in the second case, but are different from those in the second case in that each piece of processing is executed in a state where the sign Sgn is fixed to 1.

As described above, in the fourth case of the third embodiment, the control unit 12 operates in the first start mode corresponding to the spatial vector modulation, the first movement mode, the first deformation mode, and the first end mode corresponding to the high-side-on-fixed-type two-phase modulation in this order. During a period in which the control unit 12 operates in the first movement mode, a modulated waveform gradually moves to the high voltage side while the power conversion circuit 11 is controlled by a modulation method close to a characteristic of the spatial vector modulation, and an upper end of the modulated waveform finally sticks to 1. Then, during a period in which the control unit 12 operates in the first deformation mode, in a state in which an upper end of a modulated waveform sticks to 1, a modulation method gradually shifts from a modulation method close to a characteristic of the spatial vector modulation to a modulation method close to a characteristic of the high-side-on-fixed-type two-phase modulation.

As described above, in the fourth case of the third embodiment, similarly to the third case of the third embodiment, a switching loss can be reduced as switching of a high-side switch is stopped during a period in which the control unit 12 operates in the first deformation mode. Further, according to the fourth case of the third embodiment, similarly to the fourth case of the second embodiment, it is possible to reduce a change in a rotational speed of the motor 20, a sudden change in noise, and a sudden change in a switching loss due to switching of a modulation method from the spatial vector modulation (modulation method of the first start mode) to the high-side-on-fixed-type two-phase modulation (modulation method of the first end mode).

Note that, in the third embodiment, an aspect in which the control unit 12 has the first start mode, the first deformation mode, the first movement mode, and the first end mode is exemplified, but the present invention is not limited to this, and at least one of the first start mode, the first movement mode, and the first end mode may be omitted.

Further, in the third embodiment, the case where the first change rate K1 of the first start mode is 0 and the first change rate K1 of the first end mode is 1 and the case where the first change rate K1 of the first start mode is 1 and the first change rate K1 of the first end mode is 0 are described, but the present invention is not limited to this. That is, as described in the second embodiment, for example, the first change rate K1 of one of the first start mode and the first end mode may be 0, and the first change rate K1 of the other may be a value larger than 0 and equal to or less than 1. Further, for example, the first change rate K1 of one of the first start mode and the first end mode may be 1, and the first change rate K1 of the other may be 0 or more and smaller than 1.

Further, the first change rate K1 may be changed from a value larger than 0 to a value smaller than 1 in a period in which the control unit 12 operates in the first deformation mode, and a value of the second offset waveform W2 may be changed to 0 while the first change rate K1 is changed to 1 in a period in which the control unit 12 operates in the first movement mode.

Further, the first change rate K1 may be changed from a value larger than 0 to a value smaller than 1 in a period in which the control unit 12 operates in the first deformation mode, and the first change rate K1 may be changed to 1 after a value of the second offset waveform W2 is changed to 0 in a period in which the control unit 12 operates in the first movement mode.

Next, a fourth embodiment of the present invention will be described. A part of the first deformation mode of the control unit 12 of the fourth embodiment is different from the first deformation mode of the first embodiment. Further, the control unit 12 in the fourth embodiment is different from that in the first embodiment in that the control unit 12 has not only the first deformation mode but also a first start mode and a first end mode. Therefore, operation of the control unit 12 in the fourth embodiment will be described in detail below.

In the fourth embodiment, the control unit 12 operates in the first start mode in which the first change rate K1 is 0 before operating in the first deformation mode. Further, in the fourth embodiment, the control unit 12 operates in the first end mode in which the first change rate K1 is 0 after operating in the first deformation mode.

In the first deformation mode, the control unit 12 in the fourth embodiment is the same as that in the first embodiment in that the control unit 12 outputs a modulated waveform obtained by adding the first offset waveform W1(θ) expressed by Formula (1) and a three-phase AC waveform. In the fourth embodiment, a period during which the control unit 12 operates in the first deformation mode includes a first period in which the first change rate K1 changes from a value larger than 0 to a value smaller than 1 in a state in which the sign Sgn is fixed to one of 1 and −1, and a second period in which the first change rate K1 changes from a value smaller than 1 to a value larger than 0 in a state in which the sign Sgn is fixed to the other of 1 and −1.

First, operation of the control unit 12 in a first case of the fourth embodiment will be described.

In the first case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 0 and the sign Sgn is −1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In the first period as a first half of a period during which the control unit 12 operates in the first deformation mode, the first change rate K1 gradually changes (increases) from the first lower limit value to the first upper limit value in a state where the sign Sgn is fixed to −1. Further, in the second period as a second half of a period during which the control unit 12 operates in the first deformation mode, the first change rate K1 gradually changes (decreases) from the first upper limit value to the first lower limit value in a state where the sign Sgn is fixed to 1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is 1.

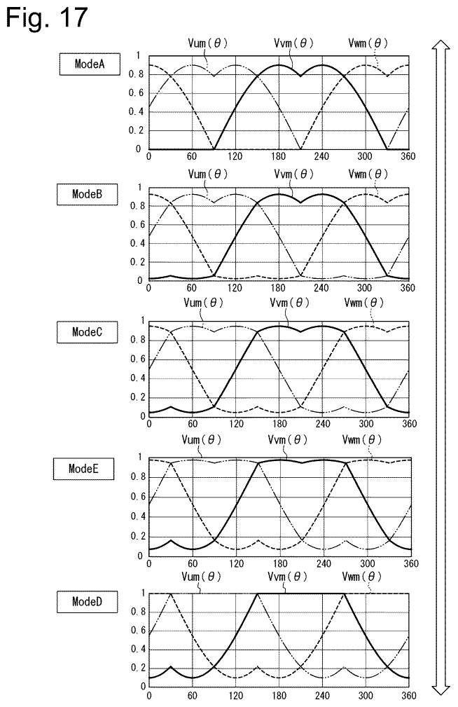

FIG. 17 is a diagram illustrating an example of a modulated waveform output during a period in which the control unit 12 operates in each of the first start mode, the first deformation mode, and the first end mode in the first case. In FIG. 17, “Mode A” indicates a modulated waveform output during a period in which the control unit 12 operates in the first start mode, “Mode B” indicates a modulated waveform output during the first period as a first half of a period in which the control unit 12 operates in the first deformation mode, “Mode C” indicates a modulated waveform when the first change rate K1 becomes 1 during a period in which the control unit 12 operates in the first deformation mode, “Mode E” indicates a modulated waveform output during a second period as a second half of a period in which the control unit 12 operates in the first deformation mode, and “Mode D” indicates a modulated waveform output during a period in which the control unit 12 operates in the first end mode. The horizontal axis of each graph illustrated in FIG. 17 represents the electrical angle θ of the motor 20, and the vertical axis of each graph represents an instantaneous value of each waveform.

As indicated by “Mode A” in FIG. 17, during a period in which the control unit 12 operates in the first start mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

In the first period as a first half of a period during which the control unit 12 operates in the first deformation mode, when the first change rate K1 gradually increases from the first lower limit value to the first upper limit value in a state in which the sign Sgn is fixed to −1, a modulated waveform output from the control unit 12 also gradually changes with increase in the first change rate K1. As an example, “Mode B” in FIG. 17 indicates a modulated waveform output when the first change rate K1 is 0.5. As described above, when the first change rate K1 gradually increases from the first lower limit value to the first upper limit value in a state where the sign Sgn is fixed to −1 in the first period as a first half of a period in which the control unit 12 operates in the first deformation mode, a modulation method gradually shifts from a modulation method close to a characteristic of the low-side-on-fixed-type two-phase modulation to a modulation method close to a characteristic of the spatial vector modulation.

As indicated by “Mode C” in FIG. 17, during a period in which the control unit 12 operates in the first deformation mode, since a modulated waveform obtained by adding the first offset waveform W1(θ) calculated on a condition that the first change rate K1 is 1 and the sign Sgn is −1 and a three-phase AC waveform is output when the first change rate K1 becomes 1, the power conversion circuit 11 is controlled by the spatial vector modulation

In the second period as a second half of a period during which the control unit 12 operates in the first deformation mode, when the first change rate K1 gradually decreases from the first upper limit value to the first lower limit value in a state in which the sign Sgn is fixed to 1, a modulated waveform output from the control unit 12 also gradually changes with decrease in the first change rate K1. As an example, “Mode E” in FIG. 17 indicates a modulated waveform output when the first change rate K1 is 0.5. As described above, when the first change rate K1 gradually increases from the first upper limit value to the first lower limit value in a state where the sign Sgn is fixed to 1 in the second period as a second half of a period in which the control unit 12 operates in the first deformation mode, a modulation method gradually shifts from a modulation method close to a characteristic of the spatial vector modulation to a modulation method close to a characteristic of the high-side-on-fixed-type two-phase modulation.

As indicated by “Mode D” in FIG. 17, during a period in which the control unit 12 operates in the first end mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

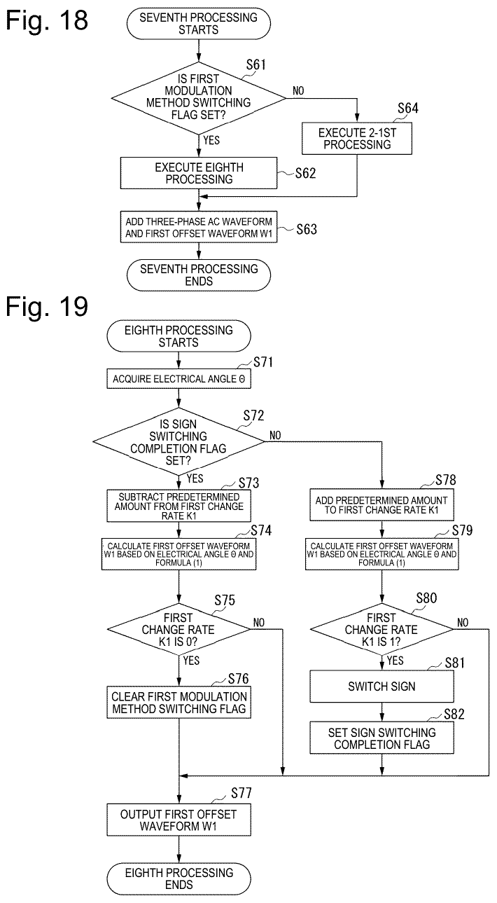

In the first case, the control unit 12 executes seventh processing and eighth processing in addition to the first processing that is the same as that in the first embodiment. FIG. 18 is a flowchart illustrating the seventh processing executed by the control unit 12. FIG. 19 is a flowchart illustrating the eighth processing executed by the control unit 12. The control unit 12 executes the first processing and the seventh processing at a predetermined cycle. As described later, the control unit 12 executes the eighth processing in a case of determining that the first modulation method switching flag is set at the time of executing the seventh processing.

First, the control unit 12 operates in the first start mode. That is, during a period in which the control unit 12 operates in the first start mode, as a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

As illustrated in FIG. 6, when starting the first processing, the control unit 12 sets the first modulation method switching flag with receiving of a switching command for a modulation method from a host control device during operation in the first start mode as a trigger (Step S1). After executing Step S1, the control unit 12 ends the first processing.

As illustrated in FIG. 18, when starting the seventh processing, the control unit 12 first determines whether or not the first modulation method switching flag is set (Step S61). In a case of determining that the first modulation method switching flag is not set (Step S61: No), that is, in a case where a switching command for a modulation method is not received from a host control device during operation in the first start mode, the control unit 12 executes 2-1st processing illustrated in FIG. 9 (Step S64).

Note that in execution of the first processing and the seventh processing at a predetermined cycle, for example, the first processing and the seventh processing can be executed by being performed at every predetermined time in interrupt processing performed in synchronization with a carrier. For example, in interrupt processing synchronized with a carrier, the first processing and the seventh processing are performed in interrupt processing performed once every ten times. At this time, in another piece of interrupt processing, the 2-1st processing and Step S63 of the seventh processing illustrated in FIG. 18 are performed. As described in the second embodiment, the control unit 12 continues to operate in the first start mode corresponding to the low-side-on-fixed-type two-phase modulation by executing the 2-1st processing until determining that the first modulation method switching flag is set.

On the other hand, as illustrated in FIG. 18, in a case of determining that the first modulation method switching flag is set (Step S61: Yes), that is, in a case where a switching command for a modulation method is received from a host control device during operation in the first start mode, the control unit 12 executes the eighth processing illustrated in FIG. 19 (Step S62). When the control unit 12 starts the eighth processing, a mode of the control unit 12 is switched from the first start mode to the first deformation mode.

As illustrated in FIG. 19, when starting the eighth processing, the control unit 12 acquires the electrical angle θ of the motor 20 (Step S71). Then, the control unit 12 determines whether or not a sign switching completion flag is set (Step S72). In a case of determining that the sign switching completion flag is not set (Step S72: No), the control unit 12 adds a predetermined amount to the first change rate K1 (Step S78).

Then, the control unit 12 calculates the first offset waveform W1(θ) based on the acquired electrical angle θ and Formula (1) (Step S79). In Step S79, the control unit 12 calculates the first offset waveform W1(θ) with the sign Sgn as −1.

Subsequently, the control unit 12 determines whether or not the first change rate K1 is 1 (Step S80). In a case of determining that the first change rate K1 is 1 (Step S80: Yes), the control unit 12 switches the sign Sgn (Step S81). That is, in the first case, the control unit 12 switches the sign Sgn from −1 to 1. After switching the sign Sgn as described above, the control unit 12 sets the sign switching completion flag (Step S82). After setting the sign switching completion flag, the control unit 12 proceeds to Step S77 described later.

When processing to Step S77, the control unit 12 outputs the first offset waveform W1(θ) calculated in Step S79 (Step S77). On the other hand, in a case of determining that the first change rate K1 is not 1 (Step S80: No), the control unit 12 skips Steps S81 and S82 and proceeds to Step S77. After executing Step S77, the control unit 12 ends the eighth processing and proceeds to Step S63 of the seventh processing illustrated in FIG. 18.

As illustrated in FIG. 18, when proceeding to Step S63 of the seventh processing after the eighth processing ends, the control unit 12 adds the first offset waveform W1(θ) output in Step S77 of the eighth processing and a three-phase AC waveform at the same electrical angle θ as the first offset waveform W1(θ) to calculate a modulated waveform at the same electrical angle θ (Step S63). After executing Step S63, the control unit 12 ends the seventh processing.

A period from start of the first deformation mode to determination that the first change rate K1 is 1 in Step S80 of the eighth processing is the first period. That is, when the first change rate K1 increases by a predetermined amount at a time from the first lower limit value to the first upper limit value in a state where the sign Sgn is fixed to −1 in the first period as a first half of a period in which the control unit 12 operates in the first deformation mode, a modulation method gradually shifts from a modulation method close to a characteristic of the low-side-on-fixed-type two-phase modulation to a modulation method close to a characteristic of the spatial vector modulation.

Then, when the first change rate K1 becomes 1, as indicated by “Mode C” in FIG. 17, since a modulated waveform obtained by adding the first offset waveform W1(θ) calculated on a condition that the first change rate K1 is 1 and the sign Sgn is −1 and a three-phase AC waveform is output, the power conversion circuit 11 is controlled by the spatial vector modulation

Further, after the first change rate K1 becomes 1, when the sign Sgn is switched to 1 and the sign switching completion flag is set, the control unit 12 determines that the sign switching completion flag is set in Step S72 when the next eighth processing is executed. As described above, in a case of determining that the sign switching completion flag is set (Step S72: Yes), the control unit 12 subtracts a predetermined amount from the first change rate K1 (Step S73).

Then, the control unit 12 calculates the first offset waveform W1(θ) based on the electrical angle θ acquired in Step S71 and Formula (1) (Step S74). In Step S74, the control unit 12 calculates the first offset waveform W1(θ) with the sign Sgn as 1.

Subsequently, the control unit 12 determines whether or not the first change rate K1 is 0 (Step S75). In a case of determining that the first change rate K1 is 0 (Step S75: Yes), the control unit 12 clears the first modulation method switching flag (Step S76). After clearing the first modulation method switching flag, the control unit 12 outputs the first offset waveform W1(θ) calculated in Step S74 (Step S77). On the other hand, in a case of determining that the first change rate K1 is not 0 (Step S75: No), the control unit 12 skips Step S76 and proceeds to Step S77. After executing Step S77, the control unit 12 ends the eighth processing and proceeds to Step S63 of the seventh processing illustrated in FIG. 18.

As illustrated in FIG. 18, when proceeding to Step S63 of the seventh processing after the eighth processing ends, the control unit 12 adds the first offset waveform W1(θ) output in Step S77 of the eighth processing and a three-phase AC waveform at the same electrical angle θ as the first offset waveform W1(θ) to calculate a modulated waveform at the same electrical angle θ (Step S63). After executing Step S63, the control unit 12 ends the seventh processing.

A period from when the sign switching completion flag is set until the first change rate K1 is determined to be 0 in Step S75 of the eighth processing is the second period. That is, when the first change rate K1 decreases by a predetermined amount at a time from the first upper limit value to the first lower limit value in a state where the sign Sgn is fixed to 1 in the second period as a second half of a period in which the control unit 12 operates in the first deformation mode, a modulation method gradually shifts from a modulation method close to a characteristic of the spatial vector modulation to a modulation method close to a characteristic of the high-side-on-fixed-type two-phase modulation.

Then, when the first modulation method switching flag is cleared, the mode of the control unit 12 is switched from the first deformation mode to the first end mode. That is, during a period in which the control unit 12 operates in the first end mode, as a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

As described above, in the first case of the fourth embodiment, the first change rate K1 gradually increases from the first lower limit value to the first upper limit value in a state where the sign Sgn is fixed to −1 in the first period as a first half of a period in which the control unit 12 operates in the first deformation mode. By the above, in the first period, a modulation method gradually shifts from a modulation method close to a characteristic of the low-side-on-fixed-type two-phase modulation to a modulation method close to a characteristic of the spatial vector modulation. Further, in the second period as a second half of a period during which the control unit 12 operates in the first deformation mode, the first change rate K1 gradually decreases from the first upper limit value to the first lower limit value in a state where the sign Sgn is fixed to 1. By the above, in the second period, a modulation method gradually shifts from a modulation method close to a characteristic of the spatial vector modulation to a modulation method close to a characteristic of the high-side-on-fixed-type two-phase modulation.

According to the first case of the fourth embodiment, it is possible to seamlessly switch a modulation method from the low-side-on-fixed-type two-phase modulation (the modulation method of the first start mode) to the high-side-on-fixed-type two-phase modulation (the modulation method of the first end mode) with the spatial vector modulation performed between them. Further, since it is possible to reduce a change in a rotational speed of the motor 20, a sudden change in noise, and a sudden change in a switching loss due to switching of a modulation method, it is possible to reduce a torque fluctuation of the motor 20 and to prevent the user from feeling uncomfortable. Furthermore, since an amount of heat generation on the high-side switch side and an amount of heat generation on the low-side switch side are averaged over an entire period in which the control unit 12 operates in the first start mode, the first deformation mode, and the first end mode, overheating of the power conversion circuit 11 can be prevented.

Note that, in the first case of the fourth embodiment, an aspect in which the control unit 12 determines whether or not the first change rate K1 is 1 in Step S80 of the eighth processing is exemplified, but the present invention is not limited to this. For example, in the first case of the fourth embodiment, the control unit 12 may determine whether or not the first change rate K1 is the first upper limit value (for example, 0.99) or more in Step S80. In this case, it is possible to shift a modulation method from the low-side-on-fixed-type two-phase modulation to the high-side-on-fixed-type two-phase modulation without performing the spatial vector modulation.

Next, operation of the control unit 12 in a second case of the fourth embodiment will be described.

In the second case, the control unit 12 first operates in the first start mode. In the first start mode, the control unit 12 outputs a modulated waveform obtained by adding the first offset waveform W1(θ) expressed by Formula (1) and a three-phase AC waveform. In a period during which the control unit 12 operates in the first start mode, the first offset waveform W1(θ) is calculated on a condition that the first change rate K1 is 0 and the sign Sgn is 1.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform. In the first period as a first half of a period during which the control unit 12 operates in the first deformation mode, the first change rate K1 gradually changes (increases) from the first lower limit value to the first upper limit value in a state where the sign Sgn is fixed to 1. Further, in the second period as a second half of a period during which the control unit 12 operates in the first deformation mode, the first change rate K1 gradually changes (decreases) from the first upper limit value to the first lower limit value in a state where the sign Sgn is fixed to −1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is −1.

In the second case, “Mode D” in FIG. 17 indicates a modulated waveform output during a period in which the control unit 12 operates in the first start mode, “Mode E” in FIG. 17 indicates a modulated waveform output during a first period as a first half of a period in which the control unit 12 operates in the first deformation mode, “Mode C” in FIG. 17 indicates a modulated waveform when the first change rate K1 becomes 1 during a period in which the control unit 12 operates in the first deformation mode, “Mode B” in FIG. 17 indicates a modulated waveform output during a second period as a second half of a period in which the control unit 12 operates in the first deformation mode, and “Mode A” in FIG. 17 indicates a modulated waveform output during a period in which the control unit 12 operates in the first end mode.

In the second case, as indicated by “Mode D” in FIG. 17, during a period in which the control unit 12 operates in the first start mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

As indicated by “Mode E” in FIG. 17, in the first period as a first half of a period during which the control unit 12 operates in the first deformation mode, when the first change rate K1 gradually increases from the first lower limit value to the first upper limit value in a state in which the sign Sgn is fixed to 1, a modulated waveform output from the control unit 12 also gradually changes with increase in the first change rate K1. As a result, in the first period as a first half of a period in which the control unit 12 operates in the first deformation mode, a modulation method gradually shifts from a modulation method close to a characteristic of the high-side-on-fixed-type two-phase modulation to a modulation method close to a characteristic of the spatial vector modulation.

As indicated by “Mode C” in FIG. 17, during a period in which the control unit 12 operates in the first deformation mode, since a modulated waveform obtained by adding the first offset waveform W1(θ) calculated on a condition that the first change rate K1 is 1 and the sign Sgn is 1 and a three-phase AC waveform is output when the first change rate K1 becomes 1, the power conversion circuit 11 is controlled by the spatial vector modulation

As indicated by “Mode B” in FIG. 17, in the second period as a second half of a period during which the control unit 12 operates in the first deformation mode, when the first change rate K1 gradually decreases from the first upper limit value to the first lower limit value in a state in which the sign Sgn is fixed to −1, a modulated waveform output from the control unit 12 also gradually changes with decrease in the first change rate K1. As a result, in the second period as a second half of a period in which the control unit 12 operates in the first deformation mode, a modulation method gradually shifts from a modulation method close to a characteristic of the spatial vector modulation to a modulation method close to a characteristic of the low-side-on-fixed-type two-phase modulation.

As indicated by “Mode A” in FIG. 17, during a period in which the control unit 12 operates in the first end mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

The first processing, the seventh processing, and the eighth processing executed by the control unit 12 in the second case are basically the same as those in the first case, but are different from those in the first case in that an initial value of the sign Sgn is set to 1. In the first case, an initial value of the sign Sgn is set to −1.

As described above, in the second case of the fourth embodiment, the first change rate K1 gradually increases from the first lower limit value to the first upper limit value in a state where the sign Sgn is fixed to 1 in the first period as a first half of a period in which the control unit 12 operates in the first deformation mode. By the above, in the first period, a modulation method gradually shifts from a modulation method close to a characteristic of the high-side-on-fixed-type two-phase modulation to a modulation method close to a characteristic of the spatial vector modulation. Further, in the second period as a second half of a period during which the control unit 12 operates in the first deformation mode, the first change rate K1 gradually decreases from the first upper limit value to the first lower limit value in a state where the sign Sgn is fixed to −1. By the above, in the second period, a modulation method gradually shifts from a modulation method close to a characteristic of the spatial vector modulation to a modulation method close to a characteristic of the low-side-on-fixed-type two-phase modulation.

According to the second case of the fourth embodiment, it is possible to seamlessly switch a modulation method from the high-side-on-fixed-type two-phase modulation (the modulation method of the first start mode) to the low-side-on-fixed-type two-phase modulation (the modulation method of the first end mode) with the spatial vector modulation performed between them. Further, similarly to the first case, since it is possible to reduce a change in a rotational speed of the motor 20, a sudden change in noise, and a sudden change in a switching loss due to switching of a modulation method, it is possible to reduce a torque fluctuation of the motor 20 and to prevent the user from feeling uncomfortable. Furthermore, similarly to the first case, overheating of the power conversion circuit 11 can be reduced in an entire period in which the control unit 12 operates in the first start mode, the first deformation mode, and the first end mode.

Note that, also in the second case of the fourth embodiment, an aspect in which the control unit 12 determines whether or not the first change rate K1 is 1 in Step S80 of the eighth processing is exemplified, but the present invention is not limited to this. For example, also in the second case of the fourth embodiment, the control unit 12 may determine whether or not the first change rate K1 is the first upper limit value (for example, 0.99) or more in Step S80. In this case, it is possible to shift a modulation method from the high-side-on-fixed-type two-phase modulation to the low-side-on-fixed-type two-phase modulation without performing the spatial vector modulation.

Next, a fifth embodiment of the present invention will be described. A part of the first deformation mode of the control unit 12 of the fifth embodiment is different from the first deformation mode of the fourth embodiment. Further, the control unit 12 of the fifth embodiment is different from that of the fourth embodiment in that the control unit 12 has the first movement mode and a second movement mode in addition to the first deformation mode, the first start mode, and the first end mode. Therefore, operation of the control unit 12 in the fifth embodiment will be described in detail below.

In the first deformation mode, the control unit 12 in the fifth embodiment is the same as that in the fourth embodiment in that the control unit 12 outputs a modulated waveform obtained by adding the first offset waveform W1(θ) expressed by Formula (1) and a three-phase AC waveform. Furthermore, in the first deformation mode, the control unit 12 according to the fifth embodiment outputs, as a final modulated waveform, a modulated waveform obtained by adding the second offset waveform W2 expressed by Formula (2) having the first change rate K1, the modulation rate m, and the sign Sgn as variables and the above-described modulated waveform.

In the fifth embodiment, after the first period in which the control unit 12 operates in the first deformation mode, the control unit 12 operates in the first movement mode in which an absolute value of the second offset waveform W2 changes from (1−m)/2 to 0 in a state where the sign Sgn is fixed to one of 1 and −1. Further, in a period between a period in which the control unit 12 operates in the first movement mode and the second period in which the control unit 12 operates in the first deformation mode, the control unit 12 operates in the second movement mode in which an absolute value of the second offset waveform W2 changes from 0 to (1−m)/2 in a state where the sign Sgn is fixed to the other of 1 and −1.

First, operation of the control unit 12 in a first case of the fifth embodiment will be described.

In the first case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 0 and the sign Sgn is −1, and the second offset waveform W2 is 0, for example.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In the first period as a first half of a period during which the control unit 12 operates in the first deformation mode, the first change rate K1 gradually changes (increases) from the first lower limit value to the first upper limit value in a state where the sign Sgn is fixed to −1. Further, in the second period as a second half of a period during which the control unit 12 operates in the first deformation mode, the first change rate K1 gradually changes (decreases) from the first upper limit value to the first lower limit value in a state where the sign Sgn is fixed to 1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is 1.

The control unit 12 operates in the first movement mode and the second movement mode in this order in a period between the first period and the second period. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is −1. Further, during a period in which the control unit 12 operates in the first movement mode, an absolute value of the second offset waveform W2 gradually changes (decreases) from (1−m)/2 to 0.

In the second movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the second movement mode, the first offset waveform W1(θ) is calculated on a condition that the first change rate K1 is 1 and the sign Sgn is 1. Further, during a period in which the control unit 12 operates in the second movement mode, an absolute value of the second offset waveform W2 gradually changes (increases) from 0 to (1−m)/2.

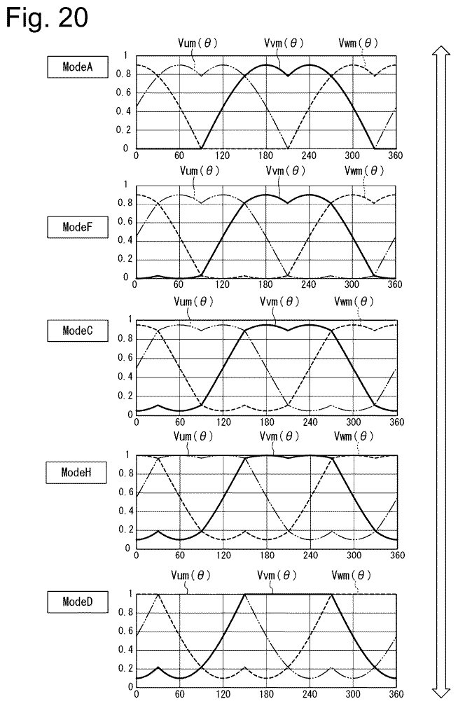

FIG. 20 is a diagram illustrating an example of a modulated waveform output during a period in which the control unit 12 operates in each of the first start mode, the first deformation mode, and the first end mode in the first case. In FIG. 20, “Mode A” indicates a modulated waveform output during a period in which the control unit 12 operates in the first start mode. “Mode F” indicates a modulated waveform output in the first period as a first half of a period in which the control unit 12 operates in the first deformation mode. “Mode C” indicates a modulated waveform when the first change rate K1 becomes 1 and an absolute value of the second offset waveform W2 becomes 0. “Mode H” indicates a modulated waveform output in the second period as a second half of a period in which the control unit 12 operates in the first deformation mode. “Mode D” indicates a modulated waveform output during a period in which the control unit 12 operates in the first end mode. The horizontal axis of each graph illustrated in FIG. 20 represents the electrical angle θ of the motor 20, and the vertical axis of each graph represents an instantaneous value of each waveform.

Although not illustrated in FIG. 20, a modulated waveform output during a period in which the control unit 12 operates in the first movement mode appears between “Mode F” and “Mode C”. In the fifth embodiment, a modulated waveform output during a period in which the control unit 12 operates in the first movement mode is the same as the modulated waveform indicated by “Mode G” in FIG. 11.

Further, although not illustrated in FIG. 20, a modulated waveform output during a period in which the control unit 12 operates in the second movement mode appears between “Mode C” and “Mode H”. In the fifth embodiment, a modulated waveform output during a period in which the control unit 12 operates in the second movement mode is the same as the modulated waveform indicated by “Mode I” in FIG. 16.

As indicated by “Mode A” in FIG. 20, during a period in which the control unit 12 operates in the first start mode, since a modulated waveform obtained by adding the first offset waveform W1(θ) calculated on a condition that the first change rate K1 is 0 and the sign Sgn is −1 and a three-phase AC waveform is output, and a modulated waveform obtained by adding the modulated waveform and the second offset waveform W2 that is 0 is output as a final modulated waveform, the power conversion circuit 11 is controlled by the low-side-on-fixed-type two-phase modulation.

In the first period as a first half of a period during which the control unit 12 operates in the first deformation mode, when the first change rate K1 gradually increases from the first lower limit value to the first upper limit value in a state in which the sign Sgn is fixed to −1, a modulated waveform output from the control unit 12 also gradually changes with increase in the first change rate K1. As an example, “Mode F” in FIG. 20 indicates a modulated waveform output when the first change rate K1 is 0.5. As described above, when the first change rate K1 gradually increases from the first lower limit value to the first upper limit value in a state where the sign Sgn is fixed to −1 in the first period, a modulation method gradually shifts from a modulation method close to a characteristic of the low-side-on-fixed-type two-phase modulation to a modulation method close to a characteristic of the spatial vector modulation. Furthermore, the second offset waveform W2 calculated by Formula (2) is added to a modulated waveform output during the first period. By the above, as indicated by “Mode F” in FIG. 20, a lower end of a modulated waveform output in the first period sticks to 0.

In a period in which the control unit 12 operates in the first movement mode, since a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually decreases from (1−m)/2 to 0, a modulated waveform stuck to 0 gradually moves to the high voltage side. For example, a modulated waveform output when an absolute value of the second offset waveform W2 is (1−m)/2 in a period in which the control unit 12 operates in the first movement mode is a modulated waveform as indicated by “Mode G” in FIG. 11.

As indicated by “Mode C” in FIG. 20, in a period in which the control unit 12 operates in the first movement mode, when an absolute value of the second offset waveform W2 becomes 0, a modulated waveform obtained on a condition that the first change rate K1 is 1 and an absolute value of the second offset waveform W2 is 0 is output. For this reason, the power conversion circuit 11 is controlled by the spatial vector modulation.

In a period in which the control unit 12 operates in the second movement mode, since a modulated waveform obtained by adding the first offset waveform W1(θ) calculated on a condition that the first change rate K1 is 1 and the sign Sgn is 1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the second movement mode, since an absolute value of the second offset waveform W2 added to a modulated waveform gradually increases from 0 to (1−m)/2, a modulated waveform gradually moves to the high voltage side. Then, at a time point at which an absolute value of the second offset waveform W2 reaches (1−m)/2, an upper end of a modulated waveform sticks to 1. For example, a modulated waveform output when an absolute value of the second offset waveform W2 is (1−m)/2 in a period in which the control unit 12 operates in the second movement mode is a modulated waveform as indicated by “Mode I” in FIG. 16.

As indicated by “Mode H” in FIG. 20, in the second period as a second half of a period during which the control unit 12 operates in the first deformation mode, when the first change rate K1 gradually decreases from the first upper limit value to the first lower limit value in a state in which the sign Sgn is fixed to 1, a modulated waveform output from the control unit 12 also gradually changes with decrease in the first change rate K1. As an example, “Mode H” in FIG. 20 indicates a modulated waveform output when the first change rate K1 is 0.5. As described above, when the first change rate K1 gradually decreases from the first upper limit value to the first lower limit value in a state where the sign Sgn is fixed to 1 in the second period, a modulation method gradually shifts from a modulation method close to a characteristic of the spatial vector modulation to a modulation method close to a characteristic of the high-side-on-fixed-type two-phase modulation. Furthermore, the second offset waveform W2 calculated by Formula (2) is added to a modulated waveform output during the second period. By the above, as indicated by “Mode H” in FIG. 20, an upper end of a modulated waveform output during the second period sticks to 1, but a value of the second offset waveform W2 also gradually decreases as the first change rate K1 decreases.

As indicated by “Mode D” in FIG. 20, during a period in which the control unit 12 operates in the first end mode, since a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

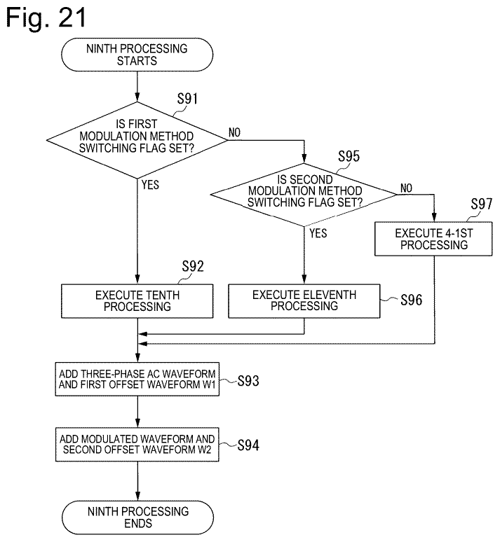

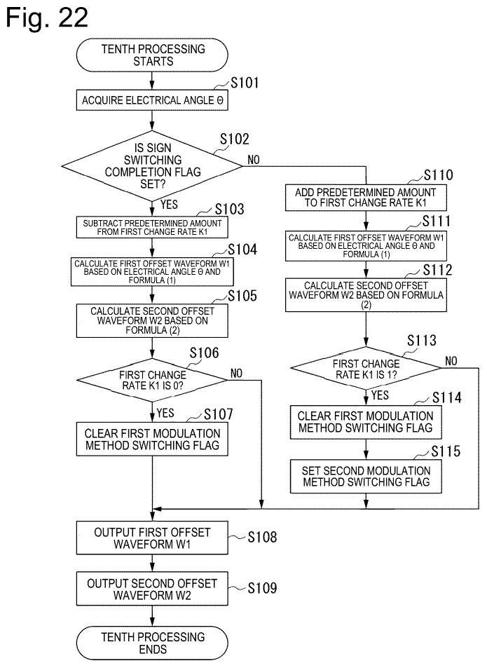

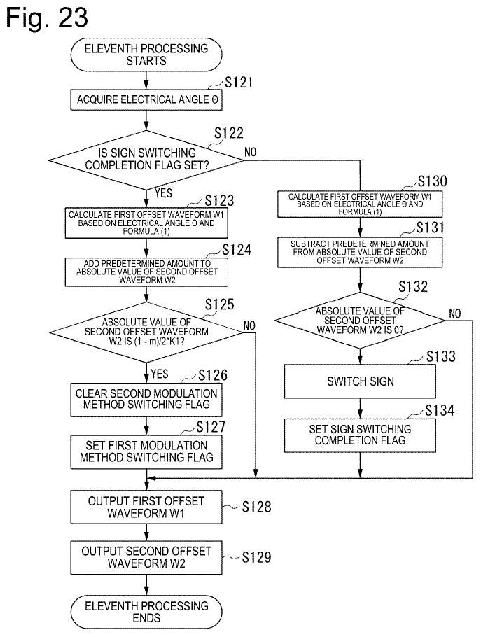

In the first case, the control unit 12 executes ninth processing, tenth processing, and eleventh processing in addition to the first processing that is the same as that in the first embodiment. FIG. 21 is a flowchart illustrating the ninth processing executed by the control unit 12. FIG. 22 is a flowchart illustrating the tenth processing executed by the control unit 12. FIG. 23 is a flowchart illustrating the eleventh processing executed by the control unit 12. The control unit 12 executes the first processing and the ninth processing at a predetermined cycle. As described later, the control unit 12 executes the tenth processing in a case of determining that the first modulation method switching flag is set at the time of executing the ninth processing. Further, in a case of determining that the second modulation method switching flag is set at the time of executing the ninth processing, the control unit 12 executes the eleventh processing.

First, the control unit 12 operates in the first start mode. That is, during a period in which the control unit 12 operates in the first start mode, as a modulated waveform obtained by adding the first offset waveform W1(θ) calculated on a condition that the first change rate K1 is 0 and the sign Sgn is −1 and a three-phase AC waveform is output, and a modulated waveform obtained by adding the modulated waveform and the second offset waveform W2 that is 0 is output as a final modulated waveform, the power conversion circuit 11 is controlled by the low-side-on-fixed-type two-phase modulation.

As illustrated in FIG. 6, when starting the first processing, the control unit 12 sets the first modulation method switching flag with receiving of a switching command for a modulation method from a host control device during operation in the first start mode as a trigger (Step S1). After executing Step S1, the control unit 12 ends the first processing.

As illustrated in FIG. 21, when starting the ninth processing, the control unit 12 first determines whether or not the first modulation method switching flag is set (Step S91). In a case of determining that the first modulation method switching flag is not set (Step S91: No), the control unit 12 determines whether or not the second modulation method switching flag is set (Step S95). In a case of determining that the second modulation method switching flag is not set (Step S95: No), the control unit 12 executes the 4-1st processing illustrated in FIG. 15 (Step S97).

Note that in execution of the first processing and the ninth processing at a predetermined cycle, for example, the first processing and the ninth processing can be executed by being performed at every predetermined time in interrupt processing performed in synchronization with a carrier. For example, in interrupt processing synchronized with a carrier, the first processing and the ninth processing are performed in interrupt processing performed once every ten times. At this time, in another piece of interrupt processing, the 4-1st processing, Step S93 of the ninth processing illustrated in FIG. 21, and Step S94 of the ninth processing illustrated in FIG. 21 are performed. As described in the third embodiment, the control unit 12 continues to operate in the first start mode corresponding to the low-side-on-fixed-type two-phase modulation by executing the 4-1st processing until determining that the second modulation method switching flag is set.

On the other hand, as illustrated in FIG. 21, in a case of determining that the first modulation method switching flag is set (Step S91: Yes), that is, in a case where a switching command for a modulation method is received from a host control device during operation in the first start mode, the control unit 12 executes the tenth processing illustrated in FIG. 22 (Step S92). When the control unit 12 starts the tenth processing, a mode of the control unit 12 is switched from the first start mode to the first deformation mode.

As illustrated in FIG. 22, when starting the tenth processing, the control unit 12 acquires the electrical angle θ of the motor 20 (Step S101). Then, the control unit 12 determines whether or not a sign switching completion flag is set (Step S102). In a case of determining that the sign switching completion flag is not set (Step S102: No), the control unit 12 adds a predetermined amount to the first change rate K1 (Step S110).

Then, the control unit 12 calculates the first offset waveform W1(θ) based on the acquired electrical angle C and Formula (1) (Step S111). In Step S111, the control unit 12 calculates the first offset waveform W1(θ) with the sign Sgn as −1.

Then, the control unit 12 calculates the second offset waveform W2 based on Formula (2) (Step S112). In Step S112, the control unit 12 calculates the second offset waveform W2 with the sign Sgn as −1.

Then, the control unit 12 determines whether or not the first change rate K1 is 1 (Step S113). In a case of determining that the first change rate K1 is 1 (Step S113: Yes), the control unit 12 clears the first modulation method switching flag (Step S114). Then, the control unit 12 sets a second modulation method switching flag (Step S115). Then, after setting the second modulation method switching flag, the control unit 12 outputs the first offset waveform W1(θ) calculated in Step S111 (Step S108). Furthermore, the control unit 12 outputs the second offset waveform W2 calculated in Step S112 (Step S109).

On the other hand, in a case of determining that the first change rate K1 is not 1 (Step S113: No), the control unit 12 skips Steps S114 and S115 and proceeds to Step S108. After executing Step S109, the control unit 12 ends the tenth processing and proceeds to Step S93 of the ninth processing illustrated in FIG. 21.

As illustrated in FIG. 21, when proceeding to Step S93 of the ninth processing after the tenth processing ends, the control unit 12 adds the first offset waveform W1(θ) output in Step S108 of the tenth processing and a three-phase AC waveform at the same electrical angle C as the first offset waveform W1(C) to calculate a modulated waveform at the same electrical angle θ (Step S93).

Then, the control unit 12 adds the second offset waveform W2 output in Step S109 of the tenth processing and the modulated waveform calculated in Step S93 to calculate a modulated waveform to be finally output (Step S94). After executing Step S94, the control unit 12 ends the ninth processing.

A period from start of the first deformation mode to determination that the first change rate K1 is 1 in Step S113 of the tenth processing is the first period. That is, when the first change rate K1 increases by a predetermined amount at a time from the first lower limit value to the first upper limit value in a state where the sign Sgn is fixed to −1 in the first period as a first half of a period in which the control unit 12 operates in the first deformation mode, a modulation method gradually shifts from a modulation method close to a characteristic of the low-side-on-fixed-type two-phase modulation to a modulation method close to a characteristic of the spatial vector modulation. Furthermore, since the second offset waveform W2 calculated by Formula (2) is added to a modulated waveform output during the first period, a lower end of the modulated waveform sticks to 0.

As illustrated in FIG. 21, in a case of determining that the second modulation method switching flag is set after determining that the first modulation method switching flag is not set (Step S95: Yes), that is, in a case where the first change rate K1 reaches 1 in the tenth processing, the control unit 12 executes the eleventh processing illustrated in FIG. 23 (Step S96). When the control unit 12 starts the eleventh processing while the sign Sgn remains at −1 (while the sign switching completion flag is not set), a mode of the control unit 12 is switched from the first deformation mode to the first movement mode.

As illustrated in FIG. 23, when starting the eleventh processing, the control unit 12 acquires the electrical angle θ of the motor 20 (Step S121). Then, the control unit 12 determines whether or not a sign switching completion flag is set (Step S122). In a case of determining that the sign switching completion flag is not set (Step S122: No), the control unit 12 calculates the first offset waveform W1(θ) based on the acquired electrical angle θ and Formula (1) (Step S130). In Step S130, the control unit 12 calculates the first offset waveform W1(θ) with the sign Sgn as −1.

Then, the control unit 12 subtracts a predetermined amount from an absolute value of the second offset waveform W2 (Step S131). Note that, since an absolute value of the second offset waveform W2 is (1−m)/2 when the first eleventh processing is executed, when Step S131 of the first eleventh processing is executed, a predetermined amount is subtracted from (1−m)/2.

Subsequently, the control unit 12 determines whether or not an absolute value of the second offset waveform W2 is 0 (Step S132). In a case of determining that an absolute value of the second offset waveform W2 is 0 (Step S132: Yes), the control unit 12 switches the sign Sgn (Step S133). That is, in the first case, the control unit 12 switches the sign Sgn from −1 to 1. After switching the sign Sgn as described above, the control unit 12 sets the sign switching completion flag (Step S134). After setting the sign switching completion flag, the control unit 12 proceeds to Step S128 described later.

When processing to Step S128, the control unit 12 outputs the first offset waveform W1(θ) calculated in Step S130 (Step S128). Then, the control unit 12 outputs the second offset waveform W2 calculated in Step S131 (Step S129).

On the other hand, in a case of determining that an absolute value of the second offset waveform W2 is not 0 (Step S132: No), the control unit 12 skips Steps S133 and S134 and proceeds to Step S128. After executing Step S129, the control unit 12 ends the eleventh processing and proceeds to Step S93 of the ninth processing illustrated in FIG. 21.

As illustrated in FIG. 21, when proceeding to Step S93 of the ninth processing after the eleventh processing ends, the control unit 12 adds the first offset waveform W1(θ) output in Step S128 of the eleventh processing and a three-phase AC waveform at the same electrical angle θ as the first offset waveform W1(θ) to calculate a modulated waveform at the same electrical angle θ (Step S93).

Then, the control unit 12 adds the second offset waveform W2 output in Step S129 of the eleventh processing and the modulated waveform calculated in Step S93 to calculate a modulated waveform to be finally output (Step S94). After executing Step S94, the control unit 12 ends the ninth processing.

The control unit 12 continues to operate in the first movement mode until an absolute value of the second offset waveform W2 is determined to be 0 in Step S132 of the eleventh processing. That is, in a period in which the control unit 12 operates in the first movement mode, since a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform decreases by a predetermined amount at a time from (1−m)/2 to 0, a modulated waveform stuck to 0 gradually moves to the high voltage side.

Then, when an absolute value of the second offset waveform W2 becomes 0 while the first change rate K1 remains 1, as indicated by “Mode C” in FIG. 20, a modulated waveform obtained on a condition that the first change rate K1 is 1 and an absolute value of the second offset waveform W2 is 0 is output. For this reason, the power conversion circuit 11 is controlled by the spatial vector modulation.

Further, after an absolute value of the second offset waveform W2 becomes 0, when the sign Sgn is switched to 1 and the sign switching completion flag is set, the control unit 12 determines that the sign switching completion flag is set in Step S122 when the next eleventh processing is executed. As described above, when the control unit 12 starts the eleventh processing in a state where the sign Sgn is 1 (a state where the sign switching completion flag is set), a mode of the control unit 12 is switched from the first movement mode to the second movement mode.

As illustrated in FIG. 23, in a case of determining that the sign switching completion flag is set (Step S122: Yes), the control unit 12 calculates the first offset waveform W1(θ) based on the electrical angle θ acquired in Step S121 and Formula (1) (Step S123). In Step S123, the control unit 12 calculates the first offset waveform W1(θ) with the sign Sgn as 1.

Then, the control unit 12 adds a predetermined amount to an absolute value of the second offset waveform W2 (Step S124). Note that, since an absolute value of the second offset waveform W2 is 0 before first Step S124 is executed, when first Step S124 is executed, a value obtained by adding a predetermined amount to 0 is calculated as an absolute value of the second offset waveform W2.

Subsequently, the control unit 12 determines whether or not an absolute value of the second offset waveform W2 is (1−m)/2 (Step S125). In a case of determining that an absolute value of the second offset waveform W2 is (1−m)/2 (Step S125: Yes), the control unit 12 clears the second modulation method switching flag (Step S126). Then, the control unit 12 sets the first modulation method switching flag (Step S127).

Then, after setting the first modulation method switching flag, the control unit 12 outputs the first offset waveform W1(θ) calculated in Step S123 (Step S128). Then, the control unit 12 outputs the second offset waveform W2 calculated in Step S124 (Step S129).

On the other hand, in a case of determining that an absolute value of the second offset waveform W2 is not (1−m)/2 (Step S125: No), the control unit 12 skips Steps S126 and S127 and proceeds to Step S128. After executing Steps S128 and S129, the control unit 12 ends the eleventh processing and proceeds to Step S93 of the ninth processing illustrated in FIG. 21.

As illustrated in FIG. 21, when proceeding to Step S93 of the ninth processing after the eleventh processing ends, the control unit 12 adds the first offset waveform W1(θ) output in Step S128 of the eleventh processing and a three-phase AC waveform at the same electrical angle θ as the first offset waveform W1(θ) to calculate a modulated waveform at the same electrical angle θ (Step S93).

Then, the control unit 12 adds the second offset waveform W2 output in Step S129 of the eleventh processing and the modulated waveform calculated in Step S93 to calculate a modulated waveform to be finally output (Step S94). After executing Step S94, the control unit 12 ends the ninth processing.

The control unit 12 continues to operate in the second movement mode until an absolute value of the second offset waveform W2 is determined to be (1−m)/2 in Step S125 of the eleventh processing. That is, in a period in which the control unit 12 operates in the second movement mode, since a modulated waveform obtained by adding the first offset waveform W1(θ) calculated on a condition that the first change rate K1 is 1 and the sign Sgn is 1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the second movement mode, since an absolute value of the second offset waveform W2 added to a modulated waveform gradually decreases and increases by a predetermined amount from 0 to (1−m)/2, a modulated waveform gradually moves to the high voltage side. Then, at a time point at which an absolute value of the second offset waveform W2 reaches (1−m)/2, an upper end of a modulated waveform sticks to 1.

When the first modulation method switching flag is set in Step S127 of the eleventh processing after an absolute value of the second offset waveform W2 becomes (1−m)/2, the control unit 12 determines that the sign switching flag is set in Step S102 when the tenth processing is executed after the next ninth processing. As described above, when the control unit 12 starts the tenth processing in a state where the sign Sgn is 1 (a state where the sign switching completion flag is set), a mode of the control unit 12 is switched from the second movement mode to the first deformation mode.

As illustrated in FIG. 22, in a case of determining that the sign switching completion flag is set (Step S102: Yes), the control unit 12 subtracts a predetermined amount from the first change rate K1 (Step S103). Then, the control unit 12 calculates the first offset waveform W1(θ) based on the electrical angle θ acquired in Step S101 and Formula (1) (Step S104). In Step S104, the control unit 12 calculates the first offset waveform W1(θ) with the sign Sgn as 1.

Then, the control unit 12 calculates the second offset waveform W2 based on Formula (2) (Step S105). In Step S105, the control unit 12 calculates the second offset waveform W2 with the sign Sgn as 1.

Then, the control unit 12 determines whether or not the first change rate K1 is 0 (Step S106). In a case of determining that the first change rate K1 is 0 (Step S106: Yes), the control unit 12 clears the first modulation method switching flag (Step S107). After clearing the first modulation method switching flag, the control unit 12 outputs the first offset waveform W1(θ) calculated in Step S104 (Step S108). Furthermore, the control unit 12 outputs the second offset waveform W2 calculated in Step S105 (Step S109).

On the other hand, in a case of determining that the first change rate K1 is not 0 (Step S106: No), the control unit 12 skips Step S107 and proceeds to Step S108. After executing Steps S108 and S109, the control unit 12 ends the tenth processing and proceeds to Step S93 of the ninth processing illustrated in FIG. 21.

As illustrated in FIG. 21, when proceeding to Step S93 of the ninth processing after the tenth processing ends, the control unit 12 adds the first offset waveform W1(θ) output in Step S108 of the tenth processing and a three-phase AC waveform at the same electrical angle θ as the first offset waveform W1(θ) to calculate a modulated waveform at the same electrical angle θ (Step S93).

Then, the control unit 12 adds the second offset waveform W2 output in Step S109 of the tenth processing and the modulated waveform calculated in Step S93 to calculate a modulated waveform to be finally output (Step S94). After executing Step S94, the control unit 12 ends the ninth processing.

A period from when the second movement mode is switched to the first deformation mode until the first change rate K1 is determined to be 0 in Step S106 of the tenth processing is the second period. That is, when the first change rate K1 decreases by a predetermined amount at a time from the first upper limit value to the first lower limit value in a state where the sign Sgn is fixed to 1 in the second period as a second half of a period in which the control unit 12 operates in the first deformation mode, a modulation method gradually shifts from a modulation method close to a characteristic of the spatial vector modulation to a modulation method close to a characteristic of the high-side-on-fixed-type two-phase modulation. Furthermore, since the second offset waveform W2 calculated by Formula (2) is added to a modulated waveform output in the second period, an upper end of a modulated waveform sticks to 1, but a value of the second offset waveform W2 gradually decreases as the first change rate K1 decreases.

Then, when the first change rate K1 becomes 0 and the first modulation method switching flag is cleared, the mode of the control unit 12 is switched from the first deformation mode to the first end mode. That is, during a period in which the control unit 12 operates in the first end mode, as a modulated waveform obtained by adding the first offset waveform W1(θ) calculated on a condition that the first change rate K1 is 0 and the sign Sgn is 1 and a three-phase AC waveform is output, the power conversion circuit 11 is controlled by the high-side-on-fixed-type two-phase modulation.

As described above, in the first case of the fifth embodiment, the control unit 12 operates in the first start mode corresponding to the low-side-on-fixed-type two-phase modulation, the first deformation mode (first period), the first movement mode, the second movement mode, the first deformation mode (second period), and the first end mode corresponding to the high-side-on-fixed-type two-phase modulation in this order. Then, during the first period in which the control unit 12 operates in the first deformation mode, in a state in which a lower end of a modulated waveform sticks to 0, a modulation method gradually shifts from a modulation method close to a characteristic of the low-side-on-fixed-type two-phase modulation to a modulation method close to a characteristic of the spatial vector modulation. Further, during a period in which the control unit 12 operates in the first movement mode, a modulated waveform that sticks to 0 gradually moves to the high voltage side while the power conversion circuit 11 is controlled by a modulation method close to a characteristic of the spatial vector modulation.

During a period in which the control unit 12 operates in the second movement mode, a modulated waveform gradually moves to the high voltage side while the power conversion circuit 11 is controlled by a modulation method close to a characteristic of the spatial vector modulation, and an upper end of the modulated waveform finally sticks to 1. Furthermore, during the second period in which the control unit 12 operates in the first deformation mode, in a state in which an upper end of a modulated waveform sticks to 1, a modulation method gradually shifts from a modulation method close to a characteristic of the spatial vector modulation to a modulation method close to a characteristic of the high-side-on-fixed-type two-phase modulation.

According to the first case of the fifth embodiment as described above, similarly to the first case of the fourth embodiment, it is possible to seamlessly switch a modulation method from the low-side-on-fixed-type two-phase modulation (the modulation method of the first start mode) to the high-side-on-fixed-type two-phase modulation (the modulation method of the first end mode) with the spatial vector modulation performed between them. Further, since it is possible to reduce a change in a rotational speed of the motor 20, a sudden change in noise, and a sudden change in a switching loss due to switching of a modulation method, it is possible to reduce a torque fluctuation of the motor 20 and to prevent the user from feeling uncomfortable. Furthermore, since an amount of heat generation on the high-side switch side and an amount of heat generation on the low-side switch side are averaged over an entire period in which the control unit 12 operates in each mode, overheating of the power conversion circuit 11 can be prevented.

According to the first case of the fifth embodiment, since a lower end of a modulated waveform is stuck to 0 during the first period in which the control unit 12 operates in the first deformation mode, switching of a low-side switch is stopped, so that a switching loss can be reduced. Further, according to the first case of the fifth embodiment, since an upper end of a modulated waveform is stuck to 1 during the second period in which the control unit 12 operates in the first deformation mode, switching of a high-side switch is stopped, so that a switching loss can be reduced.

Note that, in the first case of the fifth embodiment, an aspect in which the control unit 12 determines whether or not the first change rate K1 is 1 in Step S113 of the tenth processing is exemplified, but the present invention is not limited to this. For example, in the first case of the fifth embodiment, the control unit 12 may determine whether or not the first change rate K1 is the first upper limit value (for example, 0.99) or more in Step S113. In this case, it is possible to shift a modulation method from the low-side-on-fixed-type two-phase modulation to the high-side-on-fixed-type two-phase modulation without performing the spatial vector modulation.

Next, operation of the control unit 12 in a second case of the fifth embodiment will be described.

In the second case, the control unit 12 first operates in the first start mode. In the first start mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In a period during which the control unit 12 operates in the first start mode, the first offset waveform W1(θ) is calculated on a condition that the first change rate K1 is 0 and the sign Sgn is 1, and the second offset waveform W2 is 0, for example.

The control unit 12 operates in the first deformation mode after operating in the first start mode. In the first deformation mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 expressed by Formula (2) as a final modulated waveform. In the first period as a first half of a period during which the control unit 12 operates in the first deformation mode, the first change rate K1 gradually changes (increases) from the first lower limit value to the first upper limit value in a state where the sign Sgn is fixed to 1. Further, in the second period as a second half of a period during which the control unit 12 operates in the first deformation mode, the first change rate K1 gradually changes (decreases) from the first upper limit value to the first lower limit value in a state where the sign Sgn is fixed to −1.

After operating in the first deformation mode, the control unit 12 operates in the first end mode. In the first end mode, the control unit 12 outputs a modulated waveform obtained by adding the first offset waveform W1(θ) expressed by Formula (1) and a three-phase AC waveform. In a period during which the control unit 12 operates in the first end mode, the first offset waveform W1(θ) is calculated on a condition that the first change rate K1 is 0 and the sign Sgn is −1.

The control unit 12 operates in the first movement mode and the second movement mode in this order in a period between the first period and the second period. In the first movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the first movement mode, the first offset waveform W1(θ) is calculated on a condition that the first change rate K1 is 1 and the sign Sgn is 1. Further, during a period in which the control unit 12 operates in the first movement mode, an absolute value of the second offset waveform W2 gradually changes (decreases) from (1−m)/2 to 0.

In the second movement mode, the control unit 12 outputs a modulated waveform obtained by adding the first offset waveform W1(θ) expressed by Formula (1) and a three-phase AC waveform, and outputs a modulated waveform obtained by adding the modulated waveform and the second offset waveform W2 as a final modulated waveform. In a period during which the control unit 12 operates in the second movement mode, the first offset waveform W1(θ) is calculated on a condition that the first change rate K1 is 1 and the sign Sgn is −1. Further, during a period in which the control unit 12 operates in the second movement mode, an absolute value of the second offset waveform W2 gradually changes (increases) from 0 to (1−m)/2.

In the second case, “Mode D” in FIG. 20 indicates a modulated waveform output during a period in which the control unit 12 operates in the first start mode. “Mode H” in FIG. 20 indicates a modulated waveform output in the first period as a first half of a period in which the control unit 12 operates in the first deformation mode. “Mode C” in FIG. 20 indicates a modulated waveform when the first change rate K1 becomes 1 and an absolute value of the second offset waveform W2 becomes 0. “Mode F” in FIG. 20 indicates a modulated waveform output in the second period as a second half of a period in which the control unit 12 operates in the first deformation mode. “Mode A” in FIG. 20 indicates a modulated waveform output during a period in which the control unit 12 operates in the first end mode.

Although not illustrated in FIG. 20, a modulated waveform output during a period in which the control unit 12 operates in the first movement mode appears between “Mode H” and “Mode C” in the second case. Further, although not illustrated in FIG. 20, a modulated waveform output during a period in which the control unit 12 operates in the second movement mode appears between “Mode C” and “Mode F” in the second case.

As indicated by “Mode D” in FIG. 20, during a period in which the control unit 12 operates in the first start mode, since a modulated waveform obtained by adding the first offset waveform W1(θ) calculated on a condition that the first change rate K1 is 0 and the sign Sgn is 1 and a three-phase AC waveform is output, and a modulated waveform obtained by adding the second offset waveform W2 that is 0 to the modulated waveform is output finally, the power conversion circuit 11 is controlled by the high-side-on-fixed-type two-phase modulation.

In the first period as a first half of a period during which the control unit 12 operates in the first deformation mode, when the first change rate K1 gradually increases from the first lower limit value to the first upper limit value in a state in which the sign Sgn is fixed to 1, a modulated waveform output from the control unit 12 also gradually changes with increase in the first change rate K1. In the first period as described above, a modulation method gradually shifts from a modulation method close to a characteristic of the high-side-on-fixed-type two-phase modulation to a modulation method close to a characteristic of the spatial vector modulation. Furthermore, the second offset waveform W2 calculated by Formula (2) is added to a modulated waveform output during the first period. By the above, as indicated by “Mode H” in FIG. 20, an upper end of a modulated waveform output in the first period sticks to 1.

In a period in which the control unit 12 operates in the first movement mode, since a modulated waveform obtained by adding the first offset waveform W1(θ) calculated on a condition that the first change rate K1 is 1 and the sign Sgn is 1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the first movement mode, since an absolute value of the second offset waveform W2 added to a modulated waveform gradually decreases from (1−m)/2 to 0, a modulated waveform stuck to 1 gradually moves to the low voltage side.

As indicated by “Mode C” in FIG. 20, in a period in which the control unit 12 operates in the first movement mode, when an absolute value of the second offset waveform W2 becomes 0, a modulated waveform obtained on a condition that the first change rate K1 is 1 and an absolute value of the second offset waveform W2 is 0 is output. For this reason, the power conversion circuit 11 is controlled by the spatial vector modulation.

In a period in which the control unit 12 operates in the second movement mode, since a modulated waveform obtained by adding the first offset waveform W1(θ) calculated on a condition that the first change rate K1 is 1 and the sign Sgn is −1 and a three-phase AC waveform is output and a modulated waveform obtained by adding the second offset waveform W2 to the modulated waveform is finally output, the power conversion circuit 11 is controlled by a modulation method close to a characteristic of the spatial vector modulation. Furthermore, during a period in which the control unit 12 operates in the second movement mode, since an absolute value of the second offset waveform W2 added to a modulated waveform gradually increases from 0 to (1−m)/2, a modulated waveform gradually moves to the low voltage side. Then, at a time point at which an absolute value of the second offset waveform W2 reaches (1−m)/2, a lower end of a modulated waveform sticks to 0.

When the first change rate K1 gradually decreases from the first upper limit value to the first lower limit value in a state where the sign Sgn is fixed to −1 in the second period of a second half of a period in which the control unit 12 operates in the first deformation mode, a modulated waveform output from the control unit 12 also gradually changes with decrease in the first change rate K1. In the second period as described above, a modulation method gradually shifts from a modulation method close to a characteristic of the spatial vector modulation to a modulation method close to a characteristic of the low-side-on-fixed-type two-phase modulation. Furthermore, the second offset waveform W2 calculated by Formula (2) is added to a modulated waveform output during the second period. By the above, as indicated by “Mode F” in FIG. 20, a lower end of a modulated waveform output during the second period sticks to 0, but a value of the second offset waveform W2 also gradually decreases as the first change rate K1 decreases.

As indicated by “Mode A” in FIG. 20, during a period in which the control unit 12 operates in the first end mode, since a modulated waveform obtained by adding the first offset waveform W1(θ) calculated on a condition that the first change rate K1 is 0 and the sign Sgn is −1 and a three-phase AC waveform is output, the power conversion circuit 11 is controlled by the low-side-on-fixed-type two-phase modulation.

The first processing, the ninth processing, the tenth processing, and the eleventh processing executed by the control unit 12 in the second case of the fifth embodiment are basically the same as those in the first case of the fifth embodiment, but are different from those in the first case in that an initial value of the sign Sgn is set to 1. In the first case of the fifth embodiment, an initial value of the sign Sgn is set to −1.

As described above, in the second case of the fifth embodiment, the control unit 12 operates in the first start mode corresponding to the high-side-on-fixed-type two-phase modulation, the first deformation mode (first period), the first movement mode, the second movement mode, the first deformation mode (second period), and the first end mode corresponding to the low-side-on-fixed-type two-phase modulation in this order. Then, during the first period in which the control unit 12 operates in the first deformation mode, in a state in which an upper end of a modulated waveform sticks to 1, a modulation method gradually shifts from a modulation method close to a characteristic of the high-side-on-fixed-type two-phase modulation to a modulation method close to a characteristic of the spatial vector modulation. Further, during a period in which the control unit 12 operates in the first movement mode, a modulated waveform stuck to 1 gradually moves to the low voltage side while the power conversion circuit 11 is controlled by a modulation method close to a characteristic of the spatial vector modulation, and the power conversion circuit 11 is finally controlled by the spatial vector modulation.

During a period in which the control unit 12 operates in the second movement mode, a modulated waveform gradually moves to the low voltage side while the power conversion circuit 11 is controlled by a modulation method close to a characteristic of the spatial vector modulation, and a lower end of the modulated waveform finally sticks to 1. Furthermore, during the second period in which the control unit 12 operates in the first deformation mode, in a state in which a lower end of a modulated waveform sticks to 0, a modulation method gradually shifts from a modulation method close to a characteristic of the spatial vector modulation to a modulation method close to a characteristic of the low-side-on-fixed-type two-phase modulation.

According to the second case of the fifth embodiment as described above, similarly to the second case of the fourth embodiment, it is possible to seamlessly switch a modulation method from the high-side-on-fixed-type two-phase modulation (the modulation method of the first start mode) to the low-side-on-fixed-type two-phase modulation (the modulation method of the first end mode) with the spatial vector modulation performed between them. Further, since it is possible to reduce a change in a rotational speed of the motor 20, a sudden change in noise, and a sudden change in a switching loss due to switching of a modulation method, it is possible to reduce a torque fluctuation of the motor 20 and to prevent the user from feeling uncomfortable. Furthermore, since an amount of heat generation on the high-side switch side and an amount of heat generation on the low-side switch side are averaged over an entire period in which the control unit 12 operates in each mode, overheating of the power conversion circuit 11 can be prevented.

According to the second case of the fifth embodiment, since an upper end of a modulated waveform is stuck to 1 during the first period in which the control unit 12 operates in the first deformation mode, switching of a high-side switch is stopped, so that a switching loss can be reduced. Further, according to the second case of the fifth embodiment, since a lower end of a modulated waveform is stuck to 0 during the second period in which the control unit 12 operates in the first deformation mode, switching of a low-side switch is stopped, so that a switching loss can be reduced.

Note that, also in the second case of the fifth embodiment, an aspect in which the control unit 12 determines whether or not the first change rate K1 is 1 in Step S113 of the tenth processing is exemplified, but the present invention is not limited to this. For example, also in the second case of the fifth embodiment, the control unit 12 may determine whether or not the first change rate K1 is the first upper limit value (for example, 0.99) or more in Step S113. In this case, it is possible to shift a modulation method from the high-side-on-fixed-type two-phase modulation to the low-side-on-fixed-type two-phase modulation without performing the spatial vector modulation.

Further, in each of the first case and the second case of the fifth embodiment, the first change rate K1 may be changed from the first lower limit value to the first upper limit value in the first period in which the control unit 12 operates in the first deformation mode, and an absolute value of the second offset waveform W2 may be changed to 0 while the first change rate K1 is changed to 1 in a period in which the control unit 12 operates in the first movement mode.

Further, in each of the first case and the second case of the fifth embodiment, the first change rate K1 may be changed from the first lower limit value to the first upper limit value in the first period in which the control unit 12 operates in the first deformation mode, and the first change rate K1 may be changed to 1 after an absolute value of the second offset waveform W2 is changed to 0 in a period in which the control unit 12 operates in the first movement mode.

Further, in each of the first case and the second case of the fifth embodiment, the first change rate K1 may be changed from the first upper limit value to the first lower limit value in the second period in which the control unit 12 operates in the first deformation mode, and an absolute value of the second offset waveform W2 may be changed to (1−m)/2 while the first change rate K1 is changed to 0 in a period in which the control unit 12 operates in the second movement mode.

Further, in each of the first case and the second case of the fifth embodiment, the first change rate K1 may be changed from the first upper limit value to the first lower limit value in the second period in which the control unit 12 operates in the first deformation mode, and the first change rate K1 may be changed to 0 after an absolute value of the second offset waveform W2 is changed to (1−m)/2 in a period in which the control unit 12 operates in the second movement mode.

Next, a sixth embodiment of the present invention will be described. The control unit 12 of the sixth embodiment is different from that of the first embodiment in having the first deformation mode different from the first deformation mode in the first embodiment and a second deformation mode. Therefore, operation of the control unit 12 in the sixth embodiment will be described in detail below.

In the first deformation mode, the control unit 12 outputs a modulated waveform obtained by adding a third offset waveform W3(θ) expressed by Formula (3) having the maximum value fmax(θ) and the minimum value fmin(θ) of a three-phase AC waveform at the electrical angle θ of the motor 20 and a second change rate K2 as variables and a three-phase AC waveform. Further, in the second deformation mode, the control unit 12 outputs a modulated waveform obtained by adding a fourth offset waveform W4(θ) expressed by Formula (4) having the maximum value fmax(θ) and the minimum value fmin(θ) of a three-phase AC waveform at the electrical angle θ of the motor 20 and a third change rate K3 as variables and a three-phase AC waveform.

Although details will be described later, the control unit 12 switches between the first deformation mode and the second deformation mode every 1/N of an electrical angle of 180 degrees in the first period. In the present embodiment, since a value of N is three, the control unit 12 switches between the first deformation mode and the second deformation mode at every 60 degrees of electrical angle in the first period. Further, the control unit 12 outputs a modulated waveform obtained by adding the fifth offset waveform W5(θ) represented by Formula (5) and a three-phase AC waveform in the second period before the first period or the third period after the first period.

$$\begin{matrix}[ Mathematical formula 5 ] & \\ W 3 ( θ ) = - f min ( θ ) \times ( 1 - K 2 ) + K 2 \times \{ 1 - f max ( θ ) - f min ( θ ) \} / 2 & ( 3 )\end{matrix}$$

$$W 4 ( θ ) = \{ 1 - f max ( θ ) \} \times ( 1 - K 3 ) + K 3 \times \{ 1 - f max ( θ ) - f min ( θ ) \} / 2 \qquad ( 4 )$$

$$W 5 ( θ ) = \{ 1 - f max ( θ ) - f min ( θ ) \} / 2 \qquad ( 5 )$$

The third offset waveform W3(θ) calculated by Formula (3) on a condition that the second change rate K2 is 0 is the same as the first offset waveform W1(θ) calculated by Formula (1) on a condition that the first change rate K1 is 0 and the sign Sgn is −1 (see the middle graph of FIG. 2). Therefore, a modulated waveform obtained by adding the third offset waveform W3(θ) calculated by Formula (3) on a condition that the second change rate K2 is 0 and a three-phase AC waveform is the same as a modulated waveform obtained by adding the first offset waveform W1(θ) calculated by Formula (1) on a condition that the first change rate K1 is 0 and the sign Sgn is −1 (see the lower graph in FIG. 2).

That is, during a period in which the control unit 12 of the sixth embodiment operates in the first deformation mode, as a modulated waveform obtained by adding the third offset waveform W3(θ) calculated by Formula (3) on a condition that the second change rate K2 is 0 and a three-phase AC waveform is output, the power conversion circuit 11 is controlled by the low-side-on-fixed-type two-phase modulation.

The third offset waveform W3(θ) calculated by Formula (3) on a condition that the second change rate K2 is 1 is the same as the first offset waveform W1(θ) calculated by Formula (1) on a condition that the first change rate K1 is 1 and the sign Sgn is 1 or −1 (see the middle graph of FIG. 3). Therefore, a modulated waveform obtained by adding the third offset waveform W3(θ) calculated by Formula (3) on a condition that the second change rate K2 is 1 and a three-phase AC waveform is the same as a modulated waveform obtained by adding the first offset waveform W1(θ) calculated by Formula (1) on a condition that the first change rate K1 is 1 and the sign Sgn is 1 or −1 (see the lower graph in FIG. 3).

That is, during a period in which the control unit 12 of the sixth embodiment operates in the first deformation mode, as a modulated waveform obtained by adding the third offset waveform W3(θ) calculated by Formula (3) on a condition that the second change rate K2 is 1 and a three-phase AC waveform is output, the power conversion circuit 11 is controlled by the spatial vector modulation.

The fourth offset waveform W4(θ) calculated by Formula (4) on a condition that the third change rate K3 is 0 is the same as the first offset waveform W1(θ) calculated by Formula (1) on a condition that the first change rate K1 is 0 and the sign Sgn is 1 (see the middle graph of FIG. 4). Therefore, a modulated waveform obtained by adding the fourth offset waveform W4(θ) calculated by Formula (4) on a condition that the third change rate K3 is 0 and a three-phase AC waveform is the same as a modulated waveform obtained by adding the first offset waveform W1(θ) calculated by Formula (1) on a condition that the first change rate K1 is 0 and the sign Sgn is 1 (see the lower graph in FIG. 4).

That is, during a period in which the control unit 12 of the sixth embodiment operates in the second deformation mode, as a modulated waveform obtained by adding the fourth offset waveform W4(θ) calculated by Formula (4) on a condition that the third change rate K3 is 0 and a three-phase AC waveform is output, the power conversion circuit 11 is controlled by the high-side-on-fixed-type two-phase modulation.

The fourth offset waveform W4(θ) calculated by Formula (4) on a condition that the third change rate K3 is 1 is the same as the first offset waveform W1(θ) calculated by Formula (1) on a condition that the first change rate K1 is 1 and the sign Sgn is 1 or −1 (see the middle graph of FIG. 3). Therefore, a modulated waveform obtained by adding the fourth offset waveform W4(θ) calculated by Formula (4) on a condition that the third change rate K3 is 1 and a three-phase AC waveform is the same as a modulated waveform obtained by adding the first offset waveform W1(θ) calculated by Formula (1) on a condition that the first change rate K1 is 1 and the sign Sgn is 1 or −1 (see the lower graph in FIG. 3).

That is, during a period in which the control unit 12 of the sixth embodiment operates in the second deformation mode, as a modulated waveform obtained by adding the fourth offset waveform W4(θ) calculated by Formula (4) on a condition that the third change rate K3 is 1 and a three-phase AC waveform is output, the power conversion circuit 11 is controlled by the spatial vector modulation.

First, operation of the control unit 12 in a first case of the sixth embodiment will be described.

In the second period before the first period, the control unit 12 switches between the first deformation mode in which the second change rate K2 is fixed to 0 and the second deformation mode in which the third change rate K3 is fixed to 0 at every 60 degrees of electrical angle. In a period in which the control unit 12 operates in the first deformation mode during a period included in the second period, since a modulated waveform obtained by adding the third offset waveform W3(θ) calculated by Formula (3) on a condition that the second change rate K2 is 0 and a three-phase AC waveform is output, the power conversion circuit 11 is controlled by the low-side-on-fixed-type two-phase modulation.

In a period in which the control unit 12 operates in the second deformation mode during a period included in the second period, since a modulated waveform obtained by adding the fourth offset waveform W4(θ) calculated by Formula (4) on a condition that the third change rate K3 is 0 and a three-phase AC waveform is output, the power conversion circuit 11 is controlled by the high-side-on-fixed-type two-phase modulation.

As described above, in the second period, the control unit 12 switches, at every 60 degrees of electrical angle, between the first deformation mode in which the second change rate K2 is fixed to 0 and the second deformation mode in which the third change rate K3 is fixed to 0, so that the power conversion circuit 11 is controlled by a modulation method (what is called an up-down-switching-type two-phase modulation) in which the low-side-on-fixed-type two-phase modulation and the high-side-on-fixed-type two-phase modulation are alternately switched at every 60 degrees of electrical angle. In the up-down-switching-type two-phase modulation method, a switching stop period can be provided for each of a high-side switch and a low-side switch. For this reason, both the high-side switch and the low-side switch can reduce heat generation due to a switching loss.

In the first period after the second period described above, the control unit 12 switches between the first deformation mode and the second deformation mode at every 60 degrees of electrical angle. In a period in which the control unit 12 operates in the first deformation mode during a period included in the first period, since a modulated waveform obtained by adding the third offset waveform W3(θ) calculated by Formula (3) and a three-phase AC waveform is output, the second change rate K2 gradually changes (increases) from a value larger than 0 to a value smaller than 1. As a result, in a period in which the control unit 12 operates in the first deformation mode during a period included in the first period, a modulation method gradually shifts from a modulation method close to a characteristic of the low-side-on-fixed-type two-phase modulation to a modulation method close to a characteristic of the spatial vector modulation.

In description below, in a period during which the control unit 12 operates in the first deformation mode, a value larger than 0 that may be taken by the second change rate K2 is referred to as a second lower limit value, and a value smaller than 1 that may be taken by the second change rate K2 is referred to as a second upper limit value. For example, the second lower limit value is 0.01, and the second upper limit value is 0.99. As the second lower limit value is set to a value close to 0, shifting from the second period to the first period can be more smoothly performed. Further, as the second upper limit value is set to a value close to 1, shifting from the first period to a third period described later can be more smoothly performed.

In a period in which the control unit 12 operates in the second deformation mode during a period included in the first period, a modulated waveform obtained by adding the fourth offset waveform W4(θ) calculated by Formula (4) and a three-phase AC waveform is output, and the third change rate K3 gradually changes (increases) from a value larger than 0 to a value smaller than 1. As a result, in a period in which the control unit 12 operates in the second deformation mode during a period included in the first period, a modulation method gradually shifts from a modulation method close to a characteristic of the high-side-on-fixed-type two-phase modulation to a modulation method close to a characteristic of the spatial vector modulation.

In description below, in a period during which the control unit 12 operates in the second deformation mode, a value larger than 0 that may be taken by the third change rate K3 is referred to as a third lower limit value, and a value smaller than 1 that may be taken by the third change rate K3 is referred to as a third upper limit value. For example, the third lower limit value is 0.01, and the third upper limit value is 0.99. As the third lower limit value is set to a value close to 0, shifting from the second period to the first period can be more smoothly performed. Further, as the third upper limit value is set to a value close to 1, shifting from the first period to the third period described later can be more smoothly performed.

As described above, in the first period, the control unit 12 switches, at every 60 degrees of electrical angle, between the first deformation mode and the second deformation mode, so that a modulation method gradually shifts from a modulation method close to a characteristic of the up-down-switching-type two-phase modulation to a modulation method close to a characteristic of the spatial vector modulation.

The control unit 12 outputs a modulated waveform obtained by adding the fifth offset waveform W5(θ) represented by Formula (5) and a three-phase AC waveform in the third period after the first period described above. The fifth offset waveform W5(θ) expressed by Formula (5) is the same as the third offset waveform W3(θ) calculated by Formula (3) on a condition that the second change rate K2 is 1. Therefore, in the third period, the power conversion circuit 11 is controlled by the spatial vector modulation.

As described above, in the first case of the sixth embodiment, in the first period between the second period in which the power conversion circuit 11 is controlled by the up-down-switching-type two-phase modulation and the third period in which the power conversion circuit 11 is controlled by the spatial vector modulation, a modulation method gradually shifts from a modulation method close to a characteristic of the up-down-switching-type two-phase modulation to a modulation method close to a characteristic of the spatial vector modulation. According to the first case of the sixth embodiment as described above, since it is possible to reduce a change in a rotational speed of the motor 20, a sudden change in noise, and a sudden change in a switching loss due to switching of a modulation method from the up-down-switching-type two-phase modulation to the spatial vector modulation, it is possible to reduce a torque fluctuation of the motor 20 and to prevent the user from feeling uncomfortable. Note that, in the first period, the second change rate K2 and the third change rate K3 may be set to different values. However, when the second change rate K2 and the third change rate K3 are set to the same value, a calculation load of the control unit 12 can be reduced, a high-side switch and a low-side switch operate symmetrically, and heat generation of both switches can be balanced.

Next, operation of the control unit 12 in a second case of the sixth embodiment will be described.

The control unit 12 outputs a modulated waveform obtained by adding the fifth offset waveform W5(θ) represented by Formula (5) and a three-phase AC waveform in the second period before the first period. By the above, in the second period, the power conversion circuit 11 is controlled by the spatial vector modulation.

In the first period after the second period described above, the control unit 12 switches between the first deformation mode and the second deformation mode at every 60 degrees of electrical angle. In a period in which the control unit 12 operates in the first deformation mode during a period included in the first period, a modulated waveform obtained by adding the third offset waveform W3(θ) calculated by Formula (3) and a three-phase AC waveform is output, and the second change rate K2 gradually changes (decreases) from the second upper limit value to the second lower limit value. As a result, in a period in which the control unit 12 operates in the first deformation mode during a period included in the first period, a modulation method gradually shifts from a modulation method close to a characteristic of the spatial vector modulation to a modulation method close to a characteristic of the low-side-on-fixed-type two-phase modulation.

In a period in which the control unit 12 operates in the second deformation mode during a period included in the first period, a modulated waveform obtained by adding the fourth offset waveform W4(θ) calculated by Formula (4) and a three-phase AC waveform is output, and the third change rate K3 gradually changes (decreases) from the third upper limit value to the third lower limit value. As a result, in a period in which the control unit 12 operates in the second deformation mode during a period included in the first period, a modulation method gradually shifts from a modulation method close to a characteristic of the spatial vector modulation to a modulation method close to a characteristic of the high-side-on-fixed-type two-phase modulation.

As described above, in the first period, the control unit 12 switches, at every 60 degrees of electrical angle, between the first deformation mode and the second deformation mode, so that a modulation method gradually shifts from a modulation method close to a characteristic of the spatial vector modulation to a modulation method close to a characteristic of the up-down-switching-type two-phase modulation.

In the third period after the first period described above, the control unit 12 switches between the first deformation mode in which the second change rate K2 is fixed to 0 and the second deformation mode in which the third change rate K3 is fixed to 0 at every 60 degrees of electrical angle. In a period in which the control unit 12 operates in the first deformation mode during a period included in the third period, since a modulated waveform obtained by adding the third offset waveform W3(θ) calculated by Formula (3) on a condition that the second change rate K2 is 0 and a three-phase AC waveform is output, the power conversion circuit 11 is controlled by the low-side-on-fixed-type two-phase modulation.

In a period in which the control unit 12 operates in the second deformation mode during a period included in the third period, since a modulated waveform obtained by adding the fourth offset waveform W4(θ) calculated by Formula (4) on a condition that the third change rate K3 is 0 and a three-phase AC waveform is output, the power conversion circuit 11 is controlled by the high-side-on-fixed-type two-phase modulation.

As described above, in the third period, the control unit 12 switches, at every 60 degrees of electrical angle, between the first deformation mode in which the second change rate K2 is fixed to 0 and the second deformation mode in which the third change rate K3 is fixed to 0, so that the power conversion circuit 11 is controlled by the up-down-switching-type two-phase modulation.

As described above, in the second case of the sixth embodiment, in the first period between the second period in which the power conversion circuit 11 is controlled by the spatial vector modulation and the third period in which the power conversion circuit 11 is controlled by the up-down-switching-type two-phase modulation, a modulation method gradually shifts from a modulation method close to a characteristic of the spatial vector modulation to a modulation method close to a characteristic of the up-down-switching-type two-phase modulation. According to the second case of the sixth embodiment as described above, since it is possible to reduce a change in a rotational speed of the motor 20, a sudden change in noise, and a sudden change in a switching loss due to switching of a modulation method from the spatial vector modulation to the up-down-switching-type two-phase modulation, it is possible to reduce a torque fluctuation of the motor 20 and to prevent the user from feeling uncomfortable. Note that, in the first period, the second change rate K2 and the third change rate K3 may be set to different values. However, when the second change rate K2 and the third change rate K3 are set to the same value, a calculation load of the control unit 12 can be reduced, a high-side switch and a low-side switch operate symmetrically, and heat generation of both switches can be balanced.

Next, a seventh embodiment of the present invention will be described. A part of the first deformation mode and the second deformation mode of the control unit 12 of the seventh embodiment is different from that of the sixth embodiment. Further, the control unit 12 of the seventh embodiment is different from that of the sixth embodiment in that the control unit 12 has the first movement mode and the second movement mode in addition to the first deformation mode and the second deformation mode. Therefore, operation of the control unit 12 in the seventh embodiment will be described in detail below.

First, operation of the control unit 12 in a first case of the seventh embodiment will be described.

In the second period before the first period, the control unit 12 switches between the first deformation mode in which the second change rate K2 is fixed to 0 and the second deformation mode in which the third change rate K3 is fixed to 0 at every 60 degrees of electrical angle. As a result, similarly to the first case of the sixth embodiment, in the second period, the power conversion circuit 11 is controlled by the up-down-switching-type two-phase modulation.

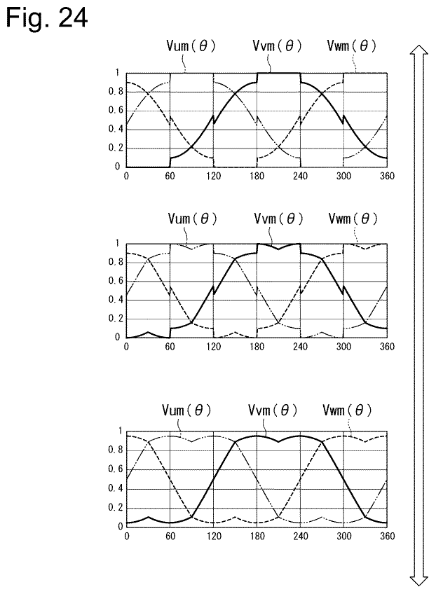

An upper graph in FIG. 24 illustrates an example of a modulated waveform output from the control unit 12 in the second period. In the upper graph of FIG. 24, during a period in which the electrical angle θ falls within a range from 0 degrees to 60 degrees, during a period in which the electrical angle θ falls within a range from 120 degrees to 180 degrees, and during a period in which the electrical angle θ falls within a range from 240 degrees to 300 degrees, the control unit 12 operates in the first deformation mode, that is, the low-side-on-fixed-type two-phase modulation. In a remaining range of the electrical angle θ, the control unit 12 operates in the second deformation mode, that is, the high-side-on-fixed-type two-phase modulation.

In the first period after the second period described above, the control unit 12 switches between the first deformation mode and the second deformation mode at every 60 degrees of electrical angle. In the first deformation mode executed in the first period, the control unit 12 of the seventh embodiment is the same as that in the sixth embodiment in that the control unit 12 outputs a modulated waveform obtained by adding the third offset waveform W3(θ) expressed by Formula (3) and a three-phase AC waveform. Furthermore, in the first deformation mode executed in the first period, the control unit 12 according to the seventh embodiment outputs, as a final modulated waveform, a modulated waveform obtained by subtracting the sixth offset waveform W6 expressed by Formula (6) having the second change rate K2 and the modulation rate m as variables from the above-described modulated waveform. In a period in which the control unit 12 operates in the first deformation mode during a period included in the first period, the second change rate K2 gradually changes (increases) from the second lower limit value to the second upper limit value.

In the second deformation mode executed in the first period, the control unit 12 of the seventh embodiment is the same as that in the sixth embodiment in that the control unit 12 outputs a modulated waveform obtained by adding the fourth offset waveform W4(θ) expressed by Formula (4) and a three-phase AC waveform. Furthermore, in the second deformation mode executed in the first period, the control unit 12 according to the seventh embodiment outputs, as a final modulated waveform, a modulated waveform obtained by adding the seventh offset waveform W7 expressed by Formula (7) having the third change rate K3 and the modulation rate m as variables and the above-described modulated waveform. In a period in which the control unit 12 operates in the second deformation mode during a period included in the first period, the third change rate K3 gradually changes (increases) from the third lower limit value to the third upper limit value.

$$\begin{matrix}[ Mathematical formula 6 ] & \\ W 6 = K 2 \times ( 1 - m ) / 2 & ( 6 )\end{matrix}$$

$$W 7 = K 3 \times ( 1 - m ) / 2 \qquad ( 7 )$$

A middle graph in FIG. 24 illustrates an example of a modulated waveform output from the control unit 12 in the first period. In the middle graph of FIG. 24, during a period in which the electrical angle θ falls within a range from 0 degrees to 60 degrees, during a period in which the electrical angle θ falls within a range from 120 degrees to 180 degrees, and during a period in which the electrical angle θ falls within a range from 240 degrees to 300 degrees, the control unit 12 operates in the first deformation mode, and operates in the second deformation mode in a remaining range of the electrical angle θ.

In a period in which the control unit 12 operates in the first deformation mode during a period included in the first period, when the second change rate K2 gradually increases from the second lower limit value to the second upper limit value, a modulated waveform output from the control unit 12 also gradually changes with increase in the second change rate K2. As an example, the middle graph in FIG. 24 indicates a modulated waveform output when the second change rate K2 is 0.5. As described above, when the second change rate K2 gradually increases from the second lower limit value to the second upper limit value in a period in which the control unit 12 operates in the first deformation mode during a period included in the first period, a modulation method gradually shifts from a modulation method close to a characteristic of the low-side-on-fixed-type two-phase modulation to a modulation method close to a characteristic of the spatial vector modulation.

Furthermore, in a period in which the control unit 12 operates in the first deformation mode during a period included in the first period, a modulated waveform obtained by subtracting the sixth offset waveform W6 expressed by Formula (6) from a modulated waveform obtained by adding the third offset waveform W3(θ) expressed by Formula (3) and a three-phase AC waveform is output as a final modulated waveform. By the above, as illustrated in the middle graph of FIG. 24, a lower end of a modulated waveform output in a period in which the control unit 12 operates in the first deformation mode during a period included in the first period sticks to 0.

In a period in which the control unit 12 operates in the second deformation mode during a period included in the first period, when the third change rate K3 gradually increases from the third lower limit value to the third upper limit value, a modulated waveform output from the control unit 12 also gradually changes with increase in the third change rate K3. As an example, the middle graph in FIG. 24 indicates a modulated waveform output when the third change rate K3 is 0.5. As described above, when the third change rate K3 gradually increases from the third lower limit value to the third upper limit value in a period in which the control unit 12 operates in the second deformation mode during a period included in the first period, a modulation method gradually shifts from a modulation method close to a characteristic of the high-side-on-fixed-type two-phase modulation to a modulation method close to a characteristic of the spatial vector modulation.

Furthermore, in a period in which the control unit 12 operates in the second deformation mode during a period included in the first period, a modulated waveform obtained by adding a modulated waveform obtained by adding the fourth offset waveform W4(θ) expressed by Formula (4) and a three-phase AC waveform and the seventh offset waveform W7 expressed by Formula (7) is output as a final modulated waveform. By the above, as illustrated in the middle graph of FIG. 24, an upper end of a modulated waveform output in a period in which the control unit 12 operates in the second deformation mode during a period included in the first period sticks to 1.

As described above, in the first period, the control unit 12 switches, at every 60 degrees of electrical angle, between the first deformation mode and the second deformation mode, so that a modulation method gradually shifts from a modulation method close to a characteristic of the up-down-switching-type two-phase modulation to a modulation method close to a characteristic of the spatial vector modulation while a value to which a modulated waveform sticks is switched at every 60 of electrical angle between 0 and 1.

In a period between the first period and the third period, the control unit 12 switches between the first movement mode and the second movement mode at every 60 degrees of electrical angle. For example, during a period in which the electrical angle θ falls within a range from 0 degrees to 60 degrees, during a period in which the electrical angle θ falls within a range from 120 degrees to 180 degrees, and during a period in which the electrical angle θ falls within a range from 240 degrees to 300 degrees, the control unit 12 operates in the first movement mode, and operates in the second movement mode in a remaining range of the electrical angle θ.

In the first movement mode, the control unit 12 outputs a modulated waveform obtained by adding the third offset waveform W3(θ) expressed by Formula (3) and a three-phase AC waveform, and outputs a modulated waveform obtained by adding the modulated waveform and the sixth offset waveform W6 as a final modulated waveform. In a period in which the control unit 12 operates in the first movement mode, the third offset waveform W3(θ) is calculated in a state in which the second change rate K2 is fixed to 1. Further, during a period in which the control unit 12 operates in the first movement mode, the sixth offset waveform W6 gradually changes (decreases) from (1−m)/2 to 0.

In a period during which the control unit 12 operates in the first movement mode, the power conversion circuit 11 is controlled by a modulation method close to a characteristic of the spatial vector modulation. Furthermore, during a period in which the control unit 12 operates in the first movement mode, since the sixth offset waveform W6 gradually decreases from (1−m)/2 to 0, a modulated waveform stuck to 0 when the first deformation mode is executed in the first period gradually moves to the high voltage side.

In the second movement mode, the control unit 12 outputs a modulated waveform obtained by adding the fourth offset waveform W4(θ) expressed by Formula (4) and a three-phase AC waveform, and outputs a modulated waveform obtained by adding the modulated waveform and the seventh offset waveform W7 as a final modulated waveform. In a period in which the control unit 12 operates in the second movement mode, the fourth offset waveform W4(θ) is calculated in a state in which the third change rate K3 is fixed to 1. Further, during a period in which the control unit 12 operates in the second movement mode, the seventh offset waveform W7 gradually changes (decreases) from (1−m)/2 to 0.

In a period during which the control unit 12 operates in the second movement mode, the power conversion circuit 11 is controlled by a modulation method close to a characteristic of the spatial vector modulation. Furthermore, during a period in which the control unit 12 operates in the second movement mode, since the seventh offset waveform W7 gradually decreases from (1−m)/2 to 0, a modulated waveform stuck to 1 when the second deformation mode is executed in the first period gradually moves to the low voltage side.

As described above, in a period between the first period and the third period, the control unit 12 switches between the first movement mode and the second movement mode at every 60 degrees of electrical angle, so that the power conversion circuit 11 is controlled by a modulation method close to a characteristic of the spatial vector modulation while an upper end and a lower end of a modulated waveform gradually move toward the center.

A lower graph in FIG. 24 illustrates an example of a modulated waveform output from the control unit 12 in the third period after the first period. The control unit 12 outputs a modulated waveform obtained by adding the fifth offset waveform W5(θ) represented by Formula (5) and a three-phase AC waveform in the third period after the first period. As a result, similarly to the first case of the sixth embodiment, in the third period, the power conversion circuit 11 is controlled by the spatial vector modulation.

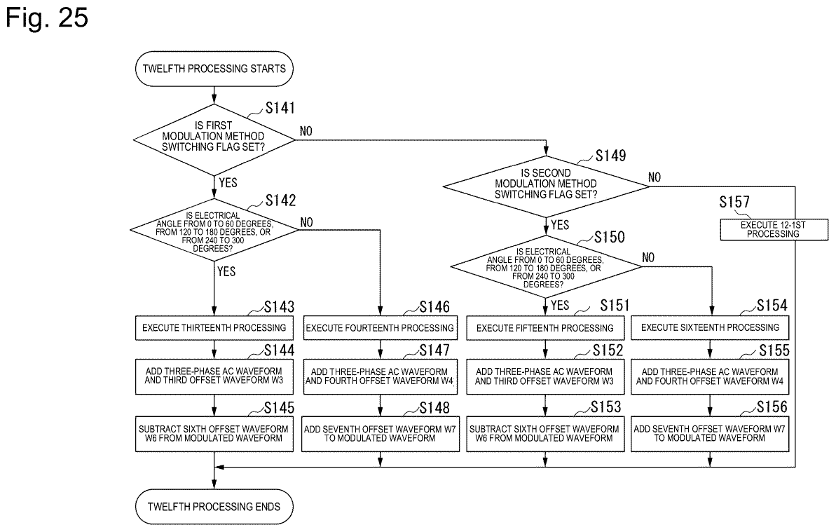

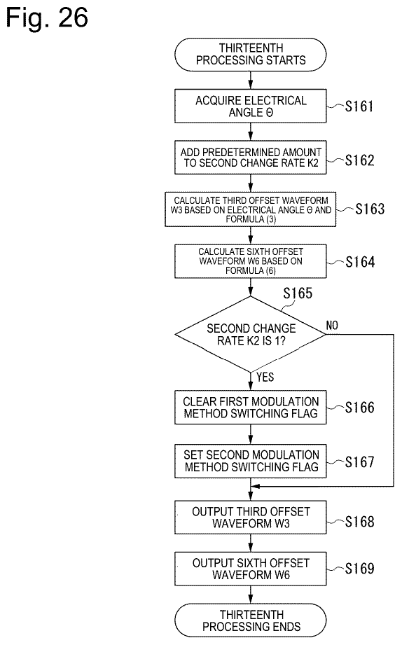

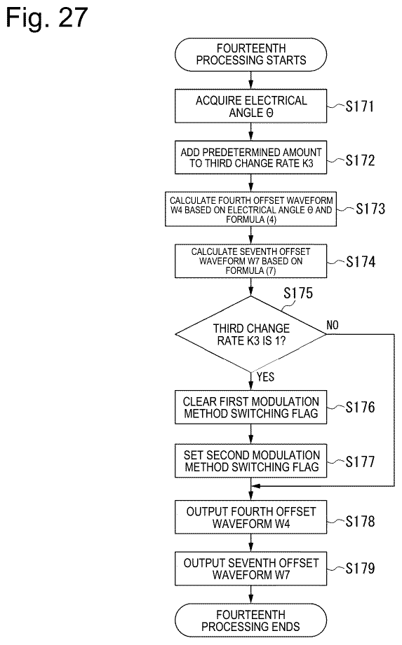

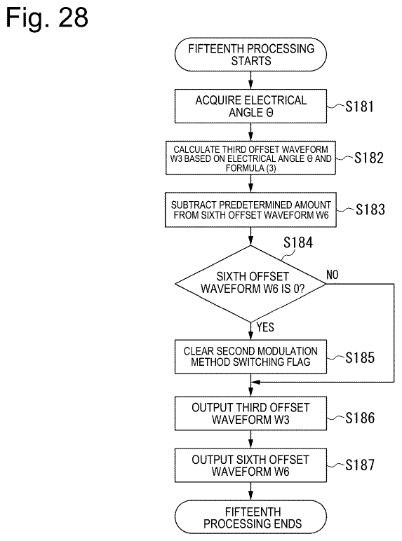

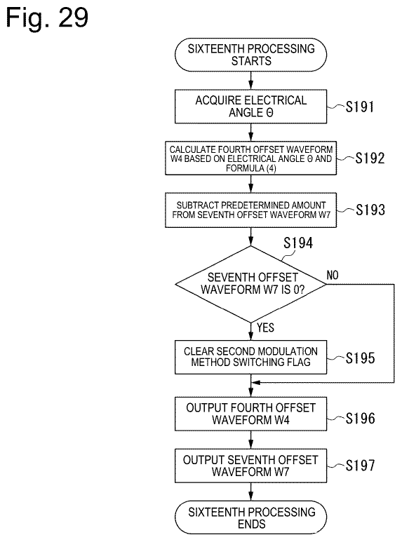

In the first case, the control unit 12 executes twelfth processing, thirteenth processing, fourteenth processing, fifteenth processing, and sixteenth processing in addition to the first processing that is the same as that in the first embodiment. FIG. 25 is a flowchart illustrating the twelfth processing executed by the control unit 12. FIG. 26 is a flowchart illustrating the thirteenth processing executed by the control unit 12. FIG. 27 is a flowchart illustrating the fourteenth processing executed by the control unit 12. FIG. 28 is a flowchart illustrating the fifteenth processing executed by the control unit 12. FIG. 29 is a flowchart illustrating the sixteenth processing executed by the control unit 12.

The control unit 12 executes the first processing and the twelfth processing at a predetermined cycle. As described later, the control unit 12 alternately executes the thirteenth processing and the fourteenth processing according to the electrical angle C in a case of determining that the first modulation method switching flag is set at the time of executing the twelfth processing. Further, the control unit 12 alternately executes the fifteenth processing and the sixteenth processing according to the electrical angle C in a case of determining that the second modulation method switching flag is set at the time of executing the twelfth processing.

First, in the second period before the first period, the control unit 12 switches between the first deformation mode in which the second change rate K2 is fixed to 0 and the second deformation mode in which the third change rate K3 is fixed to 0 at every 60 degrees of electrical angle. As a result, in the second period, the power conversion circuit 11 is controlled by the up-down-switching-type two-phase modulation.

As illustrated in FIG. 6, when starting the first processing, the control unit 12 sets the first modulation method switching flag with receiving of a switching command for a modulation method from a host control device during the second period (Step S1). After executing Step S1, the control unit 12 ends the first processing.

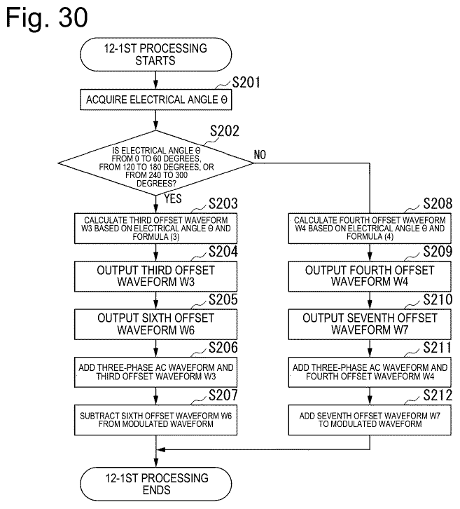

As illustrated in FIG. 25, when starting the twelfth processing, the control unit 12 first determines whether or not the first modulation method switching flag is set (Step S141). In a case of determining that the first modulation method switching flag is not set (Step S141: No), the control unit 12 determines whether or not the second modulation method switching flag is set (Step S149). In a case of determining that the second modulation method switching flag is not set (Step S149: No), the control unit 12 executes 12-1st processing illustrated in FIG. 30 (Step S157).

Note that in execution of the first processing and the twelfth processing at a predetermined cycle, for example, the first processing and the twelfth processing can be executed by being performed at every predetermined time in interrupt processing performed in synchronization with a carrier. For example, in interrupt processing synchronized with a carrier, the first processing and the twelfth processing are performed in interrupt processing performed once every ten times. At this time, in another piece of interrupt processing, the 12-1st processing is performed.

As illustrated in FIG. 30, when starting the 12-1st processing, the control unit 12 acquires the electrical angle θ of the motor 20 (Step S201). Then, the control unit 12 determines whether the electrical angle θ falls within a range from 0 degrees to 60 degrees, a range from 120 degrees to 180 degrees, or a range from 240 degrees to 300 degrees (Step S202).

In a case of determining that the electrical angle θ falls within a range from 0 degrees to 60 degrees, a range from 120 degrees to 180 degrees, or a range from 240 degrees to 300 degrees (Step S202: Yes), the control unit 12 calculates the third offset waveform W3(θ) based on the acquired electrical angle θ and Formula (3) (Step S203). At this time, the control unit 12 calculates the third offset waveform W3 on a condition that the second change rate K2 is 0.

Then, the control unit 12 outputs the third offset waveform W3(θ) calculated in Step S203 (Step S204). Furthermore, the control unit 12 outputs the sixth offset waveform W6 calculated on the same condition (Step S205). That is, the control unit 12 outputs 0 as the sixth offset waveform W6.

The control unit 12 adds the third offset waveform W3(θ) output in Step S204 and a three-phase AC waveform at the same electrical angle θ as the third offset waveform W3(θ) to calculate a modulated waveform at the same electrical angle θ (Step S206). Then, the control unit 12 subtracts the sixth offset waveform W6 output in Step S205 from a modulated waveform calculated in Step S206 to calculate a modulated waveform to be finally output (Step S207). After executing Step S207, the control unit 12 ends the 12-1st processing.

On the other hand, in a case of determining that the electrical angle θ does not fall within a range from 0 degrees to 60 degrees, a range from 120 degrees to 180 degrees, or a range from 240 degrees to 300 degrees (Step S202: No), the control unit 12 calculates the fourth offset waveform W4(θ) based on the acquired electrical angle θ and Formula (4) (Step S208). At this time, the control unit 12 calculates the fourth offset waveform W4 on a condition that the third change rate K3 is 0.

Then, the control unit 12 outputs the fourth offset waveform W4(θ) calculated in Step S208 (Step S209). Furthermore, the control unit 12 outputs the seventh offset waveform W7 calculated on the same condition (Step S210). That is, the control unit 12 outputs 0 as the seventh offset waveform W7.

The control unit 12 adds the fourth offset waveform W4(θ) output in Step S209 and a three-phase AC waveform at the same electrical angle θ as the fourth offset waveform W4(θ) to calculate a modulated waveform at the same electrical angle θ (Step S211). Then, the control unit 12 adds the seventh offset waveform W7 output in Step S210 and the modulated waveform calculated in Step S211 to calculate a modulated waveform to be finally output (Step S212). After executing Step S212, the control unit 12 ends the 12-1st processing. As described above, in a case of determining that both the first modulation method switching flag and the second modulation method switching flag are not set in the second period before the first period, the control unit 12 continues switching between the first deformation mode in which the second change rate K2 is fixed to 0 and the second deformation mode in which the third change rate K3 is fixed to 0 at every 60 degrees of electrical angle.

On the other hand, as illustrated in FIG. 25, in a case of determining that the first modulation method switching flag is set (Step S141: Yes), that is, in a case of receiving a switching command for a modulation system from a host control device during the second period, the control unit 12 determines whether or not the electrical angle θ falls within a range from 0 degrees to 60 degrees, a range from 120 degrees to 180 degrees, or a range from 240 degrees to 300 degrees (Step S142).

In a case of determining that the electrical angle θ falls within a range from 0 degrees to 60 degrees, a range from 120 degrees to 180 degrees, or a range from 240 degrees to 300 degrees (Step S142: Yes), the control unit 12 executes the thirteenth processing shown in FIG. 26 (Step S143). When the control unit 12 starts the thirteenth processing, the control unit 12 operates in the first deformation mode in the first period.

As illustrated in FIG. 26, when starting the thirteenth processing, the control unit 12 acquires the electrical angle θ of the motor 20 (Step S161). Then, the control unit 12 adds a predetermined amount to the second change rate K2 (Step S162). Then, the control unit 12 calculates the third offset waveform W3(θ) based on the acquired electrical angle θ and Formula (3) (Step S163). Then, the control unit 12 calculates the sixth offset waveform W6 based on Formula (6) (Step S164).

Then, the control unit 12 determines whether or not the second change rate K2 is 1 (Step S165). In a case of determining that the second change rate K2 is 1 (Step S165: Yes), the control unit 12 clears the first modulation method switching flag (Step S166). Then, the control unit 12 sets the second modulation method switching flag (Step S167). Then, after setting the second modulation method switching flag, the control unit 12 outputs the third offset waveform W3(θ) calculated in Step S163 (Step S168). Furthermore, the control unit 12 outputs the sixth offset waveform W6 calculated in Step S164 (Step S169).

On the other hand, in a case of determining that the second change rate K2 is not 1 (Step S165: No), the control unit 12 skips Steps S166 and S167 and proceeds to Step S168. After executing Steps S168 and S169, the control unit 12 ends the thirteenth processing and proceeds to Step S144 of the twelfth processing illustrated in FIG. 25.

As illustrated in FIG. 25, when proceeding to Step S144 of the twelfth processing after the thirteenth processing ends, the control unit 12 adds the third offset waveform W3(θ) output in Step S168 of the twelfth processing and a three-phase AC waveform at the same electrical angle θ as the third offset waveform W3(θ) to calculate a modulated waveform at the same electrical angle θ (Step S144).

Then, the control unit 12 subtracts the sixth offset waveform W6 output in Step S169 of the thirteenth processing from a modulated waveform calculated in Step S144 to calculate a modulated waveform to be finally output (Step S145). After executing Step S145, the control unit 12 ends the twelfth processing.

In a case of determining that the electrical angle θ does not fall within a range from 0 degrees to 60 degrees, a range from 120 degrees to 180 degrees, or a range from 240 degrees to 300 degrees (Step S142: No), the control unit 12 executes the fourteenth processing shown in FIG. 27 (Step S146). When the control unit 12 starts the fourteenth processing, the control unit 12 operates in the second deformation mode in the first period.

As illustrated in FIG. 27, when starting the fourteenth processing, the control unit 12 acquires the electrical angle θ of the motor 20 (Step S171). Then, the control unit 12 adds a predetermined amount to the third change rate K3 (Step S172). Then, the control unit 12 calculates the fourth offset waveform W4(θ) based on the acquired electrical angle θ and Formula (4) (Step S173). Then, the control unit 12 calculates the seventh offset waveform W7 based on Formula (7) (Step S174).

Then, the control unit 12 determines whether or not the third change rate K3 is 1 (Step S175). In a case of determining that the third change rate K3 is 1 (Step S175: Yes), the control unit 12 clears the first modulation method switching flag (Step S176). Then, the control unit 12 sets the second modulation method switching flag (Step S177). Then, after setting the second modulation method switching flag, the control unit 12 outputs the fourth offset waveform W4(θ) calculated in Step S173 (Step S178). Furthermore, the control unit 12 outputs the seventh offset waveform W7 calculated in Step S174 (Step S179).

On the other hand, in a case of determining that the third change rate K3 is not 1 (Step S175: No), the control unit 12 skips Steps S176 and S177 and proceeds to Step S178. After executing Steps S178 and S179, the control unit 12 ends the fourteenth processing and proceeds to Step S147 of the twelfth processing illustrated in FIG. 25.

As illustrated in FIG. 25, when proceeding to Step S147 of the twelfth processing after the fourteenth processing ends, the control unit 12 adds the fourth offset waveform W4(θ) output in Step S178 of the fourteenth processing and a three-phase AC waveform at the same electrical angle θ as the fourth offset waveform W4(θ) to calculate a modulated waveform at the same electrical angle θ (Step S147).

Then, the control unit 12 adds the seventh offset waveform W7 output in Step S179 of the fourteenth processing and the modulated waveform calculated in Step S147 to calculate a modulated waveform to be finally output (Step S148). After executing Step S148, the control unit 12 ends the twelfth processing.

As described above, in the first period, the control unit 12 switches, at every 60 degrees of electrical angle, between the first deformation mode and the second deformation mode, so that a modulation method gradually shifts from a modulation method close to a characteristic of the up-down-switching-type two-phase modulation to a modulation method close to a characteristic of the spatial vector modulation while a value to which a modulated waveform sticks is switched at every 60 of electrical angle between 0 and 1.

As illustrated in FIG. 25, in a case of determining that the second modulation method switching flag is set after determining that the first modulation method switching flag is not set (Step S149: Yes), the control unit 12 determines whether or not the electrical angle θ falls within a range from 0 degrees to 60 degrees, a range from 120 degrees to 180 degrees, or a range from 240 degrees to 300 degrees (Step S150).

In a case of determining that the electrical angle θ falls within a range from 0 degrees to 60 degrees, a range from 120 degrees to 180 degrees, or a range from 240 degrees to 300 degrees (Step S150: Yes), the control unit 12 executes the fifteenth processing shown in FIG. 28 (Step S151). When the control unit 12 starts the fifteenth processing, the control unit 12 operates in the first movement mode.

As illustrated in FIG. 28, when starting the fifteenth processing, the control unit 12 acquires the electrical angle θ of the motor 20 (Step S181). Then, the control unit 12 calculates the third offset waveform W3(θ) based on the acquired electrical angle θ and Formula (3) (Step S182). Then, the control unit 12 subtracts a predetermined amount from the sixth offset waveform W6 (Step S183). Note that, since the sixth offset waveform W6 is (1−m)/2 when the first fifteenth processing is executed, when Step S183 of the first fifteenth processing is executed, a value obtained by subtracting a predetermined amount from (1−m)/2 is calculated as the sixth offset waveform W6.

Subsequently, the control unit 12 determines whether or not the sixth offset waveform W6 is 0 (Step S184). In a case of determining that the sixth offset waveform W6 is 0 (Step S184: Yes), the control unit 12 clears the second modulation method switching flag (Step S185). Then, after clearing the second modulation method switching flag, the control unit 12 outputs the third offset waveform W3(θ) calculated in Step S182 (Step S186). Furthermore, the control unit 12 outputs the sixth offset waveform W6 calculated in Step S183 (Step S187).

On the other hand, in a case of determining that the sixth offset waveform W6 is not 0 (Step S184: No), the control unit 12 skips Step S185 and proceeds to Step S186. After executing Steps S186 and S187, the control unit 12 ends the fifteenth processing and proceeds to Step S152 of the twelfth processing illustrated in FIG. 25.

As illustrated in FIG. 25, when proceeding to Step S152 of the twelfth processing after the fifteenth processing ends, the control unit 12 adds the third offset waveform W3(θ) output in Step S186 of the fifteenth processing and a three-phase AC waveform at the same electrical angle θ as the third offset waveform W3(θ) to calculate a modulated waveform at the same electrical angle θ (Step S152).

Then, the control unit 12 subtracts the sixth offset waveform W6 output in Step S187 of the fifteenth processing from a modulated waveform calculated in Step S152 to calculate a modulated waveform to be finally output (Step S153). After executing Step S153, the control unit 12 ends the twelfth processing.

In a case of determining that the electrical angle θ does not fall within a range from 0 degrees to 60 degrees, a range from 120 degrees to 180 degrees, or a range from 240 degrees to 300 degrees (Step S150: No), the control unit 12 executes the sixteenth processing shown in FIG. 29 (Step S154). When the control unit 12 starts the sixteenth processing, the control unit 12 operates in the second movement mode.

As illustrated in FIG. 29, when starting the sixteenth processing, the control unit 12 acquires the electrical angle θ of the motor 20 (Step S191). Then, the control unit 12 calculates the fourth offset waveform W4(θ) based on the acquired electrical angle θ and Formula (4) (Step S192). Then, the control unit 12 subtracts a predetermined amount from the seventh offset waveform W7 (Step S193). Note that, since the seventh offset waveform W7 is (1−m)/2 when the first sixteenth processing is executed, when Step S193 of the first sixteenth processing is executed, a value obtained by subtracting a predetermined amount from (1−m)/2 is calculated as the seventh offset waveform W7.

Subsequently, the control unit 12 determines whether or not the seventh offset waveform W7 is 0 (Step S194). In a case of determining that the seventh offset waveform W7 is 0 (Step S194: Yes), the control unit 12 clears the second modulation method switching flag (Step S195). Then, after clearing the second modulation method switching flag, the control unit 12 outputs the fourth offset waveform W4(θ) calculated in Step S192 (Step S196). Furthermore, the control unit 12 outputs the seventh offset waveform W7 calculated in Step S193 (Step S197).

On the other hand, in a case of determining that the seventh offset waveform W7 is not 0 (Step S194: No), the control unit 12 skips Step S195 and proceeds to Step S196. After executing Steps S196 and S197, the control unit 12 ends the sixteenth processing and proceeds to Step S155 of the twelfth processing illustrated in FIG. 25.

As illustrated in FIG. 25, when proceeding to Step S155 of the twelfth processing after the sixteenth processing ends, the control unit 12 adds the fourth offset waveform W4(θ) output in Step S196 of the sixteenth processing and a three-phase AC waveform at the same electrical angle θ as the fourth offset waveform W4(θ) to calculate a modulated waveform at the same electrical angle θ (Step S155).

Then, the control unit 12 adds the seventh offset waveform W7 output in Step S197 of the sixteenth processing and the modulated waveform calculated in Step S155 to calculate a modulated waveform to be finally output (Step S156). After executing Step S156, the control unit 12 ends the twelfth processing.

As described above, in a period between the first period and the third period, the control unit 12 switches between the first movement mode and the second movement mode at every 60 degrees of electrical angle, so that the power conversion circuit 11 is controlled by a modulation method close to a characteristic of the spatial vector modulation while an upper end and a lower end of a modulated waveform gradually move toward the center.

The control unit 12 outputs a modulated waveform obtained by adding the fifth offset waveform W5(θ) represented by Formula (5) and a three-phase AC waveform after the second modulation method switching flag is cleared, that is, in the third period after the first period. As a result, in the third period, the power conversion circuit 11 is controlled by the spatial vector modulation.

As described above, in the first case of the seventh embodiment, in the first period between the second period in which the power conversion circuit 11 is controlled by the up-down-switching-type two-phase modulation and the third period in which the power conversion circuit 11 is controlled by the spatial vector modulation, a modulation method gradually shifts from a modulation method close to a characteristic of the up-down-switching-type two-phase modulation to a modulation method close to a characteristic of the spatial vector modulation while a value to which a modulated waveform sticks is switched every 60 of electrical angle between 0 and 1. Further, in the first case of the seventh embodiment, in a period between the first period and the third period, the power conversion circuit 11 is controlled by a modulation method close to a characteristic of the spatial vector modulation while an upper end and a lower end of a modulated waveform gradually move toward the center.

As described above, according to the first case of the seventh embodiment, similarly to the first case of the sixth embodiment, since it is possible to reduce a change in a rotational speed of the motor 20, a sudden change in noise, and a sudden change in a switching loss due to switching of a modulation method from the up-down-switching-type two-phase modulation to the spatial vector modulation, it is possible to reduce a torque fluctuation of the motor 20 and to prevent the user from feeling uncomfortable.

According to the first case of the seventh embodiment, since a lower end of a modulated waveform is stuck to 0 in a period in which the control unit 12 operates in the first deformation mode during a period included in the first period, switching of a low-side switch is stopped, so that a switching loss can be reduced. Further, according to the first case of the seventh embodiment, since an upper end of a modulated waveform is stuck to 1 in a period in which the control unit 12 operates in the second deformation mode during a period included in the first period, switching of a high-side switch is stopped, so that a switching loss can be reduced.

Note that, in the first case of the seventh embodiment, the case where the second change rate K2 and the third change rate K3 are fixed to 1 in the first movement mode and the second movement mode is described, but the present invention is not limited to this, and the second change rate K2 and the third change rate K3 may be fixed to predetermined values larger than 0 and less than 1. Alternatively, the second change rate K2 and the third change rate K3 may be gradually increased in the first movement mode and the second movement mode. That is, the second change rate K2 and the third change rate K3 may be increased to, for example, 0.5 in the first deformation mode and the second deformation mode, and the second change rate K2 and the third change rate K3 may be increased to the second upper limit value and the third upper limit value while the sixth offset waveform W6 and the seventh offset waveform W7 are gradually changed to 0 in the first movement mode and the second movement mode. According to this method, a waveform in the first period can be continuously changed, the first period can be shortened while a torque fluctuation of the motor 20 is reduced, and shifting between the second period and the third period can be performed at a higher speed. Further, in the first period, the second change rate K2 and the third change rate K3 may be set to different values. However, when the second change rate K2 and the third change rate K3 are set to the same value, a calculation load of the control unit 12 can be reduced, a high-side switch and a low-side switch operate symmetrically, and heat generation of both switches can be balanced.

Next, operation of the control unit 12 in a second case of the seventh embodiment will be described.

The control unit 12 outputs a modulated waveform obtained by adding the fifth offset waveform W5(θ) represented by Formula (5) and a three-phase AC waveform in the second period before the first period. As a result, in the second period, the power conversion circuit 11 is controlled by the spatial vector modulation.

In a period between the second period described above and the first period, the control unit 12 switches between the first movement mode and the second movement mode at every 60 degrees of electrical angle. For example, during a period in which the electrical angle θ falls within a range from 0 degrees to 60 degrees, during a period in which the electrical angle θ falls within a range from 120 degrees to 180 degrees, and during a period in which the electrical angle θ falls within a range from 240 degrees to 300 degrees, the control unit 12 operates in the first movement mode, and operates in the second movement mode in a remaining range of the electrical angle θ.

In the first movement mode, the control unit 12 outputs a modulated waveform obtained by adding the third offset waveform W3(θ) expressed by Formula (3) and a three-phase AC waveform, and outputs a modulated waveform obtained by adding the modulated waveform and the sixth offset waveform W6 as a final modulated waveform. In a period in which the control unit 12 operates in the first movement mode, the third offset waveform W3(θ) is calculated in a state in which the second change rate K2 is fixed to 1. Further, during a period in which the control unit 12 operates in the first movement mode, the sixth offset waveform W6 gradually changes (increases) from 0 to (1−m)/2.

In a period during which the control unit 12 operates in the first movement mode, the power conversion circuit 11 is controlled by a modulation method close to a characteristic of the spatial vector modulation. Furthermore, during a period in which the control unit 12 operates in the first movement mode, since the sixth offset waveform W6 gradually increases from 0 to (1−m)/2, a modulated waveform output during a period in which the control unit 12 operates in the first movement mode gradually moves to the low voltage side.

In the second movement mode, the control unit 12 outputs a modulated waveform obtained by adding the fourth offset waveform W4(θ) expressed by Formula (4) and a three-phase AC waveform, and outputs a modulated waveform obtained by adding the modulated waveform and the seventh offset waveform W7 as a final modulated waveform. In a period in which the control unit 12 operates in the second movement mode, the fourth offset waveform W4(θ) is calculated in a state in which the third change rate K3 is fixed to 1. Further, during a period in which the control unit 12 operates in the second movement mode, the seventh offset waveform W7 gradually changes (increases) from 0 to (1−m)/2.

In a period during which the control unit 12 operates in the second movement mode, the power conversion circuit 11 is controlled by a modulation method close to a characteristic of the spatial vector modulation. Furthermore, during a period in which the control unit 12 operates in the second movement mode, since the seventh offset waveform W7 gradually increases from 0 to (1−m)/2, a modulated waveform output during a period in which the control unit 12 operates in the second movement mode gradually moves to the high voltage side.

As described above, in a period between the second period and the first period, the control unit 12 switches between the first movement mode and the second movement mode at every 60 degrees of electrical angle, so that the power conversion circuit 11 is controlled by a modulation method close to a characteristic of the spatial vector modulation while an upper end of a modulated waveform gradually moves toward 1 and a lower end gradually moves toward 0.

In the first period after the second period, the control unit 12 switches between the first deformation mode and the second deformation mode at every 60 degrees of electrical angle. In a period in which the control unit 12 operates in the first deformation mode during a period included in the first period, the second change rate K2 gradually changes (decreases) from the second upper limit value to the second lower limit value. In a period in which the control unit 12 operates in the second deformation mode during a period included in the first period, the third change rate K3 gradually changes (decreases) from the third upper limit value to the third lower limit value.

As described above, when the second change rate K2 gradually decreases from the second upper limit value to the second lower limit value in a period in which the control unit 12 operates in the first deformation mode during a period included in the first period, a modulation method gradually shifts from a modulation method close to a characteristic of the spatial vector modulation to a modulation method close to a characteristic of the low-side-on-fixed-type two-phase modulation.

Furthermore, in a period in which the control unit 12 operates in the first deformation mode during a period included in the first period, a modulated waveform obtained by subtracting the sixth offset waveform W6 expressed by Formula (6) from a modulated waveform obtained by adding the third offset waveform W3(θ) expressed by Formula (3) and a three-phase AC waveform is output as a final modulated waveform. By the above, a lower end of a modulated waveform output in a period in which the control unit 12 operates in the first deformation mode during a period included in the first period sticks to 0. Note that, when the second change rate K2 gradually decreases from the second upper limit value to the second lower limit value in a period in which the control unit 12 operates in the first deformation mode during a period included in the first period, a value of the sixth offset waveform W6 also gradually decreases as the second change rate K2 decreases.

As described above, when the third change rate K3 gradually decreases from the third upper limit value to the third lower limit value in a period in which the control unit 12 operates in the second deformation mode during a period included in the first period, a modulation method gradually shifts from a modulation method close to a characteristic of the spatial vector modulation to a modulation method close to a characteristic of the high-side-on-fixed-type two-phase modulation.

Furthermore, in a period in which the control unit 12 operates in the second deformation mode during a period included in the first period, a modulated waveform obtained by adding a modulated waveform obtained by adding the fourth offset waveform W4(θ) expressed by Formula (4) and a three-phase AC waveform and the seventh offset waveform W7 expressed by Formula (7) is output as a final modulated waveform. By the above, an upper end of a modulated waveform output in a period in which the control unit 12 operates in the second deformation mode during a period included in the first period sticks to 1. Note that, when the third change rate K3 gradually decreases from the third upper limit value to the third lower limit value in a period in which the control unit 12 operates in the second deformation mode during a period included in the first period, a value of the seventh offset waveform W7 also gradually decreases as the third change rate K3 decreases.

As described above, in the first period, the control unit 12 switches, at every 60 degrees of electrical angle, between the first deformation mode and the second deformation mode, so that a modulation method gradually shifts from a modulation method close to a characteristic of the spatial vector modulation to a modulation method close to a characteristic of the up-down-switching-type two-phase modulation while a value to which a modulated waveform sticks is switched at every 60 of electrical angle between 0 and 1.

In the third period after the first period, the control unit 12 switches between the first deformation mode in which the second change rate K2 is fixed to 0 and the second deformation mode in which the third change rate K3 is fixed to 0 at every 60 degrees of electrical angle. As a result, in the third period, the power conversion circuit 11 is controlled by the up-down-switching-type two-phase modulation.

As described above, in the second case of the seventh embodiment, in the first period between the second period in which the power conversion circuit 11 is controlled by the spatial vector modulation and the third period in which the power conversion circuit 11 is controlled by the up-down-switching-type two-phase modulation, a modulation method gradually shifts from a modulation method close to a characteristic of the spatial vector modulation to a modulation method close to a characteristic of the up-down-switching-type two-phase modulation while a value to which a modulated waveform sticks is switched every 60 of electrical angle between 0 and 1. Further, in the second case of the seventh embodiment, in a period between the second period and the first period, the power conversion circuit 11 is controlled by a modulation method close to a characteristic of the spatial vector modulation while an upper end of a modulated waveform gradually moves toward 1 and a lower end gradually moves toward 0.

As described above, according to the second case of the seventh embodiment, similarly to the second case of the sixth embodiment, since it is possible to reduce a change in a rotational speed of the motor 20, a sudden change in noise, and a sudden change in a switching loss due to switching of a modulation method from the spatial vector modulation to the up-down-switching-type two-phase modulation, it is possible to reduce a torque fluctuation of the motor 20 and to prevent the user from feeling uncomfortable.

According to the second case of the seventh embodiment, since a lower end of a modulated waveform is stuck to 0 in a period in which the control unit 12 operates in the first deformation mode during a period included in the first period, switching of a low-side switch is stopped, so that a switching loss can be reduced. Further, according to the second case of the seventh embodiment, since an upper end of a modulated waveform is stuck to 1 in a period in which the control unit 12 operates in the second deformation mode during a period included in the first period, switching of a high-side switch is stopped, so that a switching loss can be reduced.

Note that, in the second case of the seventh embodiment, the case where the second change rate K2 and the third change rate K3 are fixed to 1 in the first movement mode and the second movement mode is described, but the present invention is not limited to this, and the second change rate K2 and the third change rate K3 may be fixed to predetermined values larger than 0 and less than 1. Alternatively, the second change rate K2 and the third change rate K3 may be gradually decreased in the first movement mode and the second movement mode. That is, the sixth offset waveform W6 and the seventh offset waveform W7 may be gradually changed to K2×(1−m)/2 and K3×(1−m)/2 while the second change rate K2 and the third change rate K3 are gradually decreased to, for example, 0.5 in the first deformation mode and the second deformation mode, and the sixth offset waveform W6 and the seventh offset waveform W7 may be set to K2×(1−m)/2 and K3×(1−m)/2 while the second change rate K2 and the third change rate K3 are decreased to the second lower limit value and the third lower limit value in the first deformation mode and the second deformation mode. According to this method, a waveform in the first period can be continuously changed, the first period can be shortened while a torque fluctuation of the motor 20 is reduced, and shifting between the second period and the third period can be performed at a higher speed. Further, in the first period, the second change rate K2 and the third change rate K3 may be set to different values. However, when the second change rate K2 and the third change rate K3 are set to the same value, a calculation load of the control unit 12 can be reduced, a high-side switch and a low-side switch operate symmetrically, and heat generation of both switches can be balanced.

The present invention is not limited to the above embodiments, and the configurations described in the present description can be appropriately combined within a range not conflicting with one another.

For example, in the above embodiment, the power conversion device 10 that controls the motor 20 which is a three-phase motor is exemplified, but the motor 20 to be controlled is not limited to a three-phase motor, and may be an N-phase motor (N is an integer of three or more). In the above embodiment, the IGBT is exemplified as each arm switch included in the power conversion circuit 11, but each arm switch may be, for example, a high-power switching element other than the IGBT such as a MOS-FET.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A power conversion device comprising:
a power conversion circuit that performs mutual conversion between DC power and N-phase AC power (N is an integer of three or more); and
a control unit having a first deformation mode for controlling the power conversion circuit by pulse width modulation based on an N-phase modulated waveform and a carrier waveform,
wherein in the first deformation mode, the control unit outputs the N-phase modulated waveform obtained by adding a first offset waveform W1(θ) expressed by Formula (1) having, as variables, a sign Sgn (Sgn is 1 or −1), a first change rate K1, and a maximum value fmax(θ) and a minimum value fmin(θ) of an N-phase AC waveform at an electrical angle θ and the N-phase AC waveform, and
the first change rate K1 of the first deformation mode is larger than 0 and smaller than 1.
$$[ Mathematical formula 1 ]$$
$$W 1 ( θ ) = \{ 1 - f max ( θ ) - f min ( θ ) \} / 2 + Sgn \times ( 1 - K 1 ) \times \{ 1 - f max ( θ ) + f min ( θ ) \} / 2 \qquad ( 1 )$$

2. The power conversion device according to claim 1, wherein
the control unit
operates in a first start mode in which the first change rate K1 is a first predetermined value different from that in the first deformation mode before operating in the first deformation mode, and
operates in a first end mode in which the first change rate K1 is a second predetermined value different from that in the first deformation mode and the first start mode after operating in the first deformation mode.

3. The power conversion device according to claim 2, wherein the first change rate K1 of one of the first start mode and the first end mode is 0, and the first change rate K1 of another one of the first start mode and the first end mode is a value larger than 0 and equal to or less than 1.

4. The power conversion device according to claim 2, wherein the first change rate K1 of one of the first start mode and the first end mode is 1, and the first change rate K1 of another one of the first start mode and the first end mode is 0 or more and smaller than 1.

5. The power conversion device according to claim 1, wherein the first change rate K1 of the first deformation mode changes within a range of larger than 0 and smaller than 1 during a period in which the control unit operates in the first deformation mode.

6. The power conversion device according to claim 1, wherein
the first change rate K1 of the first deformation mode changes within a range of larger than 0 and smaller than 1 during a period in which the control unit operates in the first deformation mode, and
in the first deformation mode, the control unit outputs the N-phase modulated waveform obtained by adding the N-phase modulated waveform and a second offset waveform W2 expressed by Formula (2) having, as variables, the first change rate K1, a modulation rate m, and the sign Sgn.
$$[ Mathematical formula 2 ]$$
$$W 2 = Sgn \times K 1 \times ( 1 - m ) / 2 \qquad ( 2 )$$

7. The power conversion device according to claim 6, wherein the control unit operates in a first movement mode in which the second offset waveform W2 changes from a value calculated by Formula (2) to 0 after operating in the first deformation mode.

8. The power conversion device according to claim 7, wherein
the first change rate K1 of the first movement mode is 1,
the first change rate K1 of the first deformation mode changes from a value larger than 0 to a value smaller than 1 during a period in which the control unit operates in the first deformation mode, and
the second offset waveform W2 changes from Sgn×(1−m)/2 to 0 in a period in which the control unit operates in the first movement mode.

9. The power conversion device according to claim 6, wherein
the control unit
operates in a first start mode in which the first change rate K1 is a first predetermined value different from that in the first deformation mode before operating in the first deformation mode, and
operates in a first end mode in which the first change rate K1 is a second predetermined value different from that in the first deformation mode and the first start mode after operating in the first deformation mode.

10. The power conversion device according to claim 9, wherein the control unit operates in a first movement mode in which the second offset waveform W2 changes from a value calculated by Formula (2) to 0 in a period between a period in which the control unit operates in the first deformation mode and a period in which the control unit operates in the first end mode.

11. The power conversion device according to claim 10, wherein
the first change rate K1 of the first start mode is 0,
the first change rate K1 of the first deformation mode changes from a value larger than 0 to a value smaller than 1 during a period in which the control unit operates in the first deformation mode,
the first change rate K1 in the first movement mode and the first end mode is 1, and
the second offset waveform W2 changes from Sgn×(1−m)/2 to 0 in a period in which the control unit operates in the first movement mode.

12. The power conversion device according to claim 1, wherein
the control unit
operates in a first start mode in which the first change rate K1 is 0 before operating in the first deformation mode, and
operates in a first end mode in which the first change rate K1 is 0 after operating in the first deformation mode, and
a period in which the control unit operates in the first deformation mode includes a first period in which the first change rate K1 changes from a value larger than 0 to a value smaller than 1 in a state in which the sign Sgn is set to one of 1 and −1, and a second period in which the first change rate K1 changes from a value smaller than 1 to a value larger than 0 in a state in which the sign Sgn is set to another one of 1 and −1.

13. The power conversion device according to claim 12, wherein
in the first deformation mode, the control unit outputs the N-phase modulated waveform obtained by adding the N-phase modulated waveform and a second offset waveform W2 expressed by Formula (2) having, as variables, the first change rate K1, a modulation rate m, and the sign Sgn,
the control unit operates in a first movement mode in which an absolute value of the second offset waveform W2 changes from (1−m)/2 to 0 in a state in which the sign Sgn is set to one of 1 and −1 after the first period in which the control unit operates in the first deformation mode, and
the control unit operates in a second movement mode in which an absolute value of the second offset waveform W2 changes from 0 to (1−m)/2 in a state in which the sign Sgn is set to another one of 1 and −1 in a period between a period in which the control unit operates in the first movement mode and the second period in which the control unit operates in the first deformation mode.
$$[ Mathematical formula 3 ]$$
$$W 2 = Sgn \times K 1 \times ( 1 - m ) / 2 \qquad ( 2 )$$

14. A power conversion device comprising:
a power conversion circuit that performs mutual conversion between DC power and N-phase AC power (N is an integer of three or more); and
a control unit having a first deformation mode and a second deformation mode for controlling the power conversion circuit by pulse width modulation based on an N-phase modulated waveform and a carrier waveform,
wherein in the first deformation mode, the control unit outputs the N-phase modulated waveform obtained by adding a third offset waveform W3(θ) expressed by Formula (3) having, as variables, a second change rate K2 and a maximum value fmax(θ) and a minimum value fmin(θ) of an N-phase AC waveform at an electrical angle θ and the N-phase AC waveform,
in the second deformation mode, the control unit outputs the N-phase modulated waveform obtained by adding a fourth offset waveform W4(θ) expressed by Formula (4) having, as variables, a third change rate K3 and a maximum value fmax(θ) and a minimum value fmin(θ) of the N-phase AC waveform at the electrical angle θ and the N-phase AC waveform,
the control unit
switches between the first deformation mode and the second deformation mode every 1/N of the electrical angle of 180 degrees in a first period,
switches between the first deformation mode in which the second change rate K2 is fixed to 0 and the second deformation mode in which the third change rate K3 is fixed to 0 every 1/N of the electrical angle of 180 degrees in a second period before the first period, and
outputs the N-phase modulated waveform obtained by adding a fifth offset waveform W5(θ) expressed by Formula (5) and the N-phase AC waveform in a third period after the first period,
the second change rate K2 in the first deformation mode changes from a value larger than 0 to a value smaller than 1 in a period in which the control unit operates in the first deformation mode during a period included in the first period, and
the third change rate K3 in the second deformation mode changes from a value larger than 0 to a value smaller than 1 in a period in which the control unit operates in the second deformation mode during a period included in the first period.
$$[ Mathematical formula 4 ]$$
$$W 3 ( θ ) = - f min ( θ ) \times ( 1 - K 2 ) + K 2 \times \{ 1 - f max ( θ ) - f min ( θ ) \} / 2 \qquad ( 3 )$$
$$W 4 ( θ ) = \{ 1 - f max ( θ ) \} \times ( 1 - K 3 ) + K 3 \times \{ 1 - f max ( θ ) - f min ( θ ) \} / 2 \qquad ( 4 )$$
$$W 5 ( θ ) = \{ 1 - f max ( θ ) - f min ( θ ) \} / 2 \qquad ( 5 )$$

15. The power conversion device according to claim 14, wherein
in the first deformation mode, the control unit outputs the N-phase modulated waveform obtained by subtracting a sixth offset waveform W6 expressed by Formula (6) having, as variables, the second change rate K2 and a modulation rate m from the N-phase modulated waveform,
in the second deformation mode, the control unit outputs the N-phase modulated waveform obtained by adding a seventh offset waveform W7 expressed by Formula (7) having, as variables, the third change rate K3 and the modulation rate m and the N-phase modulated waveform,
the control unit operates in a first movement mode in which the second change rate K2 is fixed to 1 after operating in the first deformation mode,
the sixth offset waveform W6 changes from (1−m)/2 to 0 during a period in which the control unit operates in the first movement mode,
the control unit operates in a second movement mode in which the third change rate K3 is fixed to 1 after operating in the second deformation mode, and
the seventh offset waveform W7 changes from (1−m)/2 to 0 during a period in which the control unit operates in the second movement mode.
$$[ Mathematical formula 5 ]$$
$$W 6 = K 2 \times ( 1 - m ) / 2 \qquad ( 6 )$$
$$W 7 = K 3 \times ( 1 - m ) / 2 \qquad ( 7 )$$

16. A motor module comprising:
a motor; and
the power conversion device according to claim 1 that supplies power to the motor.
